(19) United States
(12) Patent Application Publication
(10) Pub. No.: US 2024/0427123 A1
(43) Pub. Date: Dec. 26, 2024

(54) Anamorphic directional illumination device

(71) Applicant: RealD Spark, LLC, BOULDER, CO (US)

(72) Inventors: Michael G. Robinson, BOULDER, CO (US); Graham J. Woodgate, Henley-on-Thames (GB); Jonathan Harrold, Leamington Spa (GB); Austin Wilson, Tempe, AZ (US)

(21) Appl. No.: 18/734,222

(22) Filed: Jun. 5, 2024

Related U.S. Application Data
(60) Provisional application No. 63/521,910, filed on Jun. 20, 2023.
(60) Provisional application No. 63/531,722, filed on Aug. 9, 2023.
(60) Provisional application No. 63/601,883, filed on Nov. 22, 2023.
(60) Provisional application No. 63/626,253, filed on Jan. 29, 2024.
(60) Provisional application No. 63/559,726, filed on Feb. 29, 2024.

(51) Int. Cl. G02B 13/10; F21V 8/00; G02B 27/00; G02B 27/28

(52) U.S. Cl. CPC G02B 13/10; G02B 6/0056; G02B 27/0068; G02B 27/0081; G02B 27/286

(57) ABSTRACT

An anamorphic directional illumination device may provide a near-eye display apparatus or a vehicle external light device. The anamorphic near-eye display device comprises a spatial light modulator with asymmetric pixels; an input transverse anamorphic lens; and an extraction waveguide that passes input light in a first direction between a polarisation-sensitive reflector and rear guide surface to a lateral anamorphic reflector, and to reflect the light back through the extraction waveguide to output through the front guide surface. Deflection features are arranged on the front side of the polarisation-sensitive reflector to deflect the reflected light towards the pupil of a viewer, maintaining the directionality of the fan of light rays from the SLM and anamorphic imaging system. A thin, transparent and efficient anamorphic display apparatus for Augmented Reality and Virtual Reality displays and for scene illumination is provided.

### TECHNICAL FIELD

This disclosure generally relates to near-eye display apparatuses and illumination systems therefor.

### BACKGROUND

Head-worn displays incorporating a near-eye display apparatus may be arranged to provide fully immersive imagery such as in virtual reality (VR) displays or augmented imagery overlayed over views of the real world such as in augmented reality (AR) displays. If the overlayed imagery is aligned or registered with the real-world image it may be termed Mixed Reality (MR). In VR displays, the near-eye display apparatus is typically opaque to the real world, whereas in AR displays the optical system is partially transmissive to light from the real world.

The near-eye display apparatuses of AR and VR displays aim to provide images to at least one eye of a user with full colour, high resolution, high luminance and high contrast; and with wide fields of view (angular size of image), large eyebox sizes (the geometry over which the eye can move while having visibility of the full image field of view). Such displays are desirable in thin form factors, low weight and with low manufacturing cost and complexity.

Further, AR near-eye display apparatuses aim to have high transmission of real-world light rays without image distortions or degradations and reduced glare of stray light away from the display wearer. AR optics may broadly be categorised as reflective combiner type or waveguide type. Waveguide types typically achieve reduced form factor and weight due to the optical path folding within the waveguide. Known methods for injecting images into a waveguide may use a spatial light modulator (SLM) and a projection lens arrangement with a prism or grating to couple light into the waveguide. Pixel locations in the SLM are converted to a fan of ray directions by the projection lens. In other arrangements a laser scanner may provide the fan of ray directions. The angular locations are propagated through the waveguide and output to the eye of the user. The eye's optical system collects the angular locations and provides spatial images at the retina.

### BRIEF SUMMARY

According to a first aspect of the present disclosure, there is provided an anamorphic directional illumination device comprising: an illumination system comprising a spatial light modulator (SLM), the illumination system being arranged to output light; and an optical system arranged to direct light from the illumination system, wherein the optical system has an optical axis and has anamorphic properties in a lateral direction and a transverse direction that are perpendicular to each other and perpendicular to the optical axis, wherein the SLM comprises pixels distributed in the lateral direction, and the optical system comprises: a transverse anamorphic component having positive optical power in the transverse direction, wherein the transverse anamorphic component is arranged to receive light from the SLM, and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide being arranged to guide light from the transverse anamorphic component to the lateral anamorphic component along the extraction waveguide in a first direction; and a light reversing reflector that is arranged to reflect light guided along the extraction waveguide in the first direction to form light that is directed along the extraction waveguide in a second direction opposite to the first direction, wherein: the extraction waveguide comprises a rear guide surface and a polarisation-sensitive reflector (PSR) opposing the rear guide surface; the anamorphic directional illumination device further comprises a deflection arrangement disposed outside the PSR, the anamorphic directional illumination device is arranged to provide light guided along the extraction waveguide in the first direction with an input linear polarisation state before reaching the PSR; the optical system further comprises a polarisation conversion retarder disposed between the PSR and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has an orthogonal linear polarisation state that is orthogonal to the input linear polarisation state; the PSR is arranged to reflect light guided in the first direction having the input linear polarisation state so that the rear guide surface and the PSR are arranged to guide light in the first direction, and to pass light guided in the second direction having the orthogonal linear polarisation state so that the passed light is incident on the deflection arrangement; and the deflection arrangement is arranged to deflect at least part of the light passed by the PSR that is incident thereon forwards of the anamorphic directional illumination device.

The anamorphic directional illumination device may provide controllable directional illumination of ambient scenes, for example for road illumination from a vehicle. Compact physical size and low weight may be achieved and high transparency may be provided. The anamorphic directional illumination device may be provided as an anamorphic near-eye display device (ANEDD) to provide images with wide field of view with high brightness and high efficiency and provide high comfort of use and extend viewing times. Images may be provided with reduced colour blur. A large size eyebox may be achieved to relax limitations of pupil positioning at desirable eye relief distances may achieve vignetting-free images over a wide range of observer pupil positions and for a wide field of view. The ANEDD may be suitable for augmented reality (AR) and virtual reality (VR) applications.

The deflection arrangement may comprise a deflection element comprising an array of deflection features that may be arranged to deflect light incident thereon forwards of the anamorphic directional illumination device. An increased size of optical pupil may be provided to achieve increased uniformity of an image for a near-eye display apparatus. Improved aesthetic appearance of an illumination device may be provided.

The deflection features may be reflectors. High efficiency and reduced colour blur may be achieved.

The reflectors may be partially reflective reflectors. The partially reflective reflectors may each comprise a partially reflective layer. Image uniformity may be increased over an increased exit pupil size.

The partially reflective layer may comprise at least one dielectric layer, preferably a stack of dielectric layers. Advantageously control of the reflectivity of the partially reflective reflectors may be achieved during manufacture. Light losses may be reduced.

The partially reflective layer may be metallic. Advantageously reduced cost may be achieved.

The anamorphic directional illumination device may further comprise an intermediate polarisation conversion retarder arranged between the PSR and the deflection element, the intermediate polarisation conversion retarder may be arranged to convert a polarisation state of light passing therethrough between the orthogonal linear polarisation state and the input linear polarisation state. High efficiency of transmission of light along the extraction waveguide in the first direction may be provided. High efficiency of reflection from the reflective deflection features may be achieved. Increased size of the exit pupil may be achieved.

The deflection arrangement may comprise a front waveguide which may have a front guide surface on the opposite side of the front waveguide from the PSR, and the deflection features may be disposed internally within the front waveguide. The front waveguide may comprise a front element and a rear element and may have a partially reflective layer disposed therebetween, the partially reflective layer comprising first and second sections of opposite inclination alternating in a direction along the front waveguide, the first sections comprising the reflective reflectors and the second sections may be arranged to pass the light passed by the PSR that may be incident thereon. Increased size of the exit pupil may be achieved and image uniformity increased. Susceptibility to damage of the deflection features may be reduced.

The deflection features may be separated in a direction along the front waveguide. The deflection features may be distributed along the extraction waveguide to provide exit pupil expansion in the transverse direction. The deflection arrangement may comprise a deflection element comprising an array of deflection features that may be arranged to deflect light incident thereon forwards of the ANEDD. Increased size of the exit pupil may be achieved and image uniformity increased.

The deflection arrangement may comprise a front waveguide that may have a front surface on the opposite side of the front waveguide from the extraction waveguide, the front surface comprising guide facets that may be arranged to guide light incident thereon in the second direction along the front waveguide and inclined facets that form the deflection elements. Advantageously exit pupil size and image uniformity may be increased.

The front surface of the front waveguide may further comprise draft facets that may be of an opposite inclination to the inclined facets that form the deflection features, and the draft facets may be arranged to pass the light passed by the PSR that may be incident thereon. Advantageously the visibility of stray light may be reduced.

The front surface of the front waveguide may have a partially reflective layer disposed thereon. A uniform reflective layer may be provided on the front surface to achieve reduced manufacturing cost and complexity.

The deflection arrangement may comprise: a partial reflector arranged to pass part of the light that may be incident thereon and to reflect the remainder of the light that may be incident thereon back into the extraction waveguide; and a deflection element that may be arranged to deflect the part of the light that may be passed by the partial reflector forwards of the anamorphic directional illumination device. The deflection element may comprise an array of deflection features that may be arranged to deflect the part of the light that may be passed by the partial reflector forwards of the anamorphic directional illumination device. The deflection element may have a front surface on the opposite side thereof from the extraction waveguide, the front surface comprising inclined facets that form the deflection features. Advantageously exit pupil size and image uniformity may be increased.

The front surface of the deflection element may further comprise draft facets that alternate with the inclined facets and may be of an opposite inclination to the inclined facets that form the deflection features, and the draft facets may be arranged to pass the light passed by the PSR that may be incident thereon. The front surface may have a partially reflective layer disposed thereon. Advantageously cost and complexity of manufacturing may be achieved.

The deflection features may be elongate in the lateral direction. The lateral size of the exit pupil may be increased. Advantageously viewer comfort may be increased.

The input linear polarisation state may be an s-polarisation state in the extraction waveguide, and the orthogonal linear polarisation state may be a p-polarisation state in the extraction waveguide. Advantageously high efficiency of transmission for light propagating in the first direction, and high efficiency of extraction for light propagating in the second direction may be achieved.

The front guide surface may comprise a surface relief grating comprising the deflection features. Advantageously the aperture size of the optical element is increased, and diffraction from the aperture reduced.

The deflection element may comprise an array of extraction reflectors disposed internally within the extraction waveguide. Advantageously increased efficiency may be achieved, and resistance to surface damage increased. Improved exit pupil size and uniformity may be achieved.

The PSR may comprise a reflective linear polariser. High efficiency may advantageously be achieved. The reflective linear polariser may be provided with low thickness and high flatness to advantageously achieve high resolution output. The reflective linear polariser may be conveniently manufactured over the area of the extraction waveguide at low cost. Light travelling along the second direction may be efficiently transmitted onto the deflection features. High efficiency and uniformity may be achieved. The exit pupil size may be increased. High image luminance uniformity over a wide field of view may be achieved.

The polarisation conversion retarder may have a retardance of a quarter wavelength at a wavelength of visible light, for example 550 nm. High efficiency of polarisation conversion for light travelling in the second direction along the extraction waveguide may be achieved. Advantageously efficiency image contrast and image uniformity may be increased.

The PSR may comprise at least one dielectric layer. The at least one dielectric layer may comprise a stack of dielectric layers.

The PSR may comprise a nematic liquid crystal layer. The nematic liquid crystal layer may comprise a liquid crystal material arranged between first and second opposing alignment layers. The component of the optical axis of the liquid crystal layer in the plane of the liquid crystal layer may be parallel or orthogonal to the first direction along the extraction waveguide. Advantageously a low thickness reflector may be provided with low scatter and high transparency.

The PSR may comprise a cholesteric liquid crystal layer. The anamorphic directional illumination device may further comprise a polarisation conversion retarder arranged between the rear guide surface and the cholesteric liquid crystal retarder, wherein the polarisation conversion retarder may be arranged to convert a polarisation state of light passing therethrough between a linear polarisation state and a circular polarisation state, and the polarisation conversion retarder and the cholesteric liquid crystal layer may be arranged in combination to reflect the input linear polarisation state of the light guided in the first direction and to transmit the linear polarisation state of the light guided in the second direction. The anamorphic directional illumination device may further comprise a polarisation conversion retarder arranged outside the cholesteric liquid crystal retarder, wherein the polarisation conversion retarder may be arranged to convert a polarisation state of light passing therethrough between a linear polarisation state and a circular polarisation state. Advantageously high reflectivity may be achieved over a wide field of view for light propagating in the first direction with a linear polarisation state, and high transmission for light propagating in the second direction. The cholesteric liquid crystal layer may have low thickness.

The optical system may further comprise an input linear polariser that may be disposed between the SLM and the PSR and may be arranged to pass light that may have the input linear polarisation state.

The input linear polariser may be disposed between the SLM and the extraction waveguide. Fabrication cost may advantageously be reduced.

The input linear polariser may be disposed within the extraction waveguide. Advantageously depolarization along the extraction waveguide may be reduced and efficiency advantageously increased.

The input linear polariser may be disposed after the transverse anamorphic component, and the optical system may further comprise a polarisation conversion retarder disposed between the transverse anamorphic component and the input linear polariser, the polarisation conversion retarder may be arranged to convert a polarisation state of light passing therethrough between a linear polarisation state and a circular polarisation state. The illumination system may be arranged to output light that may be unpolarised or the illumination system may be arranged to output light having the input linear polarisation state. Stray light from back reflections falling on the input end may be reduced. Advantageously image contrast may be increased.

The illumination system may be arranged to output light that may be unpolarised. The input linear polariser may be arranged in the optical system and so separated in location from the light source to achieve reduced heating and increased lifetime of the input polariser.

The illumination system may be arranged to output light that may have the input linear polarisation state. The efficiency of the optical system may be improved.

The extraction waveguide may have an input end extending in the lateral and transverse directions, the extraction waveguide may be arranged to receive light from the illumination system through the input end. The direction of the optical axis through the transverse anamorphic component may be inclined with respect to the first and second directions along the extraction waveguide. The input end may be inclined with respect to the first and second directions along the extraction waveguide. The input linear polariser may be disposed between the SLM and the input end of the extraction waveguide. The polarisation conversion retarder may have a retardance of a quarter wavelength at a wavelength of visible light. Light may be input into the extraction waveguide at angles that may be extracted without double imaging. Image contrast may advantageously be improved.

The light reversing reflector may be a reflective end of the extraction waveguide. The lateral anamorphic component may comprise the light reversing reflector. Advantageously the cost and complexity of manufacture may be reduced. Interfacial losses may be reduced.

The transverse anamorphic component may comprise a lens, optionally a compound lens. Advantageously aberrations in the transverse direction may be reduced.

The optical system may comprise an input section comprising an input reflector that is the transverse anamorphic component and may be arranged to reflect the light from the illumination system and direct it along the waveguide. Advantageously complexity, cost of fabrication and weight may be reduced.

The transverse anamorphic component may further comprise a lens. Advantageously aberrations may be reduced, image fidelity increased and headbox increased in size.

The input section may further comprise an input face disposed on a front or rear side of the waveguide and facing the input reflector, and the input section may be arranged to receive the light from the illumination system through the input face. The input face may extend at an acute angle to the front guide surface in the case that the input face is on the front side of the waveguide or to the rear guide surface in the case that the input face is on the rear side of the waveguide. The input face may extend parallel to the front guide surface in the case that the input face is on the front side of the waveguide or to the rear guide surface in the case that the input face is on the rear side of the waveguide. The input face may be coplanar with the front guide surface in the case that the input face is on the front side of the waveguide or with the rear guide surface in the case that the input face is on the rear side of the waveguide. The input face may be disposed outwardly of one of the front or rear guide surfaces. The input section may further comprise a separation face extending outwardly from the one of the front or rear guide surfaces to the input face. Advantageously improved mechanical arrangements of the illumination system and optical system may be achieved.

The input section may be integral with the waveguide. Advantageously complexity of manufacture may be reduced, and lower cost achieved.

The waveguide may have an end that is an input face through which the waveguide is arranged to receive light from the illumination system, and the input section may be a separate element from the waveguide that may further comprise an output face and is arranged to direct light reflected by the input reflector through the output face and into the waveguide through the input face of the waveguide. Advantageously improved aberrations may be achieved. Reflective surfaces may be protected.

The pixels of the SLM may be also distributed in the transverse direction so that the light output from the transverse anamorphic component may be directed in the directions that may be distributed in the transverse direction. Advantageously, image rows may be provided simultaneously. Image break-up artefacts may be reduced.

The illumination system may further comprise a deflector element arranged to deflect light output from the transverse anamorphic component by a selectable amount, the deflector element may be selectively operable to direct the light output from the transverse anamorphic component in the directions that may be distributed in the transverse direction. Advantageously the complexity of the illumination system may be reduced.

The SLM may comprise pixels that may have pitches in the lateral and transverse directions with a ratio that may be the same as the inverse of the ratio of optical powers of the lateral and transverse anamorphic optical elements. Advantageously the observer may perceive square pixels. Image fidelity may be increased.

The anamorphic directional illumination device may further comprise a control system arranged to operate the illumination system to provide light input in accordance with image data representing an image. Advantageously, image data may be perceived to provide an AR or VR image.

The deflection arrangement may be configured such that the output light from each point of the spatial light modulator has vergence in the transverse direction and, when the output light is viewed by an eye of a viewer, the vergence allows the eye of the viewer to focus the output light from a finite viewing distance in the transverse direction. The deflection features may have tilts that vary such that the light from each point of the spatial light modulator has the vergence in the transverse direction.

A near-eye display may provide images to an observer so that the eye focusses at a finite viewing distance. Stereoscopic images may be provided for virtual images provided with image disparity suitable for finite viewing distance. Accommodation may be matched to image convergence and increased viewing comfort achieved. Correction for ophthalmic conditions such as myopia, hypertropia and presbyopia may be achieved for viewing of virtual images.

In the transverse direction, each deflection feature may be linear. The cost and complexity of fabrication of the array of extraction features may be reduced.

In the transverse direction, each deflection feature may be curved. Image blur may be reduced and image fidelity improved. In the transverse direction, each deflection feature may be curved with the same curvature. Cost and complexity of manufacture may be reduced.

In the transverse direction, each deflection feature may be curved with a curvature that changes along the extraction waveguide in the second direction. Uniformity of the virtual image may be improved and image blur reduced.

The vergence in the transverse direction may be divergence. The virtual image may be arranged behind the near-eye display device and arranged to be around a typical viewing distance from the viewer. Well-corrected eyes and myopic eyes may be conveniently provided with sharp virtual images.

The lateral anamorphic component and the deflection arrangement may be configured such that the output light from each point of the spatial light modulator has vergence in the lateral direction so that, when the output light is viewed by an eye of a viewer, the vergence of the output light allows the eye of the viewer to focus the output light from a finite viewing distance in the lateral direction. The vergence in the lateral direction may be divergence. The deflection arrangement may be configured to cause divergence in the lateral direction. The deflection features may be curved with negative optical power to cause divergence in the lateral direction. The vergence in the lateral direction may be arranged to match the vergence in the transverse direction and a sharp image may be provided on the retina of a well-corrected eye. The vergence in the lateral direction may be arranged to be different to the vergence in the transverse direction. Correction for astigmatism of the eye may be provided and increased image sharpness may be achieved.

The lateral anamorphic component may be configured to cause divergence in the lateral direction. Aberrations may be reduced and increased fidelity of the perceived virtual image achieved across the exit pupil. The extraction features may be linear in the lateral direction to cause no change of the vergence of the output light in the lateral direction. The cost and complexity of the extraction features may be reduced.

The deflection arrangement may be configured to cause no change of the divergence of the output light in the lateral direction. The deflection features may be linear in the lateral direction to cause no change of the divergence of the output light in the lateral direction. The cost and complexity of the extraction features may be reduced.

The deflection features may be curved with positive optical power in the lateral direction to reduce the divergence caused by the lateral anamorphic component in the lateral direction. The deflection arrangement may be configured to reduce the divergence caused by the lateral anamorphic component in the lateral direction. Each deflection feature may be curved in the lateral direction with a curvature that changes along the extraction waveguide in the second direction. Aberrations may be reduced and increased fidelity of the perceived virtual image achieved across the exit pupil.

According to a second aspect of the present disclosure there is provided an anamorphic directional illumination device that may be an ANEDD, wherein the deflection element may be arranged to direct the deflected light towards an eye of a viewer in front of the anamorphic directional illumination device.

According to a third aspect of the present disclosure there is provided a head-worn display apparatus comprising: an ANEDD according to the second aspect; and a head-mounting arrangement arranged to mount the ANEDD on a head of a wearer with the ANEDD extending across at least one eye of the wearer. VR and AR images may be conveniently provided to moving observers.

The head-worn display apparatus may further comprise lenses having optical power, the ANEDD overlying one or each lens. The nominal viewing distance of the virtual image may be adjusted to achieve reduced discrepancy between accommodation and convergence depth cues in a stereoscopic display apparatus. Correction for visual characteristics of the observer's eyes may be provided.

The head-worn display apparatus may comprise a pair of spectacles. Advantageously a low weight transparent head-worn display apparatus suitable for AR applications may be achieved.

According to a fourth aspect of the present disclosure, the anamorphic directional illumination device may be a vehicle external light device. High illuminance of illuminated scenes may be achieved with high resolution imaging of addressable light cones in one or two dimensions. High image contrast may be achieved for adjustable beam shaping. Image glare to oncoming viewers of the illumination device may be reduced while improved visibility of scenes around the oncoming viewers may be achieved.

The light sources may output light that may be visible light or infra-red light. The array of light sources may include light sources that have different spectral outputs. The different spectral outputs may include: a white light spectrum, plural different white light spectra, red light, orange light, and/or infra-red light. The vehicle light device may be arranged to provide desirable illumination to a scene for human observation or for detection by a detection system. Improved safety of operation may be achieved.

According to a fifth aspect of the present disclosure there may be provided a vehicle external light apparatus comprising: a housing for fitting to a vehicle; a vehicle external light device mounted on the housing. The vehicle external light apparatus may be provided in the vehicle in a rugged package with long lifetime.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments and automotive environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating a rear perspective view of an ANEDD;

FIG. 1B is a schematic diagram illustrating a rear perspective view of the coordinate system arrangements for the ANEDD of FIG. 1A;

FIG. 1C is a schematic diagram illustrating the operation of a near-eye display in a transverse plane;

FIG. 1D is a schematic diagram illustrating the operation of a near-eye display in a lateral plane orthogonal to the transverse plane;

FIG. 1E is a schematic diagram illustrating a rear perspective view of a coordinate system mapping for the ANEDD of FIG. 1A;

FIG. 1F is a schematic diagram illustrating a field-of-view plot of the output of the ANEDD of FIG. 1A for polychromatic illumination;

FIG. 2A, FIG. 2B, FIG. 2C and FIG. 2D are schematic diagrams illustrating in front view arrangements of a SLM for use in the ANEDD of FIG. 1A comprising spatially multiplexed red, green and blue sub-pixels;

FIG. 2E is a schematic diagram illustrating in front view a SLM for use in the ANEDD of FIG. 1A for use with temporally multiplexed spectral illumination;

FIG. 3A is a schematic diagram illustrating a side view of an alternative ANEDD comprising alternating inclined extraction facets comprising a dichroic stack;

FIG. 3B is a schematic diagram illustrating a side view of light extraction and light transmission by the ANEDD of FIG. 3A;

FIG. 3C is a schematic diagram illustrating a front view of polarised light propagation in the ANEDD of FIG. 3A;

FIG. 3D is a schematic graph illustrating the variation of reflectivity for polarised light from a dichroic interface;

FIG. 3E is a schematic diagram illustrating a side view of light input into an extraction waveguide;

FIG. 3F is a schematic diagram illustrating a side view of light propagation along a first direction in an extraction waveguide;

FIG. 3G is a schematic diagram illustrating a side view of light extraction from the ANEDD of FIG. 1A;

FIG. 4A is a schematic diagram illustrating a side view of light output from an ANEDD for a single deflection feature;

FIG. 4B is a schematic diagram illustrating a side view of light output from an ANEDD for multiple deflection features to achieve a full ray cone input in the transverse direction into a pupil of a viewer;

FIG. 4C is a schematic diagram illustrating a side view of light output from an ANEDD for multiple locations for a moving viewer in the transverse direction;

FIG. 5A is a schematic diagram illustrating a rear view of light output from the ANEDD of FIG. 1A;

FIG. 5B is a schematic diagram illustrating a rear view of the ANEDD of FIG. 1A for a single pupil position;

FIG. 5C is a schematic diagram illustrating a rear view of the ANEDD of FIG. 1A for multiple pupil positions;

FIG. 5D is a schematic diagram illustrating a rear view of an extraction waveguide and exit pupil;

FIG. 5E is a schematic diagram illustrating a side view of an unfolded imaging system arranged to image in the transverse direction wherein no reflective deflection features are provided;

FIG. 5F is a schematic diagram illustrating a top view of an unfolded imaging system arranged to image in the lateral direction;

FIG. 5G is a schematic diagram illustrating a side view of an unfolded imaging system arranged to image in the transverse direction wherein an array of deflection features is provided as the reflective extractions features;

FIG. 6A is a schematic diagram illustrating a side view of polarised light propagation in the ANEDD of FIG. 1A;

FIG. 6B is a schematic diagram illustrating a rear view of polarised light propagation in the ANEDD of FIG. 6A;

FIG. 6C is a schematic diagram illustrating a side view of polarised light propagation in an ANEDD wherein the polarisation state propagating along the first direction is orthogonal to the arrangement of FIG. 6A;

FIG. 6D is a schematic diagram illustrating a rear view of polarised light propagation in the ANEDD of FIG. 6C;

FIG. 7A is a schematic diagram illustrating a side view of the operation of an alternative PSR comprising a thin film stack;

FIG. 7B is a schematic graph illustrating the variation of thin film stack transmission against wavelength for incident s-polarised and p-polarised light;

FIG. 7C is a flow chart illustrating compensation of pixel level to correct for transmission of a thin film stack PSR;

FIG. 8A is a schematic diagram illustrating a rear view of an ANEDD comprising an alternative PSR comprising an in-plane liquid crystal layer;

FIG. 8B is a schematic diagram illustrating in top view the liquid crystal layer of the PSR of FIG. 8A;

FIG. 8C is a schematic diagram illustrating in side view the liquid crystal layer of the PSR of FIG. 8A;

FIG. 9A is a schematic diagram illustrating a side view of the operation of an alternative PSR comprising an in-plane liquid crystal layer for p-polarised light propagating in the first direction along the extraction waveguide;

FIG. 9B is a schematic diagram illustrating a side view of the operation of the alternative PSR of FIG. 9A for light propagating in the second direction along the extraction waveguide comprising homogeneously aligned liquid crystal material;

FIG. 9C is a schematic diagram illustrating a side view of the operation of an alternative PSR comprising homeotropically aligned liquid crystal material;

FIG. 9D is a schematic diagram illustrating a side view of an ANEDD comprising a PSR comprising homeotropically aligned liquid crystal material and deflection features comprising homogeneously aligned liquid crystal material;

FIG. 10A is a schematic diagram illustrating a side view of the operation of an alternative PSR comprising a cholesteric liquid crystal layer for light propagating in the first direction along an extraction waveguide;

FIG. 10B is a schematic diagram illustrating a side view of the operation of the alternative PSR of FIG. 10A for light propagating in the second direction along the extraction waveguide;

FIG. 11A, FIG. 11B, and FIG. 11C are schematic diagrams illustrating side views of various arrangements of PSRs;

FIG. 12A is a schematic diagram illustrating a side view of light extraction for a central pixel;

FIG. 12B is a schematic diagram illustrating a side view of light extraction for a top pixel;

FIG. 12C is a schematic diagram illustrating a side view of light extraction for a bottom pixel;

FIG. 12D is a schematic diagram illustrating a side view of exit pupil geometry for an arrangement without guiding of light through the layer of the light deflection features;

FIG. 12E is a schematic diagram illustrating a side view of light extraction for a bottom pixel when some of the light is guided from the front guide surface;

FIG. 12F is a schematic diagram illustrating a side view of exit pupil geometry for an arrangement with guiding of light through the layer of the light deflection features;

FIG. 13A is a schematic diagram illustrating a side view of an alternative ANEDD further comprising partially transmissive dichroic stacks;

FIG. 13B is a schematic diagram illustrating a side view of an alternative ANEDD further comprising a polarisation conversion retarder arranged to provide an elliptical polarisation state;

FIG. 14 is a schematic diagram illustrating a side view of an alternative ANEDD further comprising a partial reflector arranged between a PSR and the deflection arrangement;

FIG. 15A is a schematic diagram illustrating a side view of an alternative ANEDD wherein one of the inclined sections does not comprise a dichroic stack;

FIG. 15B is a schematic diagram illustrating a side view of an alternative ANEDD further comprising guide facets;

FIG. 15C is a schematic diagram illustrating a side view of an alternative ANEDD wherein the dichroic stack is provided on inclined deflection features arranged as a pile of plates;

FIG. 16A is a schematic diagram illustrating a side view of an alternative ANEDD wherein the dichroic stack is provided on inclined deflection features and no front guide surface is provided;

FIG. 16B is a schematic diagram illustrating a side view of an alternative ANEDD wherein the front element is omitted;

FIG. 16C is a schematic diagram illustrating a side view of an alternative ANEDD wherein the dichroic stack is provided on inclined deflection features, and the dichroic stack is not provided on the inclined draft facets;

FIG. 17A is a schematic diagram illustrating in rear perspective view an alternative arrangement of the ANEDD wherein some of the polarising beam splitters do not extend the entirety of the thickness of the extraction waveguide;

FIG. 17B is a schematic diagram illustrating in side view the operation of the ANEDD of FIG. 17A;

FIG. 18A is a schematic diagram illustrating in rear perspective view an alternative arrangement of the ANEDD wherein the polarising beam splitters are patterned;

FIG. 18B is a schematic diagram illustrating in side view the operation of the ANEDD of FIG. 18A;

FIG. 19A is a schematic diagram illustrating a side view of the operation of an array of deflection features comprising a surface relief grating;

FIG. 19B is a schematic diagram illustrating a side view of the operation of an array of deflection features comprising a volume diffractive optical element;

FIG. 19C is a schematic diagram illustrating a side view of the operation of an array of deflection features comprising different types of deflection features;

FIG. 20A is a schematic diagram illustrating in rear perspective view an alternative arrangement of the ANEDD comprising first and second PSRs and respective first and second deflection elements that comprise deflection reflectors;

FIG. 20B is a schematic diagram illustrating in side view the operation of the alternative arrangement of FIG. 20A;

FIG. 20C is a schematic diagram illustrating in rear perspective view an alternative arrangement of the ANEDD comprising first and second PSRs, front deflection element that comprises polarisation-sensitive deflection reflectors and a rear deflection element that comprises a structured rear guide surface;

FIG. 20D is a schematic diagram illustrating in side view the operation of the alternative arrangement of FIG. 20C;

FIG. 21A is a schematic diagram illustrating a side view of optical isolation for an ANEDD comprising an emissive SLM;

FIG. 21B is a schematic diagram illustrating optical axis alignment directions through the polarisation control components of FIG. 21A;

FIG. 21C is a schematic diagram illustrating a side view of optical isolation for an ANEDD comprising a transmissive or reflective SLM;

FIG. 21D is a schematic diagram illustrating optical axis alignment directions through the polarisation control components of FIG. 21C;

FIG. 21E is a schematic diagram illustrating in side view a polarisation recirculation arrangement for light input into a waveguide;

FIG. 21F is a schematic diagram illustrating in side view operation of a polarisation recirculation arrangement for light input into the waveguide from a SLM;

FIG. 22A is a schematic graph of the variation of facet width with position along the extraction waveguide for various illustrative arrangements of deflection features;

FIG. 22B is a schematic diagram illustrating in rear view an arrangement of chirped deflection features for a monocular near-eye anamorphic display apparatus;

FIG. 22C is a schematic diagram illustrating in rear view an arrangement of chirped deflection features for a binocular near-eye anamorphic display apparatus;

FIG. 23A is a schematic diagram illustrating in rear perspective view an AR head-worn display apparatus comprising a right-eye anamorphic display apparatus arranged with SLM in brow position;

FIG. 23B is a schematic diagram illustrating in rear perspective view an AR head-worn display apparatus comprising left-eye and right-eye anamorphic display apparatuses arranged with SLM in brow position;

FIG. 23C is a schematic diagram illustrating in rear perspective view an eyepiece arrangement for an AR head-worn display apparatus;

FIG. 24A is a schematic diagram illustrating in rear perspective view an ANEDD with SLM in temple position;

FIG. 24B is a schematic diagram illustrating in rear perspective view an AR head-worn display apparatus comprising a left-eye anamorphic display apparatus arranged with SLM in temple position;

FIG. 24C is a schematic diagram illustrating in rear perspective view an AR head-worn display apparatus comprising left-eye and right-eye anamorphic display apparatuses arranged with SLM in temple position;

FIG. 25A is a schematic diagram illustrating in rear view a VR head-worn display apparatus comprising left-eye and right-eye anamorphic display apparatuses;

FIG. 25B is a schematic diagram illustrating in side view a VR head-worn display apparatus comprising an ANEDD;

FIG. 25C is a schematic diagram illustrating in rear view an alternative VR head-worn display apparatus comprising left-eye and right-eye anamorphic display apparatuses;

FIG. 25D is a schematic diagram illustrating in side view the VR head-worn display apparatus of FIG. 25C;

FIG. 26A is a schematic diagram illustrating in rear view an ANEDD comprising a single waveguide suitable for use by both eyes of a display user;

FIG. 26B is a schematic diagram illustrating in side view a head-worn display apparatus comprising two ANEDDs;

FIG. 26C is a schematic diagram illustrating a composite image;

FIG. 27A is a schematic diagram illustrating in side view a VR head-worn display apparatus comprising an ANEDD arranged to receive light from a magnifying lens and additional SLM;

FIG. 27B is a schematic diagram illustrating in side view a VR head-worn display apparatus comprising an ANEDD arranged between the anamorphic SLM and magnifying lens of a non-ANEDD;

FIG. 28A is a schematic diagram illustrating in side view an arrangement of virtual image distances for a VR display apparatus;

FIG. 28B and FIG. 28C are schematic diagrams illustrating displayed images for the arrangement of FIG. 28A;

FIG. 29A is a schematic diagram illustrating in rear view an ANEDD comprising a reflective end comprising a Pancharatnam-Berry lens;

FIG. 29B is a schematic diagram illustrating in end view the optical structure of a Pancharatnam-Berry lens;

FIG. 29C is a schematic diagram illustrating in rear view an optical structure of the Pancharatnam-Berry lens of FIG. 29B;

FIG. 30A is a schematic graph illustrating the variation of phase difference with lateral position for an illustrative Pancharatnam-Berry lens of FIG. 29B;

FIG. 30B is a schematic diagram illustrating in side view the operation of the Pancharatnam-Berry lens of FIG. 29A;

FIG. 31A is a schematic diagram illustrating in side view the operation of an ANEDD further comprising a corrective spectacle lens;

FIG. 31B is a schematic diagram illustrating in side view the operation of an ANEDD further comprising a corrective Pancharatnam-Berry lens and a corrective spectacle lens;

FIG. 32A is a schematic diagram illustrating in side view a head-worn display apparatus comprising first and second focal plane modifying lenses;

FIG. 32B is a schematic diagram illustrating in side view a head-worn display apparatus comprising plural extraction waveguides and further comprising first and second focal plane modifying lenses;

FIG. 32C is a schematic diagram illustrating in side view a head-worn display apparatus comprising plural extraction waveguides and three focal plane modifying lenses;

FIG. 32D is a schematic diagram illustrating in side view a head-worn display apparatus comprising a non-ANEDD and an anamorphic extraction waveguide;

FIG. 32E is a schematic diagram illustrating in side view a head-worn display apparatus comprising a non-ANEDD; an anamorphic extraction waveguide; and a focal plane modifying lens arranged between the non-ANEDD and the ANEDD;

FIG. 32F is a schematic diagram illustrating in side view a head-worn display apparatus comprising a non-ANEDD; an anamorphic extraction waveguide; and a focal plane modifying lens arranged to receive light from the non-ANEDD and the ANEDD;

FIG. 32G is a schematic diagram illustrating in side view a head-worn display apparatus comprising a non-ANEDD; an anamorphic extraction waveguide; and two focal plane modifying lenses;

FIG. 32H is a schematic diagram illustrating in side view a head-worn display apparatus comprising a non-ANEDD; two anamorphic extraction waveguides; and focal plane modifying lenses;

FIG. 33A is a schematic diagram illustrating a rear perspective view of an ANEDD arranged to provide visibility of an external real object and to provide a virtual image at a finite viewing distance wherein an optical waveguide comprises light deflection features that extend through the optical waveguide;

FIG. 33B is a schematic diagram illustrating a rear perspective view of virtual image formation from the ANEDD of FIG. 33A;

FIG. 33C is a schematic diagram illustrating a rear perspective view of real image formation through the ANEDD of FIG. 33A;

FIG. 33D is a schematic diagram illustrating a side view of light output from the ANEDD of FIG. 1B to provide a virtual image at a finite viewing distance in the transverse direction;

FIG. 33E is a schematic diagram illustrating a side view of light output from the ANEDD of FIG. 33D to provide a virtual image at a finite viewing distance in the transverse direction;

FIG. 33F is a schematic diagram illustrating a front perspective view of an ANEDD comprising deflection features that are curved with negative optical power in the lateral direction that is the same across the array of deflection features;

FIG. 33G is a schematic diagram illustrating a front perspective view of an ANEDD comprising deflection features that are straight in the lateral direction and the shape of the lateral anamorphic component is provided with additional negative optical power;

FIG. 33H is a schematic diagram illustrating a front perspective view of an ANEDD comprising deflection features that are curved in the lateral direction with negative optical power that varies across the array of deflection features;

FIG. 33I is a schematic diagram illustrating a front perspective view of an ANEDD comprising deflection features that are curved with positive optical power in the lateral direction and the shape of the lateral anamorphic component is provided with additional negative optical power;

FIG. 33J is a schematic diagram illustrating a rear perspective view of an ANEDD further comprising a corrective lens to compensate for ophthalmic conditions of the eye of the viewer;

FIG. 33K is a schematic diagram illustrating in side and top views light output from an ANEDD not comprising the curved light deflection features of the type of FIG. 1A;

FIG. 33L is a schematic diagram illustrating in side and top views light output from an ANEDD of the type of FIG. 1A;

FIG. 33M is a schematic diagram illustrating in side and top views light output from an ANEDD of the type of FIG. 1A and further arranged to provide vision correction for the hyperopic eye of a viewer;

FIG. 33N is a schematic diagram illustrating in side and top views light output from an ANEDD of the type of FIG. 1A and further arranged to provide vision correction for the myopic astigmatic eye of a viewer;

FIG. 33O is a schematic diagram illustrating in side view operation of a diverging corrective lens for a myopic eye;

FIG. 33P is a schematic diagram illustrating in side view operation of the arrangement of FIG. 33N wherein the virtual image is arranged for an infinite conjugate distance;

FIG. 33Q is a schematic diagram illustrating in side view operation of the arrangement of FIG. 33N wherein the virtual image is arranged for a finite conjugate distance;

FIG. 33R is a schematic diagram illustrating a top view of a stereoscopic ANEDD display device incorporating front views of virtual images arranged to provide a stereoscopic virtual image at a finite viewing distance;

FIG. 33S is a schematic diagram illustrating a rear perspective view of an alternative near-eye display device arranged to provide first and second virtual images at a finite viewing distances and comprising a non-anamorphic display device and an ANEDD arranged in series;

FIG. 33T is a schematic diagram illustrating a side view of the operation of the arrangement of FIG. 33S;

FIG. 34A is a schematic diagram illustrating in side view a detail of an arrangement of an input focussing lens;

FIG. 34B is a schematic diagram illustrating in rear view a detail of the arrangement of the input focussing lens of FIG. 34A;

FIG. 35A is a schematic diagram illustrating in side view a SLM arrangement for use in the ANEDD of FIG. 1 comprising separate red, green and blue SLMs and a beam-combining element;

FIG. 35B is a schematic diagram illustrating in side view an illumination system for use in the ANEDD of FIG. 1 comprising a birdbath folded arrangement;

FIG. 35C is a schematic diagram illustrating in side view a SLM arrangement for use in an ANEDD comprising a transverse anamorphic component comprising a reflector;

FIG. 35D is a schematic diagram illustrating in front perspective view an alternative arrangement of an input focussing lens;

FIG. 35E is a schematic diagram illustrating in side view an alternative arrangement of an input focussing lens comprising a pancake lens;

FIG. 35F is a schematic diagram illustrating in side view a SLM arrangement for use in the ANEDD of FIG. 1 comprising a SLM comprising a laser scanner and light diffusing screen;

FIG. 35G is a schematic diagram illustrating in front perspective view a SLM comprising a microlens array for use in the ANEDD of FIG. 1A;

FIG. 35H, FIG. 35I, FIG. 35J and FIG. 35K are schematic diagrams illustrating in side views arrangements of pixels and refractive microlens arrays for use in the ANEDD of FIG. 1A;

FIG. 35L is a schematic diagram illustrating in side view arrangements of pixels and a diffractive microlens array for use in the ANEDD of FIG. 1A;

FIG. 35M is a schematic diagram illustrating in unfolded front perspective view the operation of an ANEDD comprising the SLM comprising the microlens of FIG. 35G;

FIG. 36A is a schematic diagram illustrating in side view input to the extraction waveguide comprising a laser sources and scanning arrangement;

FIG. 36B is a schematic diagram illustrating in front view a SLM arrangement comprising an array of laser light sources for use in the arrangement of FIG. 36A;

FIG. 36C is a schematic diagram illustrating in side view a SLM arrangement comprising an array of laser light sources, a beam expander and a scanning mirror;

FIG. 37A is a schematic diagram illustrating a rear perspective view of an ANEDD comprising an input reflector;

FIG. 37B is a schematic diagram illustrating a side view of the ANEDD of FIG. 37A;

FIG. 37C is a schematic diagram illustrating a rear view of the ANEDD of FIG. 37A;

FIG. 37D is a schematic diagram illustrating a side view of an alternative ANEDD comprising an input reflector;

FIG. 37E is a schematic diagram illustrating a side view of an ANEDD comprising an alternative input reflector;

FIG. 37F is a schematic diagram illustrating a side view of an ANEDD comprising an alternative input reflector;

FIG. 37G is a schematic diagram illustrating a side view of an ANEDD comprising an alternative input reflector;

FIG. 38A is a schematic diagram illustrating in rear perspective view an ANEDD comprising a stepped extraction interface and an eye tracking arrangement;

FIG. 38B is a schematic diagram illustrating in side view an ANEDD comprising an eye tracking arrangement with a transmissive hole arranged at the reflective end;

FIG. 38C is a schematic diagram illustrating in side view an ANEDD comprising an eye tracking arrangement with a partially transmissive mirror arranged at the reflective end;

FIG. 39A is a schematic diagram illustrating a rear perspective view of an anamorphic directional illumination device; and

FIG. 39B is a schematic diagram illustrating a side view of a road scene comprising a vehicle comprising a vehicle external light apparatus comprising the anamorphic directional illumination device of FIG. 39A.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) have equivalent birefringence.

The optical axis of an optical retarder refers to the direction of propagation of a light ray in the uniaxial birefringent material in which no birefringence is experienced. This is different from the optical axis of an optical system which may for example be parallel to a line of symmetry or normal to a display surface along which a principal ray propagates.

For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials the slow axis direction is the extraordinary axis of the birefringent material. For negative dielectric anisotropy uniaxial birefringent materials the fast axis direction is the extraordinary axis of the birefringent material.

The terms half a wavelength and quarter a wavelength refer to the operation of a retarder for a design wavelength λ₀ that may typically be between 500 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components; which is related to the birefringence Δn and the thickness d of the retarder with retardance Δn. d by:

$$Γ = 2 \cdot π \cdot Δ n \cdot d / {λ}_{0} \qquad eqn . 1$$

In eqn. 1, Δn is defined as the difference between the extraordinary and the ordinary index of refraction, i.e.

$$Δ n = {n}_{e} - {n}_{o} \qquad eqn . 2$$

For a half-wave retarder, the relationship between d, Δn, and λ₀ is chosen so that the phase shift between polarization components is Γ=π. For a quarter-wave retarder, the relationship between d, Δn, and λ₀ is chosen so that the phase shift between polarization components is Γ=π/2.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current description, the SOP may be termed the polarisation state.

A linear SOP has a polarisation component with a non-zero amplitude and an orthogonal polarisation component which has zero amplitude. A p-polarisation state is a linear polarisation state that lies within the plane of incidence of a ray comprising the p-polarisation state and a s-polarisation state is a linear polarisation state that lies orthogonal to the plane of incidence of a ray comprising the p-polarisation state. For a linearly polarised SOP incident onto a retarder, the relative phase F is determined by the angle between the optical axis of the retarder and the direction of the polarisation component.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter-wave retarder arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

Achromatic retarders may be provided wherein the material of the retarder is provided with a retardance Δn. d that varies with wavelength λ as

$$Δ n \cdot d / λ = κ \qquad eqn . 3$$

where κ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

Various other terms used in the present disclosure related to retarders and to liquid crystals will now be described.

A liquid crystal cell has a retardance given by Δn. d where Δn is the birefringence of the liquid crystal material in the liquid crystal cell and d is the thickness of the liquid crystal cell, independent of the alignment of the liquid crystal material in the liquid crystal cell.

Homogeneous alignment refers to the alignment of liquid crystals in switchable liquid crystal displays where molecules align substantially parallel to a substrate. Homogeneous alignment is sometimes referred to as planar alignment. Homogeneous alignment may typically be provided with a small pre-tilt such as 2 degrees, so that the molecules at the surfaces of the alignment layers of the liquid crystal cell are slightly inclined as will be described below. Pretilt is arranged to minimise degeneracies in switching of cells.

In the present disclosure, homeotropic alignment is the state in which rod-like liquid crystalline molecules align substantially perpendicularly to the substrate. In discotic liquid crystals homeotropic alignment is defined as the state in which an axis of the column structure, which is formed by disc-like liquid crystalline molecules, aligns perpendicularly to a surface. In homeotropic alignment, pretilt is the tilt angle of the molecules that are close to the alignment layer and is typically close to 90 degrees and for example may be 88 degrees.

In a twisted liquid crystal layer, a twisted configuration (also known as a helical structure or helix) of nematic liquid crystal molecules is provided. The twist may be achieved by means of a non-parallel alignment of alignment layers. Further, cholesteric dopants may be added to the liquid crystal material to break degeneracy of the twist direction (clockwise or anti-clockwise) and to further control the pitch of the twist in the relaxed (typically undriven) state. A supertwisted liquid crystal layer has a twist of greater than 180 degrees. A twisted nematic layer used in SLMs typically has a twist of 90 degrees.

Liquid crystal molecules with positive dielectric anisotropy are switched from a homogeneous alignment (such as an A-plate retarder orientation) to a homeotropic alignment (such as a C-plate or O-plate retarder orientation) by means of an applied electric field.

Liquid crystal molecules with negative dielectric anisotropy are switched from a homeotropic alignment (such as a C-plate or O-plate retarder orientation) to a homogeneous alignment (such as an A-plate retarder orientation) by means of an applied electric field.

Rod-like molecules have a positive birefringence so that nₑ>nₒ as described in eqn. 2. Discotic molecules have negative birefringence so that nₑ<nₒ.

Positive retarders such as A-plates, positive O-plates and positive C-plates may typically be provided by stretched films or rod-like liquid crystal molecules. Negative retarders such as negative C-plates may be provided by stretched films or discotic-like liquid crystal molecules.

Parallel liquid crystal cell alignment refers to the alignment direction of homogeneous alignment layers being parallel or more typically antiparallel. In the case of pre-tilted homeotropic alignment, the alignment layers may have components that are substantially parallel or antiparallel. Hybrid aligned liquid crystal cells may have one homogeneous alignment layer and one homeotropic alignment layer. Twisted liquid crystal cells may be provided by alignment layers that do not have parallel alignment, for example oriented at 90 degrees to each other.

The structure and operation of various anamorphic near-eye display devices will now be described. In this description, common elements have common reference numerals. It is noted that the disclosure relating to any element applies mutatis mutandi to each device in which the same or corresponding element is provided. Accordingly, for brevity such disclosure is not repeated. Similarly, the various features of any of the following examples may be combined together in any combination.

It would be desirable to provide an anamorphic near-eye display device (ANEDD) 100 with a thin form factor, large freedom of movement, high resolution, high brightness and wide field of view. An ANEDD 100 will now be described.

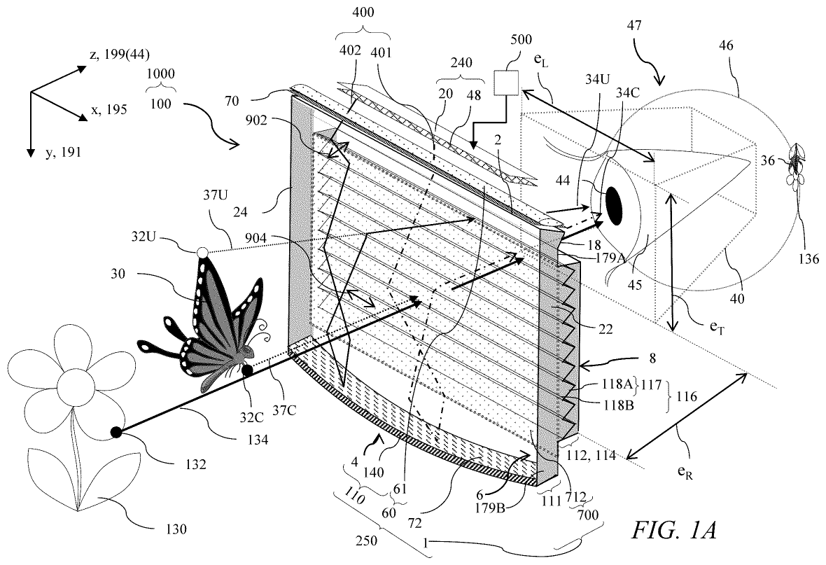

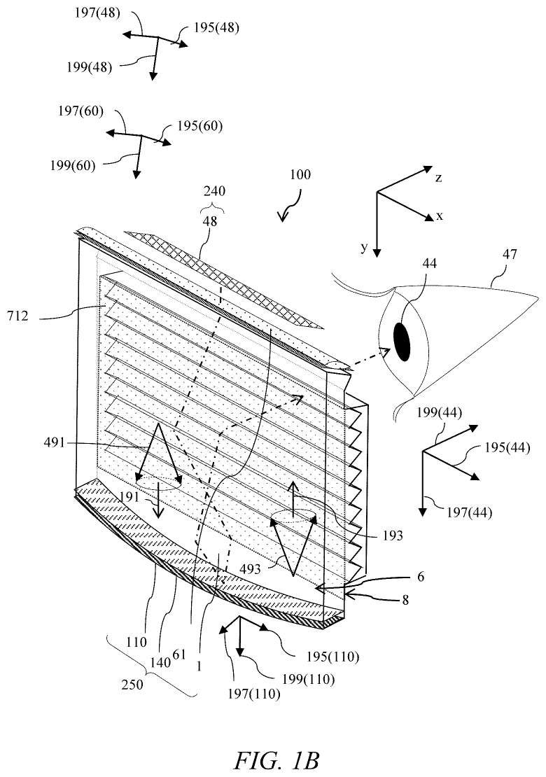

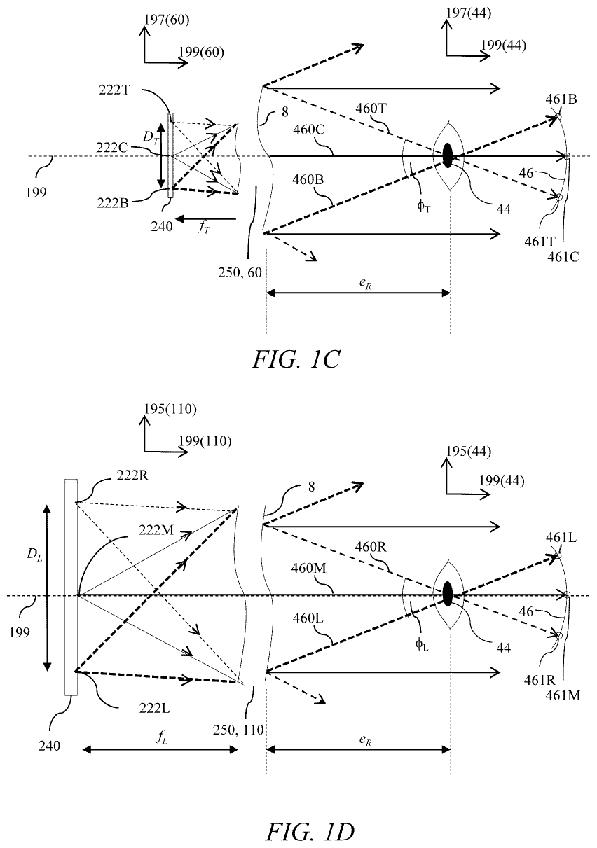

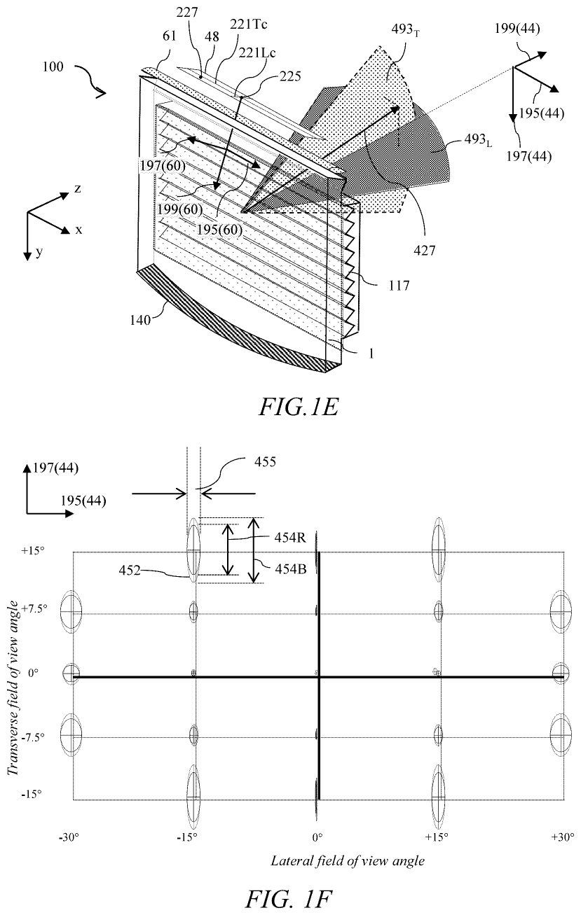

FIG. 1A is a schematic diagram illustrating a rear perspective view of an ANEDD 100; and FIG. 1B is a schematic diagram illustrating a rear perspective view of the coordinate system arrangements for the ANEDD 100 of FIG. 1A.

FIGS. 1A-B illustrate an anamorphic directional illumination device 1000 that is an ANEDD 100 provided near to an eye 45, to provide light to the pupil 44 of the eye 45 of a viewer 47.

In an illustrative embodiment, the eye 45 may be arranged at a nominal viewing distance e_{R} of between 5 mm and 100 mm and preferably between 8 mm and 25 mm from the output surface of the ANEDD 100. Such displays are distinct from direct view displays wherein the viewing distance is typically greater than 100 mm. The nominal viewing distance e_{R} may be referred to as the eye relief.

The ANEDD 100 comprises an illumination system 240 comprising a spatial light modulator (SLM) 48 and arranged to output light and an optical system 250 arranged to direct light from the illumination system 240 to the eye 45 of a viewer 47. The illumination system 240 is arranged to output light rays 400 including illustrative light rays 401, 402 that are input into the optical system 250 and as will be described hereinbelow are output towards the pupil 44 of the eye 45 as rays 34C, 34U respectively.

In operation, it is desirable that the spatial pixel data provided on the SLM 48 is directed to the pupil 44 of the eye 45 as angular pixel data. The lens of the eye 45 of the viewer 47 relays the angular pixel data to spatial pixel data as image 36 at the retina 46 of the eye 45 to provide a perceived virtual image 30, and further the eye 45 images the object 130 to retinal image 136.

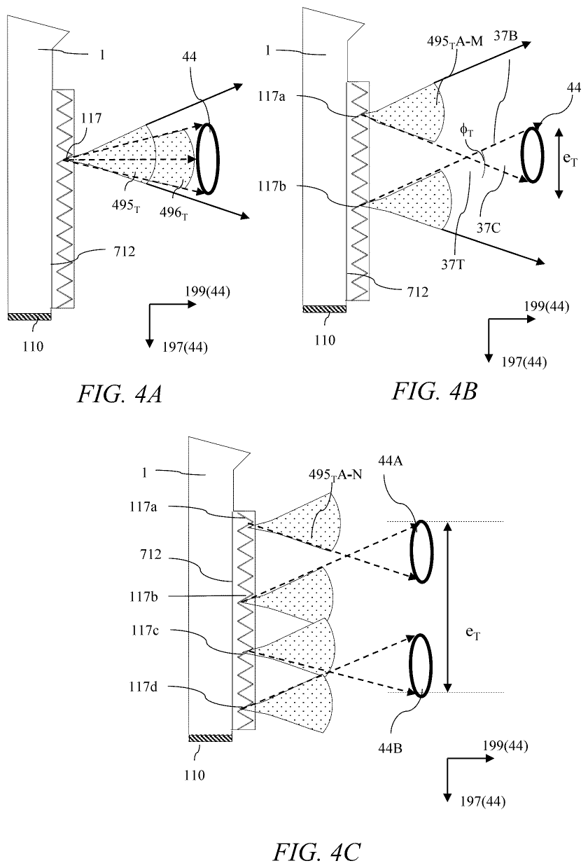

In the ANEDD 100, the pixels 222 provide image data for the eye 45 of the viewer 47. The pupil 44 of the eye 45 of the viewer 47 is located in a spatial volume near to the ANEDD 100 commonly referred to as the exit pupil 40, or eyebox. When the pupil 44 is located within the exit pupil 40, the viewer 47 is provided with a full image without missing parts of the image, that is the image does not appear to be vignetted at the retina 46 of the eye 45 of the viewer 47. The shape of the exit pupil 40 is determined at least by the anamorphic imaging properties of the ANEDD and the respective aberrations of the anamorphic optical system. The exit pupil 40 at a nominal eye relief distance e_{R} may have dimension e_{L} in the lateral direction 195 and dimension e_{T} in the transverse direction 197. The maximum eye relief distance e_{Rmax} refers to the maximum distance of the pupil 44 from the ANEDD 100 wherein no image vignetting is present. In the present embodiment, increasing the size of the exit pupil 40 refers to increasing the dimensions e_{L}, e_{T}. Increased exit pupil 40 achieves an increased viewer freedom and an increase in e_{Rmax} as will be described further hereinbelow with reference to FIGS. 4A-C for example.

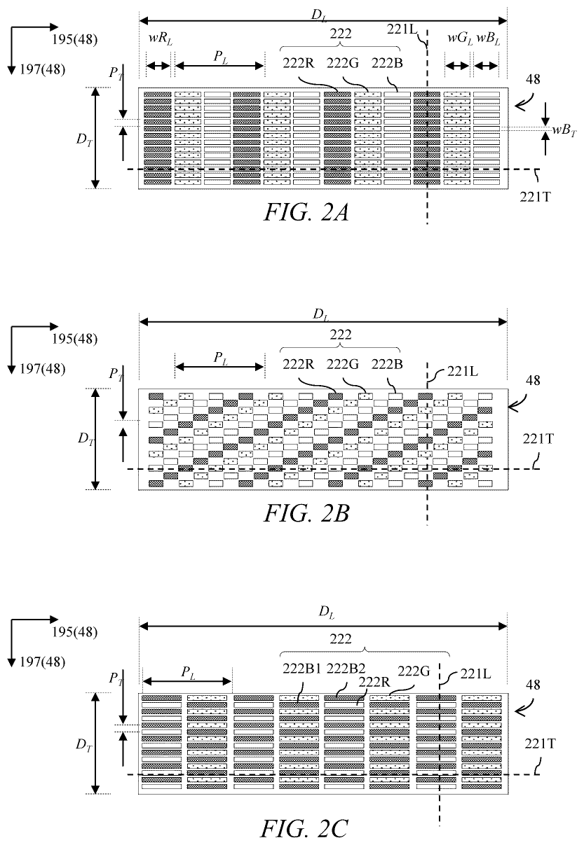

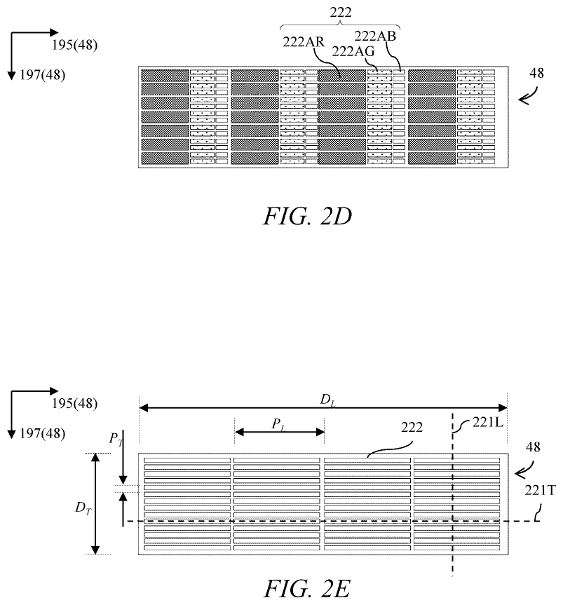

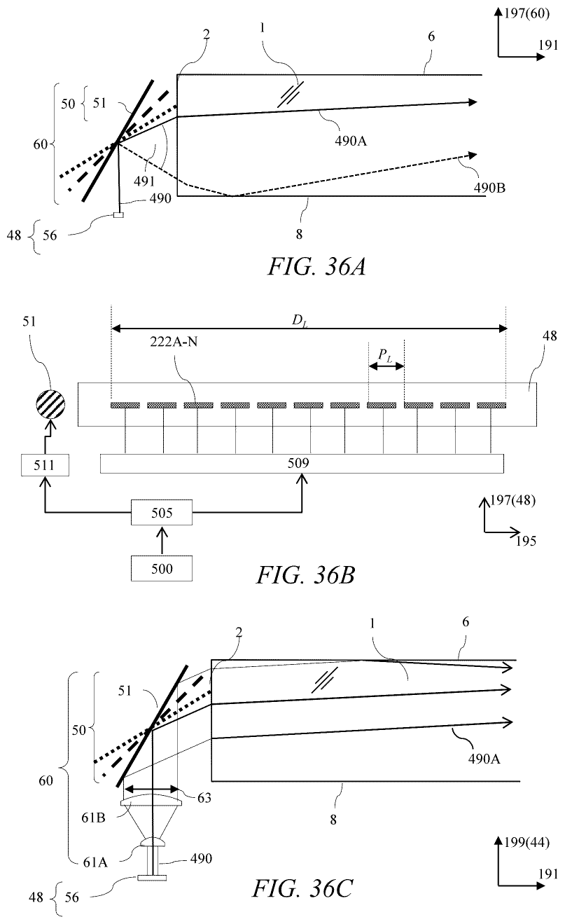

The SLM 48 comprises pixels 222 distributed at least in the lateral direction 195 as will be described further hereinbelow, for example in FIGS. 2A-E and FIG. 36B. In the illustrative embodiment of FIG. 1A, the illumination system 240 comprises a transmissive SLM 48 comprising an array of spatially separated pixels 222 distributed in a lateral direction 195(48) and transverse direction 197(48). In the embodiment of FIG. 1A, the SLM 48 is a TFT-LCD and illumination system 240 further comprises a backlight 20 arranged to illuminate the SLM 48.

The ANEDD 100 further comprises a control system 500 arranged to operate the illumination system 240 to provide light that is spatially modulated in accordance with image data representing an image.

The optical system 250 comprises a transverse anamorphic component 60 comprising transverse lens 61 in the embodiment of FIG. 1A, as discussed below. The transverse lens 61 comprises a cylindrical lens in this example.

A transverse anamorphic component 60 is arranged to receive light rays 400 from the SLM 48. The illumination system 240 is arranged so that light output from the transverse anamorphic component 60 is directed in directions that are distributed in the transverse direction 197(60).

In the embodiment of FIG. 1A, the transverse anamorphic component 60 is a transverse lens 61 that is extended in a lateral direction 195(60) parallel to the lateral direction 195(48) of the SLM 48. The transverse anamorphic component 60 that is lens 61 has positive optical power in a transverse direction 197(60) that is parallel to the direction 197(48) and orthogonal to the lateral direction 195(60); and no optical power in the lateral direction 195(60).

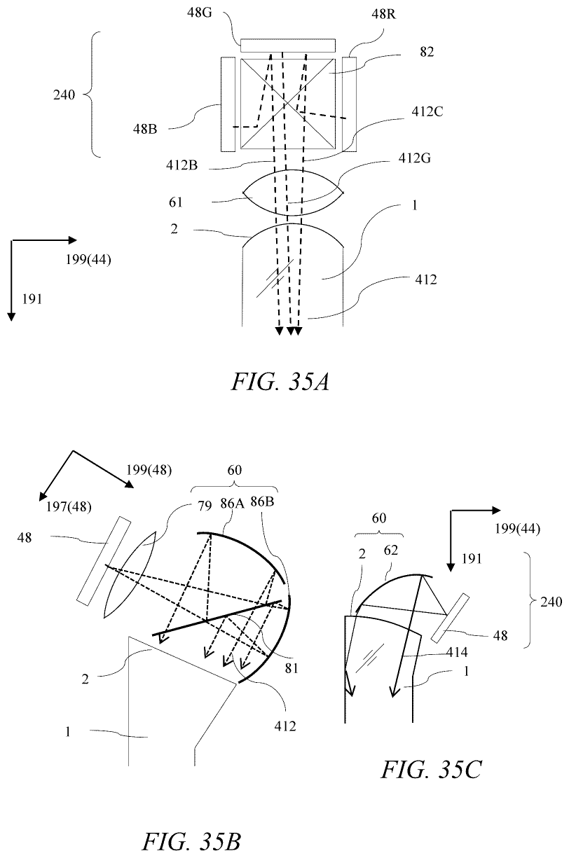

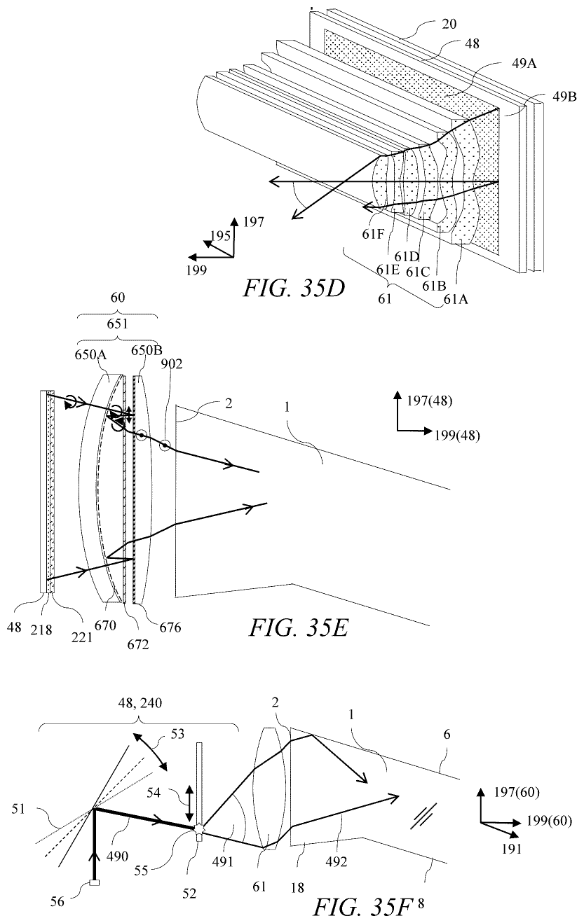

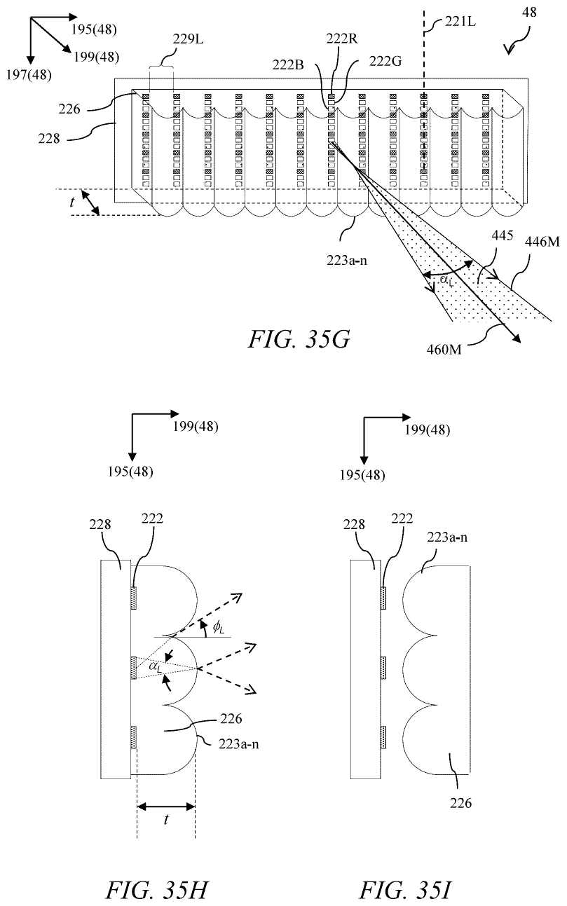

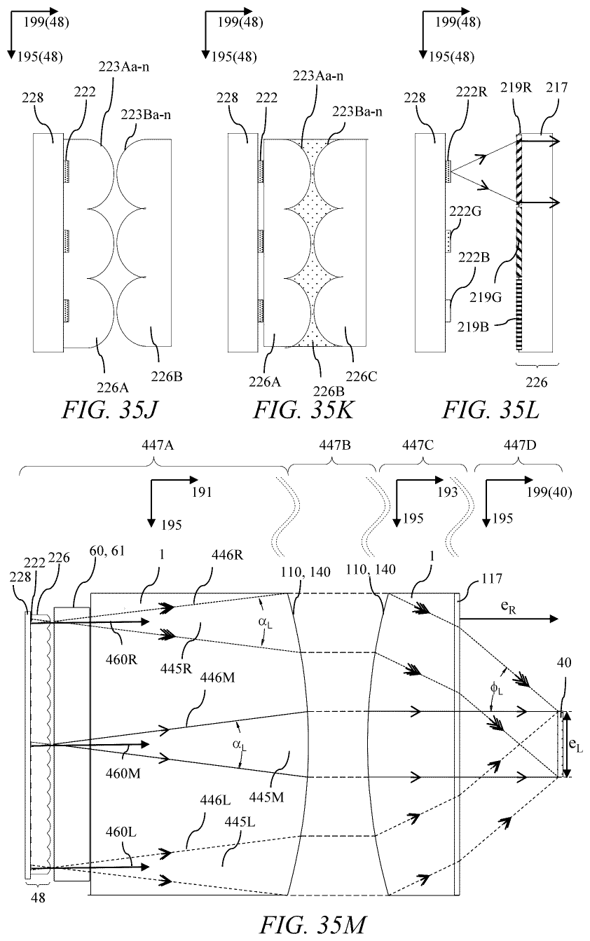

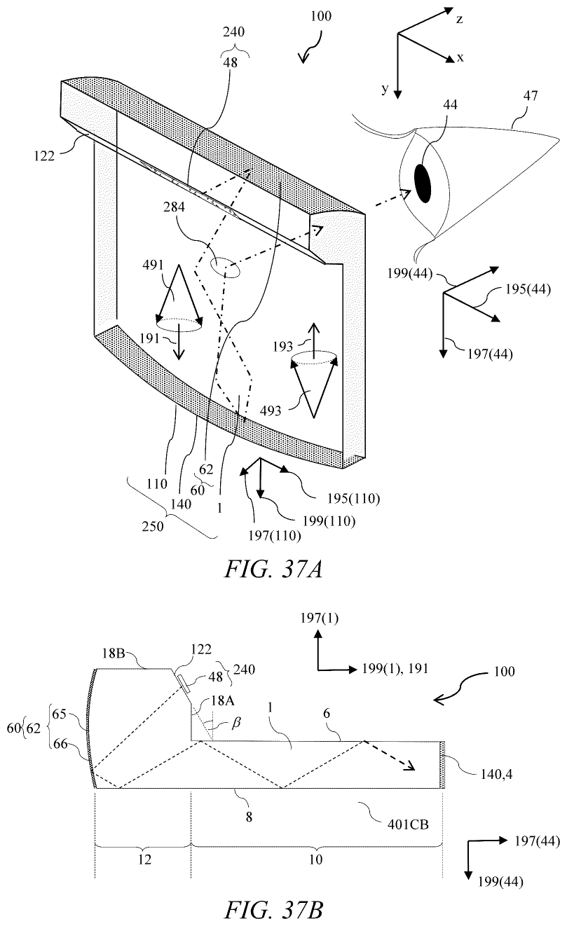

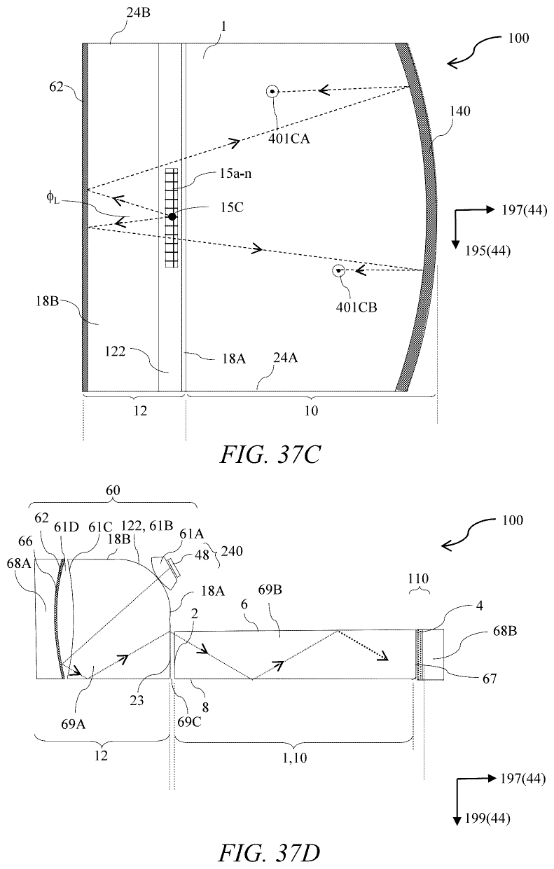

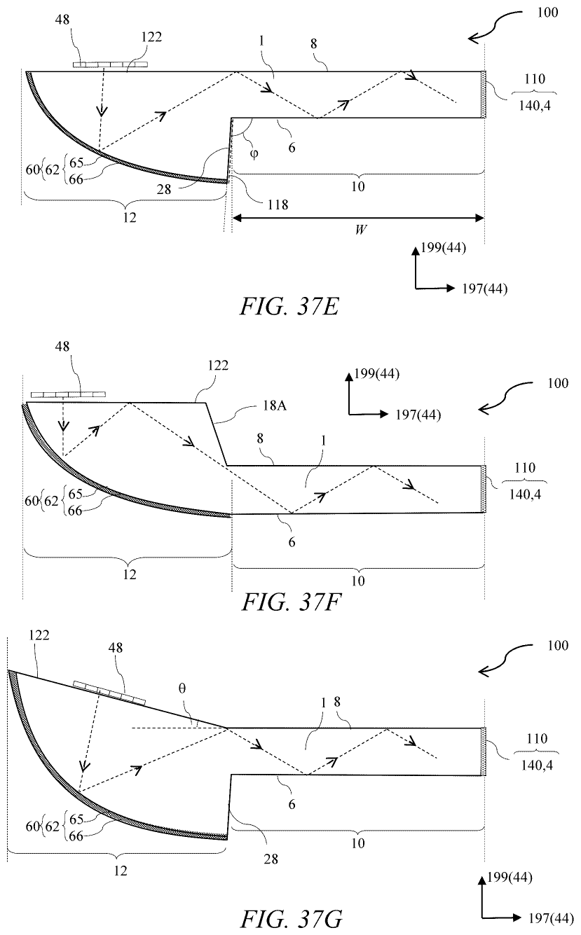

In the present disclosure, the term lens most generally refers to a single lens element or most commonly a compound lens (group of lens elements) as will be described hereinbelow in FIG. 37 for example; and is arranged to provide optical power. A lens may comprise a single refractive surface, multiple refractive surfaces, reflective surfaces or may comprise a catadioptric lens element that combines refractive and reflective surfaces for example as illustrated in FIG. 35C hereinbelow. A lens may further or alternatively comprise diffractive optical elements. A transverse lens is a lens that provides optical power in the transverse direction. Typically a transverse lens provides no optical power in the lateral direction. A transverse lens may be termed a cylindrical lens, although the profile in cross section of the surface or surfaces providing optical power may be different to a segment of a circle, for example paraboidal, elliptical or aspheric. The transverse lens 61 may comprise a pancake lens, for example as illustrated in FIG. 35E hereinbelow. Advantageously aberrations in the transverse direction 197 may be improved and thickness reduced.

The optical system 250 further comprises an extraction waveguide 1 arranged to receive light from the transverse lens 61 and arranged to guide light rays 400 in cone 491 from the transverse lens 61 to a lateral anamorphic component 110 along the extraction waveguide 1 in a first direction 191. The lateral anamorphic component 110 has positive optical power in the lateral direction 195.

The extraction waveguide 1 comprises a rear guide surface 6 and a polarisation-sensitive reflector (PSR) 700 opposing the rear guide surface 6. The extraction waveguide 1 comprises waveguide member 111 arranged between the rear guide surface 6 and the PSR 700, wherein light guides through the waveguide member 111 in the first direction 191.

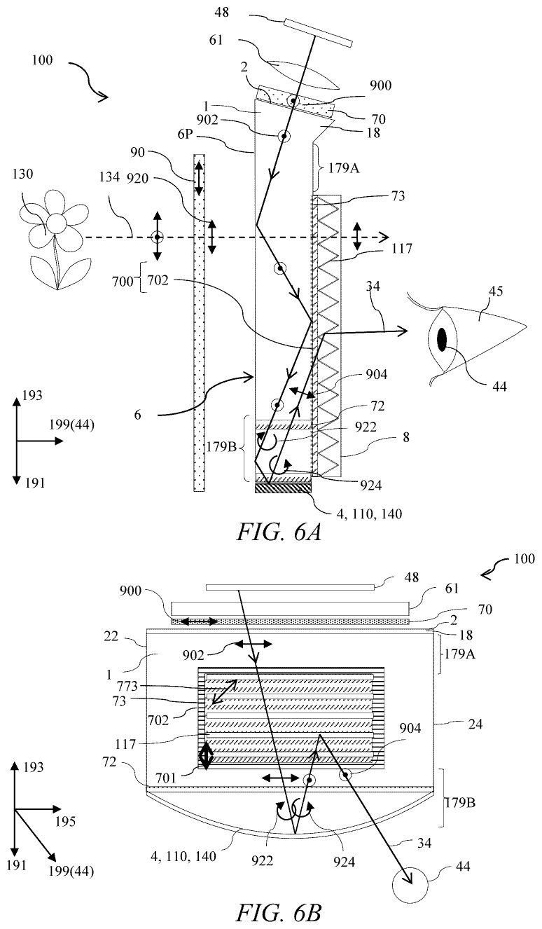

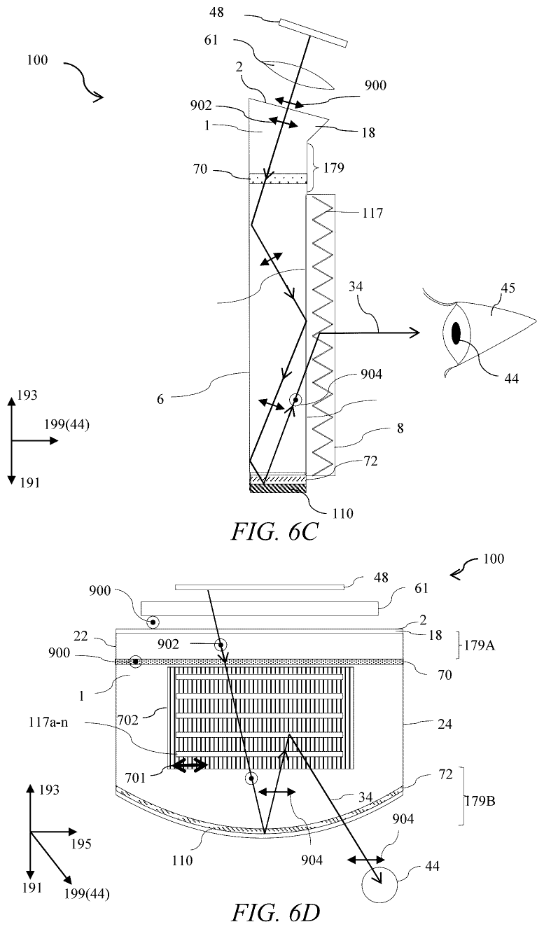

One example of a PSR 700 is a dichroic stack 712. Other types of PSR 700 will be described further hereinbelow, for example reflective linear polarisers 702 as described in FIGS. 6A-F hereinbelow.

The extraction waveguide 1 further has an input end 2 extending in the lateral and transverse directions 195(60), 197(60), the extraction waveguide member 111 of the waveguide 1 being arranged to receive light 400 from the illumination system 240 through the input end 2. The input end 2 extends in the lateral direction 195 between edges 22, 24 of the extraction waveguide 1, and extends in the transverse direction between opposing surfaces of the extraction waveguide 1 waveguide member 111.

The optical system 250 further comprises a light reversing reflector 140 arranged to reflect the light rays 400 in light cones 491 that have been guided along the extraction waveguide 1 in the first direction 191. FIG. 1B illustrates that the reflected light rays 400 in light cone 493 with polarisation state 904 is light that is formed to be guided along the extraction waveguide 1 in a second direction 193 opposite to the first direction 191 and so that reflected cone 493 is guided back through the extraction waveguide 1.

In the embodiment of FIG. 1A, the light reversing reflector 140 is a reflective end 4 of the extraction waveguide 1. Furthermore, the lateral anamorphic component 110 comprises the light reversing reflector 140. The reflective end 4 of the extraction waveguide 1 has a curved shape in the lateral direction 195 that provides positive optical power, affecting the light rays in cone 491 in the lateral direction 195(110), and no power in the transverse direction 197(110). The optical system 250 is thus arranged so that light output from the lateral anamorphic component 110 is directed in directions that are distributed in the transverse direction 197(110) and the lateral direction 195(110). The curved shape of the reflective end 4 may be a shape that is the cross section of a sphere, ellipse, parabola or other aspheric shape to achieve desirable imaging of light rays from the SLM 48 to the pupil 44 of the eye 45 as will be described further hereinbelow.

PSR 700 may not extend along the entirety of the waveguide member 111. Waveguide member 111 guiding regions 179A, 179B may be arranged along the waveguide member 111 between an input end 2 and the PSR 700, and between the PSR 700 and light reversing reflector 140. The front guide surface 8 of the extraction waveguide 1 may comprise the guiding regions 179A, 179B.

The anamorphic directional illumination device 1000 comprising the ANEDD 100 further comprises a deflection arrangement 112 disposed outside the PSR 700, in other words the PSR 700 is arranged between the deflection arrangement 112 and waveguide member 111.

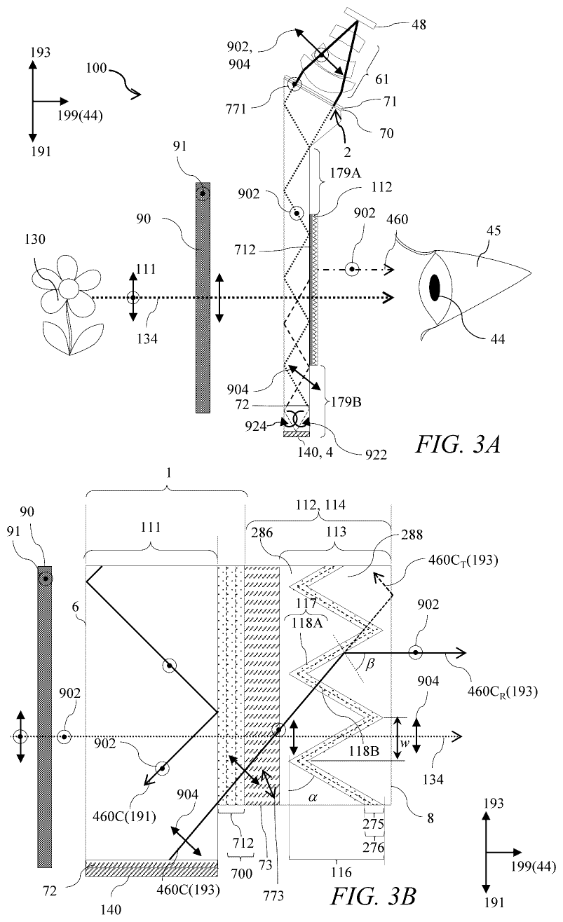

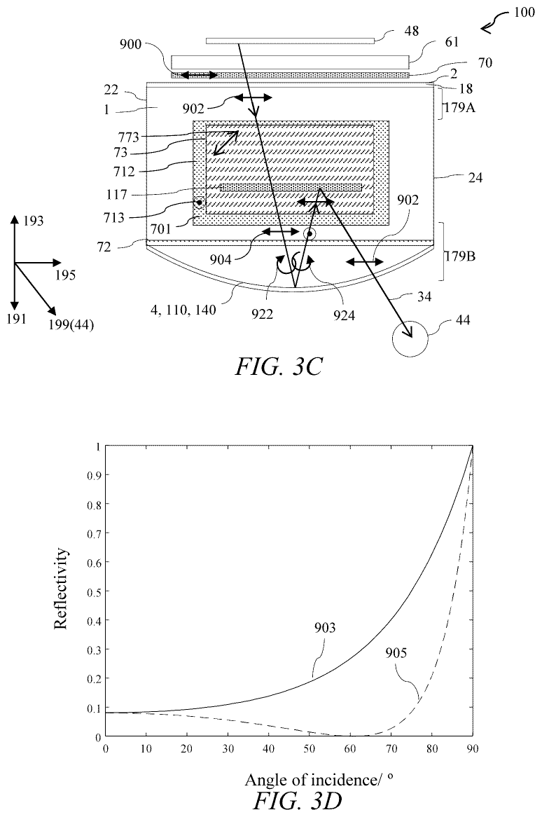

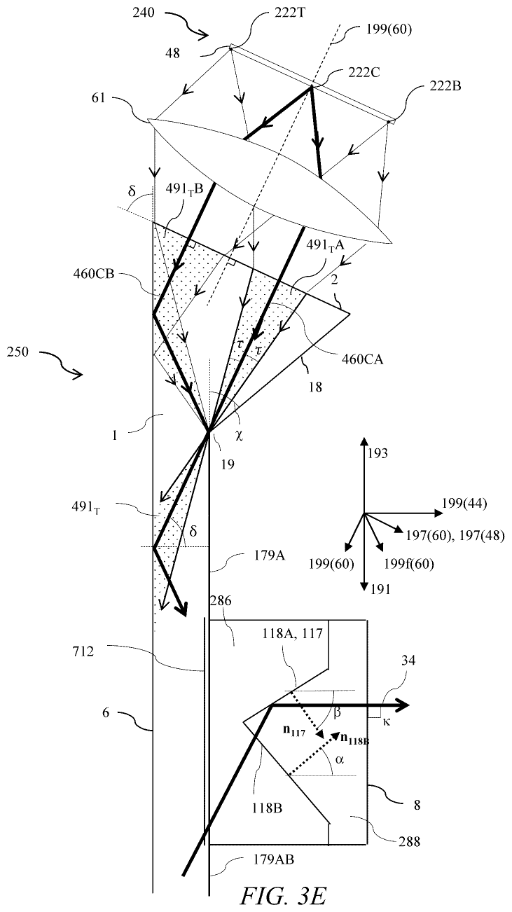

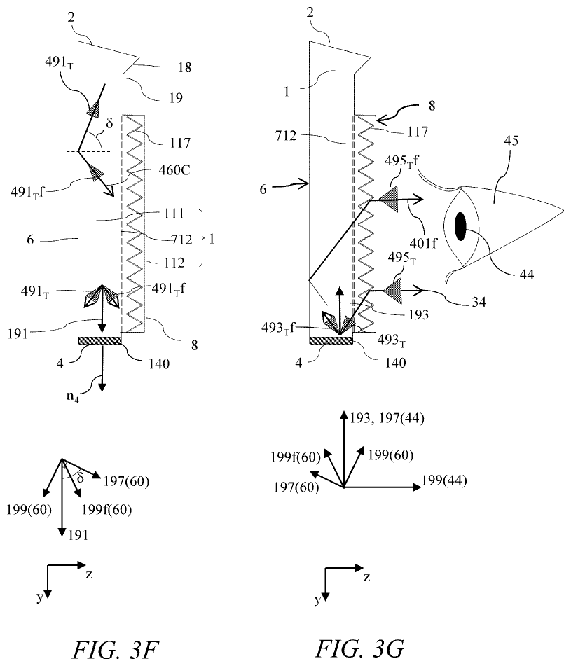

The deflection arrangement 112 comprises a deflection element 116 comprising an array of deflection features 118A that are arranged to deflect light incident thereon forwards of the ANEDD 100 and towards the output direction 199(44) wherein the deflection features 118A are reflectors 117 as will be described further in FIGS. 3A-B hereinbelow. The deflection element 116 is arranged to direct the deflected light towards an eye 45 of the viewer 47 in front of the ANEDD 100.

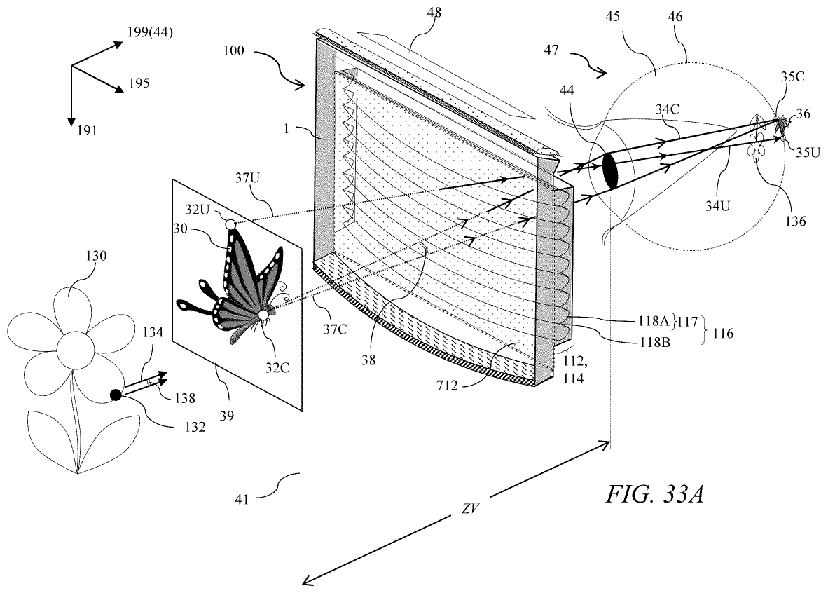

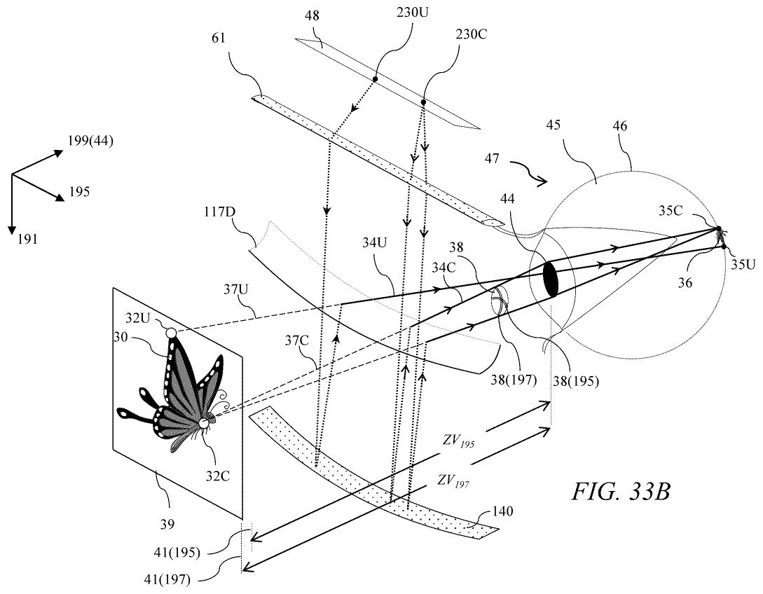

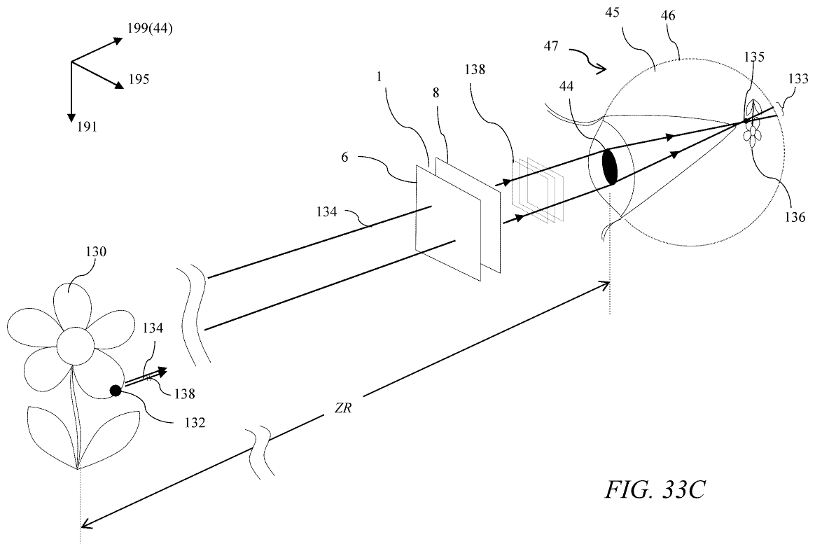

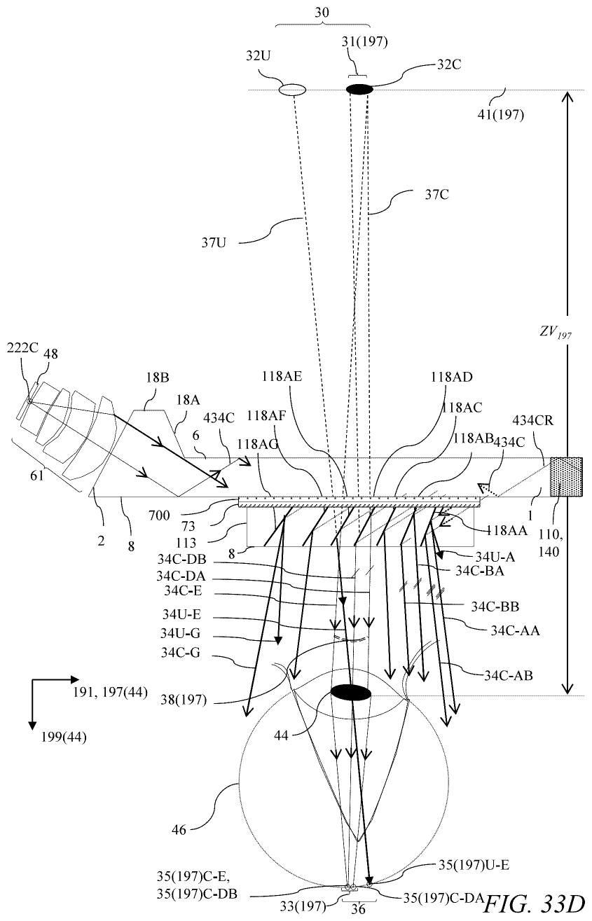

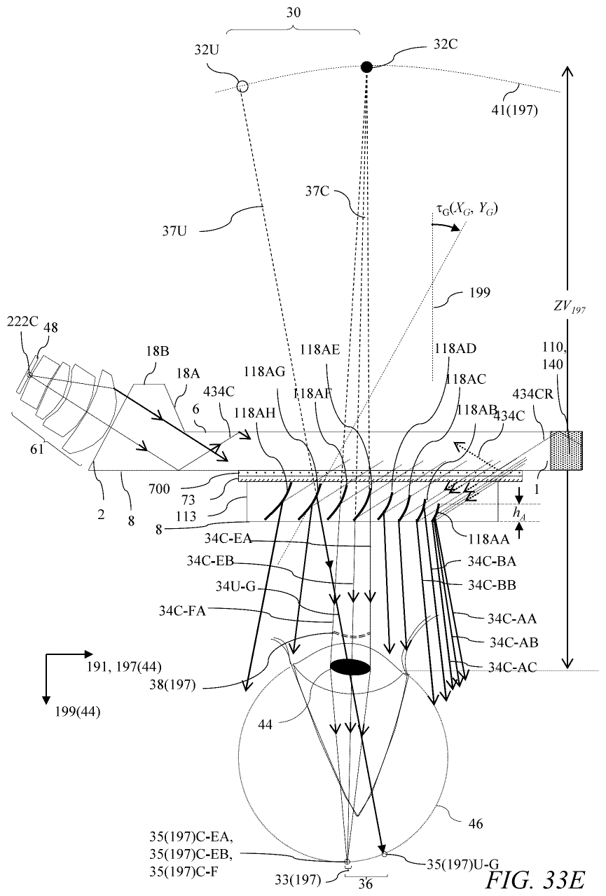

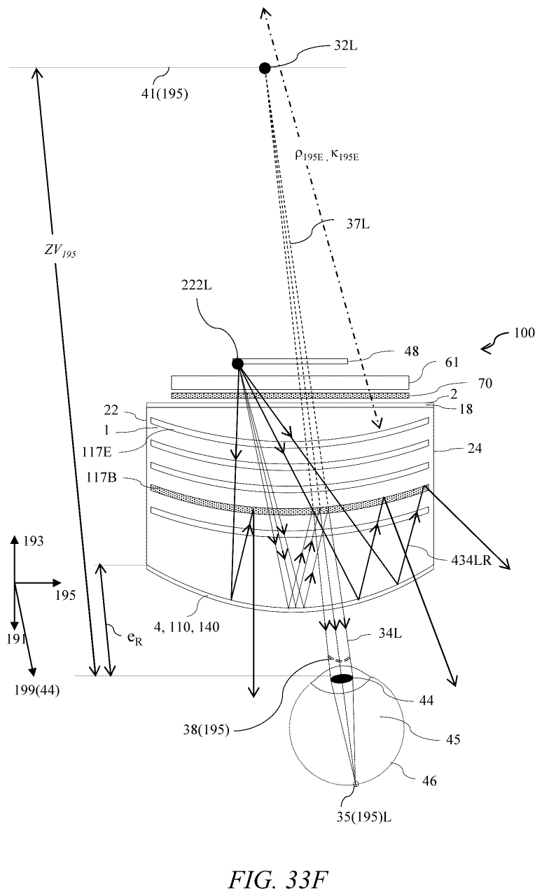

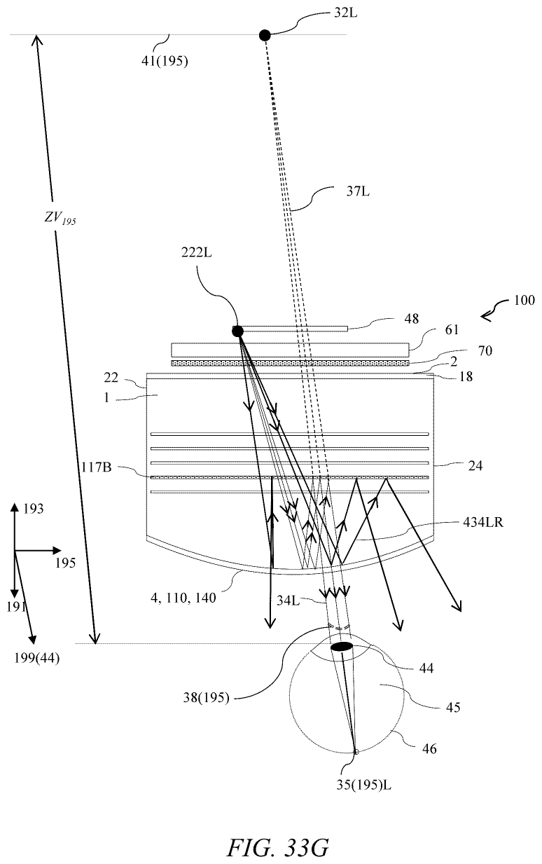

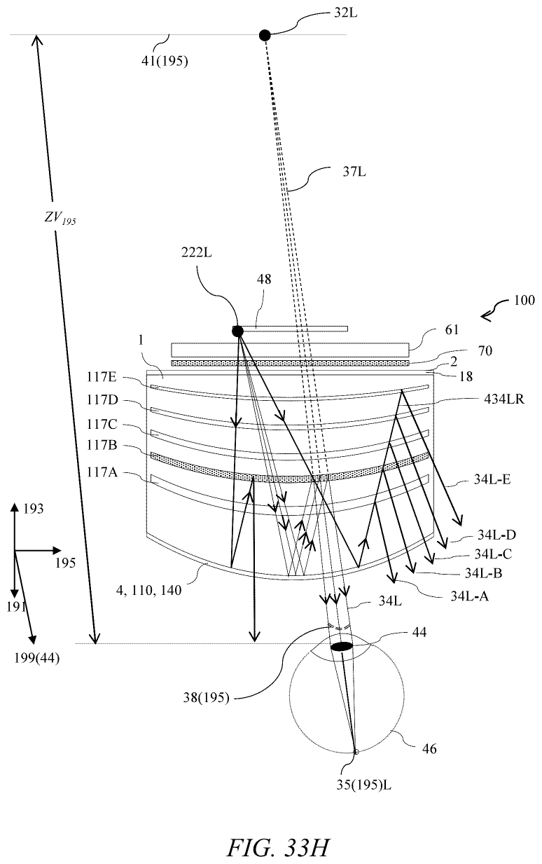

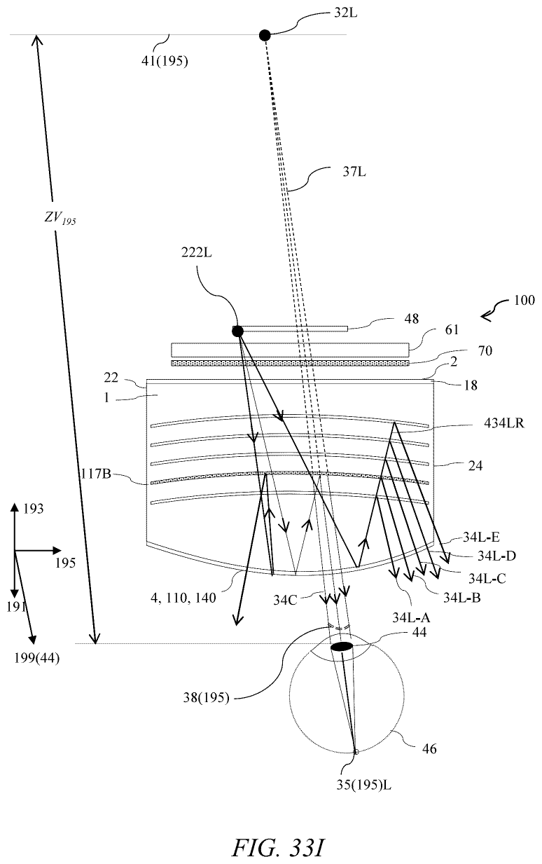

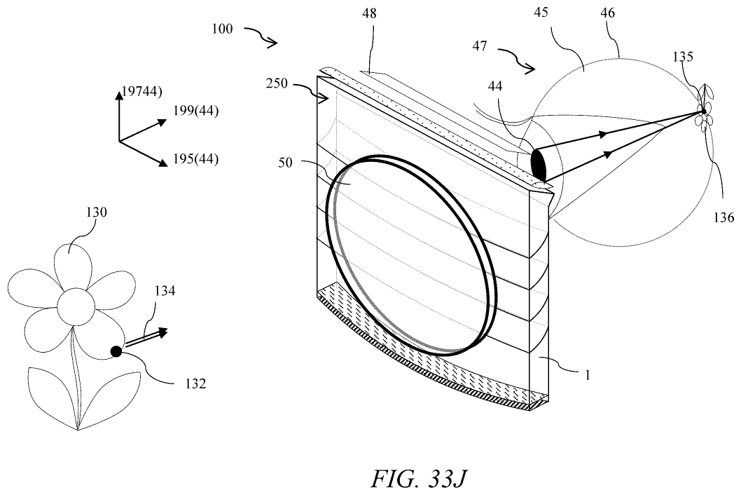

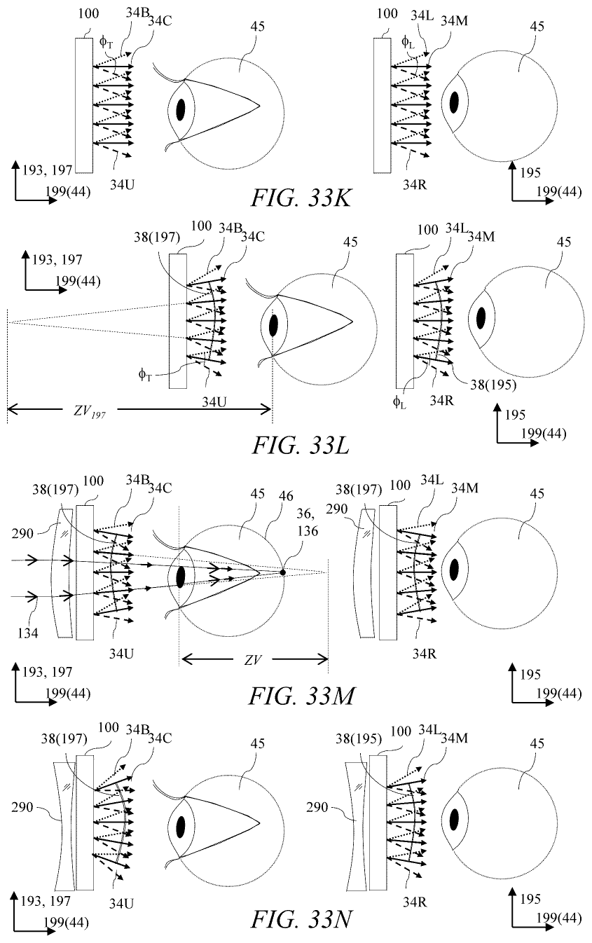

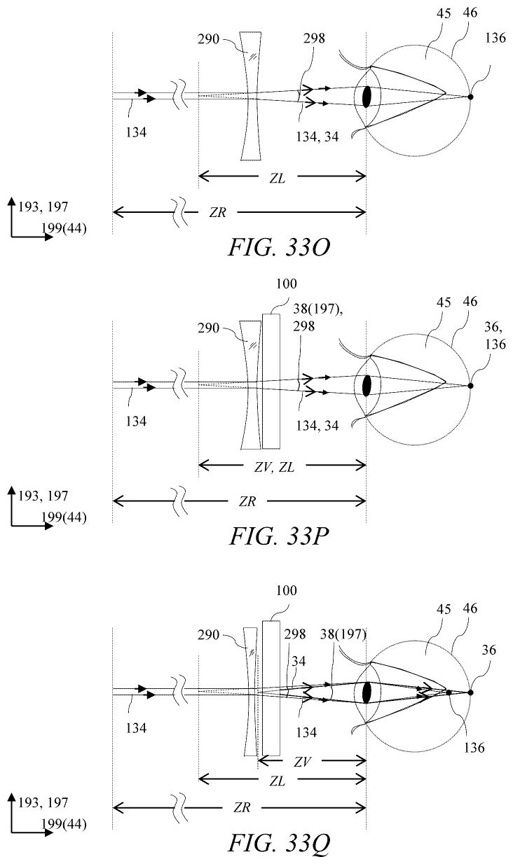

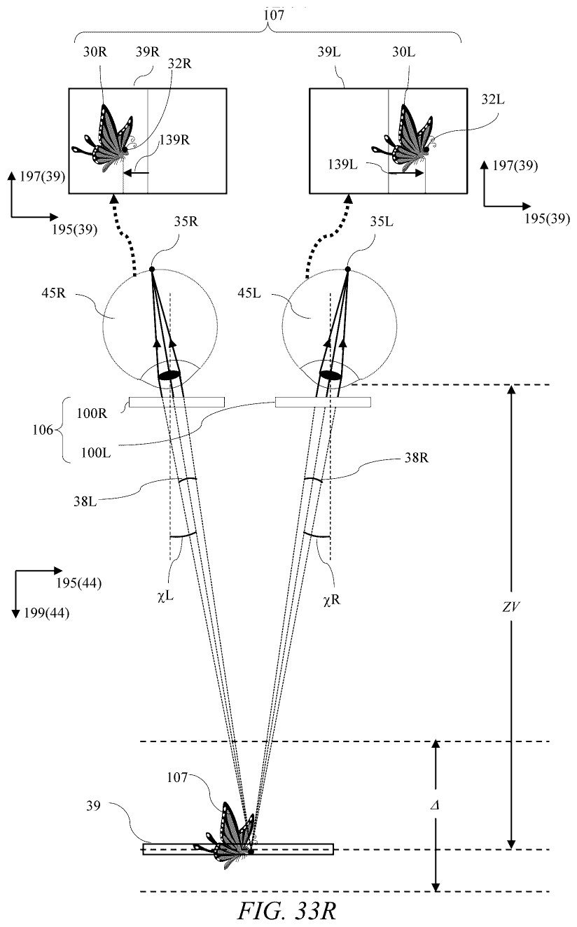

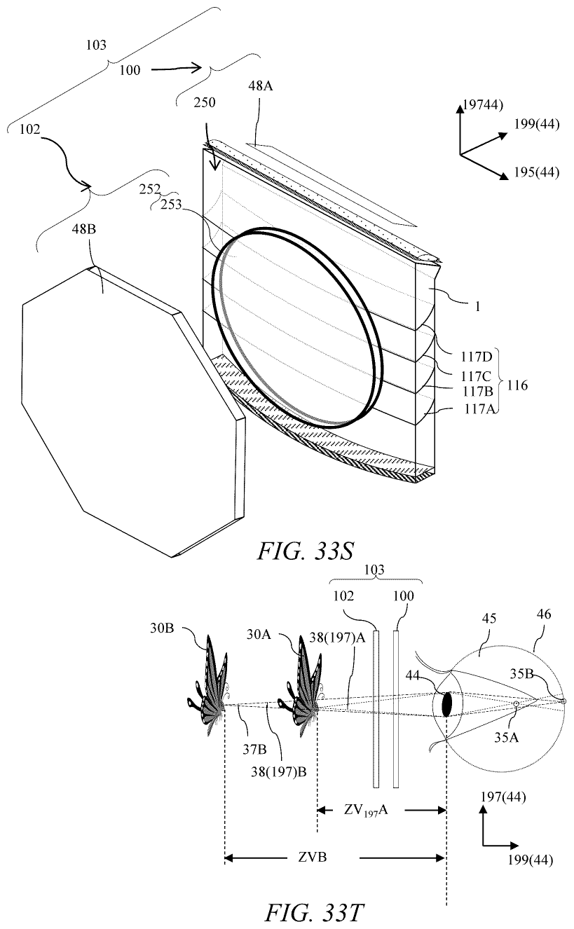

The output direction 199(44) may be a nominal direction 199(44) for light rays 34 from a point 230 on the central pixel 222C of the spatial light modulator 48. More generally, for example as illustrated in FIGS. 33A-T hereinbelow, the output light 34 is output forwards of the ANEDD 100 and for a point on the spatial light modulator 48 may comprise a range of angles across the output side 8 of the ANEDD 100.

The principle of operation of the ANEDD 100 will now be further described. The optical system 250 has an optical axis 199 and has anamorphic properties in a lateral direction 195 and in a transverse direction 197 that are perpendicular to each other and perpendicular to the optical axis 199.

Mathematically expressed, for any location within the ANEDD 100, the optical axis direction 199 may be referred to as the O unit vector, the transverse direction 197 may be referred to as the T unit vector and the lateral direction 195 may be referred to as the L unit vector wherein the optical axis direction 199 is the crossed product of the transverse direction 197 and the lateral direction 195:

$$O = T \times L \qquad eqn . 4$$

Various surfaces of the ANEDD 100 transform or replicate the optical axis direction 199; however, for any given ray, the expression of eqn. 4 may be applied.

FIG. 1B illustrates the variation of optical axis 199 direction, lateral direction 195 and transverse direction 197 as light rays propagate through the optical system 250. In the present description, the lateral and transverse directions 195, 197 are defined relative to the optical axis 199 direction in any part of the illumination system 240 or optical system 250, and are not in constant directions in space. In the embodiment of FIG. 1B, the transverse direction 197(60) illustrates the transverse direction 197 at the transverse anamorphic component 60 formed by the transverse lens 61; the transverse direction 197(110) illustrates the transverse direction 197 at the lateral anamorphic component 110; and the transverse direction 197(44) illustrates the transverse direction 197 at the eye 45 of the viewer 47. The transverse anamorphic component 60 has lateral direction 195(60) that is the same as the lateral direction 195(110) of the lateral anamorphic component 110 and the lateral direction 195(44) at the pupil 44 of the eye 45. The Euclidian coordinate system illustrated by x, y, z directions is invariant, whereas the transverse direction 197, lateral direction 195 and optical axis direction 199 may be transformed at various optical components, in particular by reflection from optical components, of the ANEDD 100.

Further features of the arrangement of FIG. 1A will now be described.

The optical system 250 may comprise an input linear polariser 70 disposed between the SLM 48 and the reflectors 117 and disposed between the SLM 48 and the PSR 700 of the extraction waveguide 1; and is arranged to pass light having the input linear polarisation state 902. In FIG. 1A, the input linear polariser 70 is arranged between the transverse anamorphic component 60 and the extraction waveguide 1. The input linear polariser 70 is an absorbing polariser such as a dichroic iodine polariser arranged to transmit a linear polarisation state and absorb the orthogonal polarisation state. In alternative embodiments the linear polariser 70 may be arranged between the transverse anamorphic component 60 and the SLM 48 or may be the output polariser of the SLM 48.

Further the optical system 250 may comprise a polarisation conversion retarder 72 disposed between the light reversing reflector 140 and the deflection arrangement 112 that may be an A-plate with an optical axis direction arranged to convert linearly polarised light to circularly polarised light and circularly polarised light to linearly polarised light. The operation of the input linear polariser 70 and polarisation conversion retarder 72 will be described further hereinbelow, for example in FIGS. 3A-B and FIGS. 6A-B.

In operation, extraction waveguide 1 is arranged to guide light rays 400 propagating in the first direction 191 between the dichroic stack 712 and the front guide surface 8 as illustrated by the zig-zag paths of guided rays 401, 402.

Waveguide 1 further comprises a reflective end 4 arranged to receive the guided light rays 401, 402 from the input end 2. The lateral anamorphic component 110 comprises the reflective end 4 of the extraction waveguide 1 with a reflective material provided on the reflective end 4. The reflective material may be a reflective film such as ESR™ from 3M or may be an evaporated or sputtered metal material such as aluminium or silver. In the embodiment of FIG. 1A, the lateral anamorphic component 110 is thus a curved mirror with positive optical power in the lateral direction 195 and no optical power in the transverse direction 197.

For light rays 400 propagating in the second direction 193, the extraction waveguide is arranged to provide guiding between the front guide surface 8 and the guide facet 174 or between the front guide surface 8 and the guide portion 178. In the second direction 193, light is transmitted through the dichroic stack 712.

For light cone 493 propagating in the second direction 193, the reflectors 117A-D are oriented to extract light guided back along the extraction waveguide 1 in the second direction 193 through the front guide surface 8 and towards the pupil 44 of eye 45 arranged in eyebox 40.

The operation of the ANEDD 100 as an AR display will now be further described.

The extraction waveguide 1 is transmissive to light such that on-axis real image point 31 on a real-world object 130 is directly viewed through the extraction waveguide 1 by light ray 134. Similarly virtual image 30 with aligned on-axis virtual image point 32C is desirably viewed with virtual ray 37C. Such virtual ray 37C is provided by on-axis light ray 34C after reflection from reflector 117C to the pupil 44 of eye 45. Similarly off-axis virtual ray 37U for viewing of virtual image point 32U is provided by off-axis ray 402 after reflection from the reflector 117D. An AR display with advantageously high transmission of external light rays 134 may be provided.

The imaging properties of the ANEDD 100 will now be further described using an unfolded schematic representation wherein said transformations of coordinates are removed for purposes of explanation.

FIG. 1C is a schematic diagram illustrating the operation of an ANEDD 100 in a transverse plane; FIG. 1D is a schematic diagram illustrating the operation of an ANEDD 100 in a lateral plane orthogonal to the transverse plane; and FIG. 1E is a schematic diagram illustrating a rear perspective view of the mapping of the coordinate system for the ANEDD 100 of FIG. 1A. Features of the embodiment of FIGS. 1C-E not discussed in further detail may be assumed to correspond to the features with equivalent reference numerals as discussed above, including any potential variations in the features.

For illustrative purposes, in FIGS. 1C-D, the variation of optical axis direction 199 as illustrated in FIGS. 1A-B is omitted. FIGS. 1C-D illustrate the principle of operation of the ANEDD 100 of FIG. 1A in unfolded illustrative arrangements to achieve a near-eye image with lateral and transverse fields of view ϕ_{T} and ϕ_{L} that are the same to the viewer 47, that is for illustrative purposes a square image is provided to the retina 46. The pupil 44 is shown as at the common viewing distance e_{R} from the output light guide surface 8 of the optical system 250.

FIG. 1C illustrates the transverse imaging property of the ANEDD 100. Illumination system 240 is provided with top, centre and bottom illuminated pixels 222T, 222C, 222B across the transverse direction 197 with light rays output into the transverse anamorphic component 60 with optical power only in the transverse direction that collimates the output from each pixel 222L, 222C, 222R and directs towards the eye 45. Light rays 460T pass through the pupil 44 of the eye 45 onto the retina 46 of the eye 45 and create an off-axis image point 461T. Light rays 460C pass onto the retina 46 and create centre image point 461C and light rays 460B pass onto the retina 46 and create off-axis image point 461B.

FIG. 1D illustrates the lateral imaging property of the ANEDD 100. Illumination system 240 is provided with right, middle and left illuminated pixels 222L, 222M, 222R across the lateral direction 195 with light rays output into the lateral anamorphic component 110 with optical power only in the lateral direction that collimates the output from each pixel 222L, 222M, 222R and directs towards the pupil 44 of the eye 45. Light rays 460L pass through the pupil 44 of the eye 45 onto the retina 46 of the eye 45 and create an off-axis image point 461L. Light rays 460M pass onto the retina 46 and create image point 461M and light rays 460R pass onto the retina 46 and create an image point 461R.

The viewer perceives a magnified virtual image with the optical system 250 arranged between the virtual image 30 and the eye 45, with the same field of view $ in each of lateral and transverse directions 195, 197.

In the ANEDD 100 of the present embodiments, the distance f_{T} between the first principal plane of the transverse anamorphic component 60 of the optical system 250 is different to the distance f_{L} between the first principal plane of the lateral anamorphic component 110 of the optical system 250. Similarly, for a square output field of view (ϕ_{T} is the same as ϕ_{L}), the separation D_{T} of pixels 222T, 222B in the transverse direction is different to the separation DL of pixels 222R, 222L in the lateral direction 195.

In the present description, the lateral angular magnification M_{L} provided by the lateral anamorphic component 110 of the optical system 250 may be given as

$${M}_{L} = ϕ {p}_{L} / {P}_{L} \qquad eqn . 5$$

and the transverse angular magnification M_{T} provided by the transverse anamorphic component 60 of the optical system 250 may be given as:

$${M}_{T} = ϕ {p}_{T} / {P}_{T} \qquad eqn . 6$$

where ϕp_{L} is the angular size of a virtual image point 32C seen by the eye in the lateral direction 195, P_{L} is the pixel pitch in the lateral direction 195, ϕp_{T} is the angular size of a virtual image point 32C seen by the eye in the transverse direction 197, and P_{T} is the pixel pitch in the transverse direction 197. In the case that the angular virtual pixels 36 are square, then ϕp_{L} and ϕp_{T} are equal and the angular magnification provided by the lateral anamorphic component 110 may be given as:

$${M}_{L} = {M}_{T} * {P}_{T} / {P}_{L} \qquad eqn . 7$$

The angular magnification M_{L}, M_{T} of the lateral and transverse anamorphic optical elements 110, 60 is proportional to the respective optical power K_{L}, K_{T} of said elements 60, 110. The SLM 48 may comprise pixels 222 having pitches P_{L}, P_{T} in the lateral and transverse directions 195, 197 with a ratio P_{L}/P_{T} that is the same as K_{T}/K_{L}, being the inverse of the ratio of optical powers of the lateral and transverse anamorphic optical elements 110, 60.

The output coordinate system is illustrated in FIG. 1E wherein output light from a central pixel 225 is directed along optical axis 199(60) through the transverse anamorphic component 60 and into the extraction waveguide 1, from which it is visible along the optical axis 199(44) at the pupil 44.

The row 221Tc of pixels 222 through the central pixel 225 that is extended in the lateral direction 195 is output as fan 493_{L} of rays, each ray representing the angle at which a virtual image point 32U is provided to the pupil 44 across the lateral direction 195.

The column 221Lc of pixels 222 through the central pixel 225 that is extended in the transverse direction 197 is output as fan 493_{T} of rays, each ray representing the angle at which a virtual image point 32U is provided to the eye 45 across the transverse direction 197.

For a pixel 227 arranged in a quadrant of the SLM 48 an output ray 427 is provided to the pupil 44 that is imaged first by the transverse anamorphic component 60 and then by the lateral anamorphic component 110.

Illustrative imaging properties of the ANEDD 100 of FIG. 1A will now be described.

FIG. 1F is a schematic diagram illustrating a field-of-view plot of the output of the ANEDD 100 of FIG. 1A for polychromatic illumination.

FIG. 1F is a graph of the transverse viewing angle against the lateral viewing angle. The lateral field of view ϕ_{L} is 60 degrees and the transverse field of view ϕ_{T} is 30 degrees.

Points with 0 degrees lateral field of view lie in the transverse light cone 493_{L} while points with 0 degrees transverse field of view lie in the transverse light cone 493_{T}. The relative aberrations at various image points are illustrated by blur ellipses 452.

The width 455 of each blur ellipse 452 indicates the relative blurring of a single pixel 227 when output to the eye 45 and thus represents the relative spot size at the retina 46 of the eye 45 in the lateral direction 195. For illustrative reasons, the heights 454 and widths 455 of the blur ellipse 452 are illustrated as magnified on the scale of the plot of FIG. 1F, and do not represent the actual angular size of the blurring of each angular pixel at the pupil 44.

The width 455 is the same for each colour of output light because the lateral anamorphic component 110 is a mirror and thus its imaging is advantageously achromatic.

The vertical height 454 of each ellipse indicates the relative blurring of a single pixel 227 from the SLM 48 when output as an angular cone to the eye 45 and thus represents the relative spot size at the retina 46 of the eye 45 in the transverse direction 197. The transverse anamorphic component 60 of FIG. 1A is a refractive optical element such as a compound lens and thus exhibits chromatic aberration. Thus the height 454R of the blur region for red pixels 222R is different to the height 454B for blue pixels 222B.

Thus the eye 45 looking at a white point off-axis will see some colour blurring for off-axis virtual pixels when looking up or down, but not side-by-side in the geometry of FIG. 1A.

Illustrative arrangements of pixels 222 of the spatially multiplexed SLM 48 will now be described.

FIGS. 2A-D are schematic diagrams illustrating in front view a SLM 48 for use in the ANEDD 100 of FIG. 1A comprising spatially multiplexed red, green and blue sub-pixels 222R, 222G, 222B arranged on a backplane 228. Features of the embodiments of FIGS. 2A-D not discussed in further detail may be assumed to correspond to the features with equivalent reference numerals as discussed above, including any potential variations in the features.

The SLM 48 may be a transmissive SLM such as an LCD as illustrated in FIG. 1A. Alternatively the SLM 48 may be a reflective SLM such as Liquid Crystal on Silicon (LCOS) or a Microoptoelectromechanical (MOEMS) array of micro-mirrors such as the DMD from Texas Instruments. Alternatively the SLM 48 may be an emissive SLM using material systems such as OLED or inorganic micro-LED. A silicon backplane 228 may be provided to achieve high speed addressing of high resolution arrays of pixels 222. Other backplanes 228 may comprise thin film transistors (TFTs) or other known pixel 222 addressing means.

In FIGS. 2A-D and FIG. 2E hereinbelow, the pixels 222 of the SLM 48 are distributed in the lateral direction 195(48) and also distributed in the transverse direction 197(48) so that the light output from the transverse anamorphic component 60 is directed in the directions that are distributed in the transverse direction 197 and the light output from the lateral anamorphic component 110 is directed in the directions that are distributed in the lateral direction 195 when output towards the pupil 44 of the eye 45.

White pixels 222 comprising red, green and blue sub-pixels 222R, 222G, 222B are provided spatially separated in the lateral direction 195 and the sub-pixels 222R, 222G, 222B are elongate with a pitch P_{L} in the lateral direction that is greater than the pitch P_{T} in the transverse direction 197.

Considering FIGS. 1C-D and the embodiments of FIGS. 2A-D, it may be desirable to provide square white pixels in the final perceived virtual image 30. The pitch P_{L} is magnified by the lateral anamorphic component to an angular size ϕ_{L} (with spatial pitch 6L at the retina 46) and the pitch P_{T} is magnified by the transverse anamorphic component to an angular size ϕ_{T} (with spatial pitch ϕ_{T} at the retina 46). The pitches P_{L}, P_{T} may be determined by said different angular magnifications to advantageously achieve square angular pixels from the ANEDD 100. The widths wR_{L}, wG_{L}, wB_{L} and heights wR_{T}, wG_{T}, wB_{T} of the red, green and blue pixels 222R, 222G, 222B respectively may be different. Differences in luminous efficiency and drive conditions may be compensated to advantageously provide desirable white point of the ANEDD 100 in desirable driving conditions.

The pixels 222 are arranged as columns 221L, wherein the columns 221L are distributed in the lateral direction 195, and the pixels along the columns 221L are distributed in the transverse direction 197; and the pixels 222 are further arranged as rows 221T, wherein the rows 221T are distributed in the transverse direction 197, and the pixels along the rows 221T are distributed in the lateral direction 195.

In FIG. 2A, the sub-pixels 222R, 222G, 222B are distributed in columns of red, green, and blue pixels. Advantageously vertical and horizontal image lines may be provided with high fidelity.

In the alternative embodiment of FIG. 2B, the sub-pixels 222R, 222G, 222B are distributed along diagonal lines. Advantageously reproduction of natural imagery may be improved in comparison to the embodiment of FIG. 2A.

The sub-pixels 222R, 222G, 222B may be provided by white light emission and patterned colour filters, or may be provided by direct emission of respective coloured light. The present embodiments comprise sub-pixel 222 pitch P_{L} that is larger than other known arrangements comprising a symmetric input lens for thin waveguides.

In the alternative embodiment of FIG. 2C, multiple blue pixels 222B1 and 222B2 may be provided. The blue pixels 222B1, 222B2 may be driven with reduced current for a desirable output luminance. Advantageously the lifetime of the pixels may be improved, for example when the SLM 48 is provided by an OLED microdisplay. In other embodiments, additional or alternative white pixels (for example with no colour filters) or a fourth colour such as yellow may be provided. Colour gamut and/or brightness and efficiency may advantageously be achieved.

In the alternative embodiment of FIG. 2D, the footprint of the red sub-pixels 222AR is larger than that of the green and blue sub-pixels. In micro-LED displays, small red-emitting pixels may be provided by AlInGaP material system, compared to InGaN material system for green and blue emitters. Such red emitters have reabsorption losses that increase with shrinking pixel size. Advantageously the red micro-LED emitter size is increased and display efficiency is improved. Similarly for OLED pixels, it may be desirable to provide larger blue pixels than red or green pixels to increase display lifetime.

FIG. 2E is a schematic diagram illustrating in front view a SLM 48 for use in the ANEDD 100 of FIG. 1A with pixels 222 for use with temporally multiplexed spectral illumination. Features of the embodiment of FIG. 2E not discussed in further detail may be assumed to correspond to the features with equivalent reference numerals as discussed above, including any potential variations in the features.

The SLM 48 may be used for monochromatic illumination. In alternative embodiments wide colour gamut imagery may be provided by time sequential illumination, for example by red, green and blue illumination in synchronisation with red, green and blue image data provided on the SLM 48. Advantageously image resolution may be increased.

In comparison to non-anamorphic image projectors in which equal angular magnification is provided between the lateral direction 195 and transverse direction 197, the present embodiments provide pixel pitch P_{L} that is substantially increased in size for a given angular image size and magnification in the transverse direction 197. Such increased size may advantageously achieve increased brightness, increased efficiency and reduced alignment tolerances for the SLM 48 and illumination system 240.

In colour filter type SLMs 48, the size of colour filters may be increased. Advantageously cost and complexity of colour filters may be reduced. The aperture ratio of the pixels 222 may be increased. In direct emission displays the size of the emitting region may be increased. Advantageously cost and complexity of fabricating the pixels may be reduced and brightness increased. In inorganic micro-LED SLMs 48, efficiency loss due to recombination losses at the edges of pixels may be reduced and system efficiency and brightness advantageously increased.

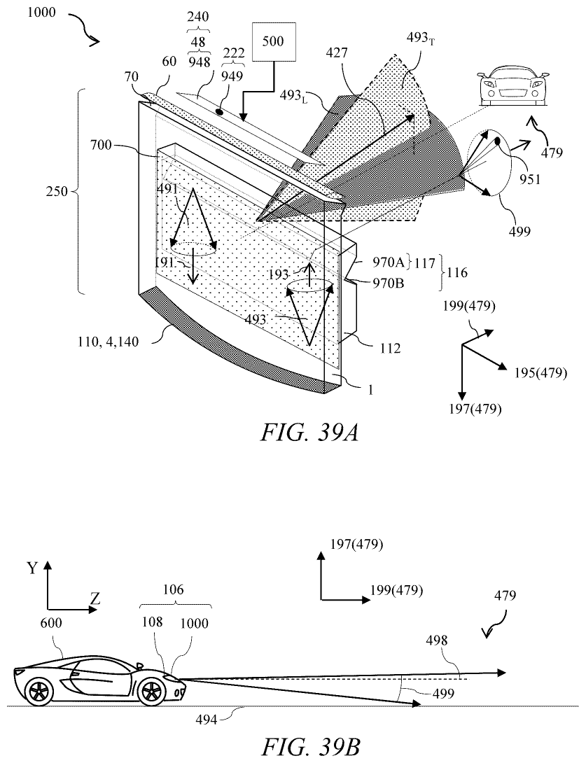

In alternative embodiments, such as the vehicle external light apparatus of FIG. 39B, the pixels 222 may be provided by white light sources such as an array of LEDs to achieve illumination of the road scene 479.

The operation of the anamorphic directional illumination device 1000 of FIGS. 1A-B will now be further described.

FIG. 3A is a schematic diagram illustrating a side view of an alternative an ANEDD 100; FIG. 3B is a schematic diagram illustrating a side view of light extraction and light transmission by the ANEDD 100 of FIG. 3A; FIG. 3C is a schematic diagram illustrating a front view of polarised light propagation in the ANEDD 100 of FIG. 3A; and FIG. 3D is a schematic graph illustrating the variation of reflectivity for polarised light from a dichroic stack 712, 276. Features of the embodiment of FIGS. 3A-D not discussed in further detail may be assumed to correspond to the features with equivalent reference numerals as discussed above, including any potential variations in the features.

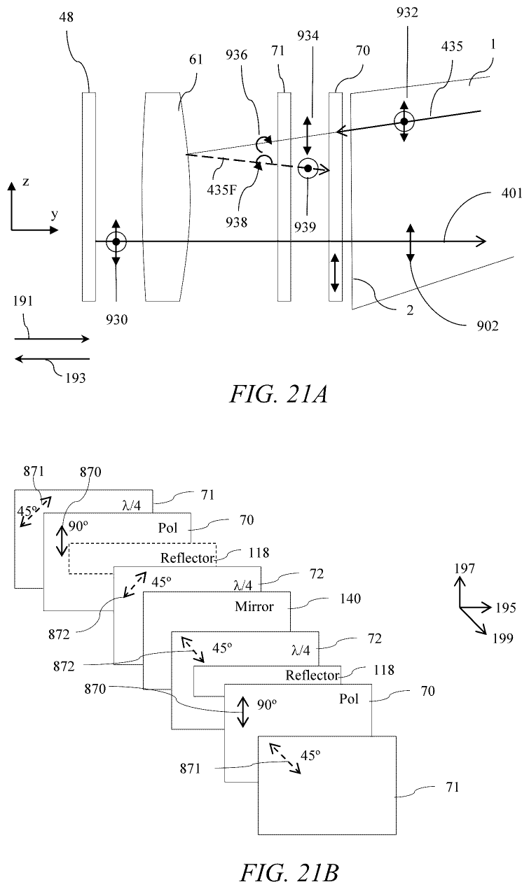

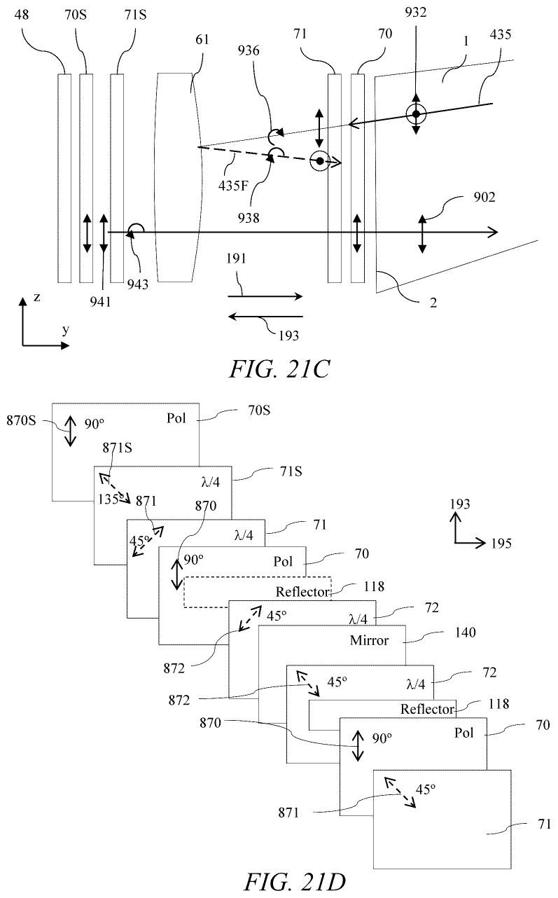

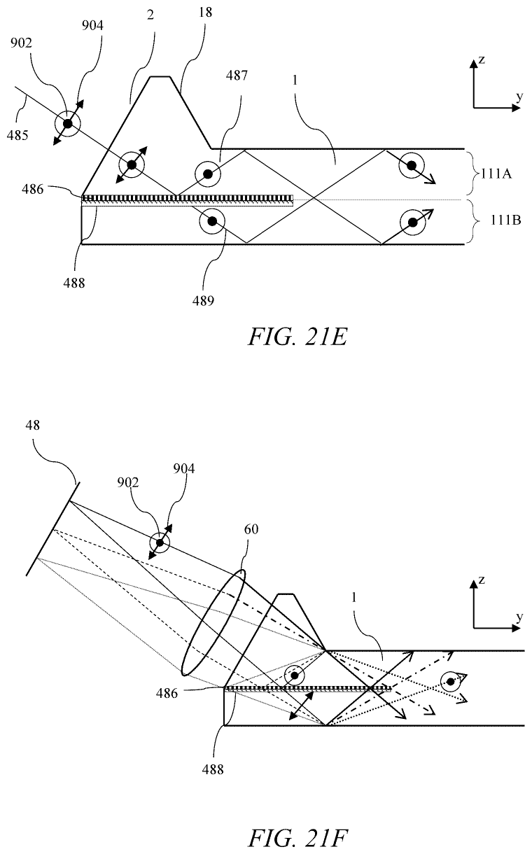

FIG. 3A illustrates a polariser 70 arranged to receive light from the transverse anamorphic component 60, through polarisation conversion retarder 71 as described hereinbelow with respect to FIGS. 21A-B. Polariser 70 has an electric vector transmission direction 771 arranged to output s-polarised light with linear polarisation state 902 into the extraction waveguide 1 through the input end 2.

The light ray 460 propagating in the first direction 191 is guided between the rear guide surface 6 and extraction waveguide 1 region 179A. The light 460 is thus guided along the extraction waveguide 1 in the first direction 191 with an input linear polarisation state 902 before reaching the PSR 700 comprising the dichroic stack 712.

The PSR 700 is arranged to reflect light 460 guided in the first direction 191 having the input linear polarisation state 902 so that the rear guide surface 6 and the PSR 700 are arranged to guide light in the first direction 191.

The polarisation conversion retarder 72 is arranged to convert a polarisation state of light passing therethrough between a linear polarisation state 902 and a circular polarisation state 922, and the polarisation conversion retarder 72 and the light reversing reflector 140 are arranged in combination to rotate the input linear polarisation state 902 of the light guided in the first direction 191 so that the light guided in the second direction 193 and output from the polarisation conversion retarder 72 has an orthogonal linear polarisation state 904 that is orthogonal to the input linear polarisation state 902.

The PSR 700 is arranged to pass light 460 guided in the second direction 193 having the orthogonal linear polarisation state 904 so that the passed light is incident on the deflection element 116. Thus the input linear polarisation state is an s-polarisation state 902 in the extraction waveguide 1, and the orthogonal linear polarisation state is a p-polarisation state 904 in the extraction waveguide. Advantageously high efficiency of transmission for light propagating in the first direction 191 along the extraction waveguide 1, and high efficiency of extraction for light propagating in the second direction 193 may be achieved.

The anamorphic directional illumination device 1000 further comprises an intermediate polarisation conversion retarder 73 arranged between the PSR 700 and the deflection element 116, the intermediate polarisation conversion retarder 73 being arranged to convert a polarisation state of light passing therethrough between the orthogonal linear polarisation state 904 and the input input linear polarisation state 902.

Considering FIGS. 3B-C, light incident in the second direction 193 onto the PSR 700 has a polarisation state 904, and the light is transmitted by the PSR 700 with electric vector transmission direction 713. The intermediate polarisation conversion retarder 73 has an optical axis direction 773 and outputs the s-polarisation state 902 which is incident onto the deflection arrangement 112.

A front waveguide 114 has a front guide surface 8 on the opposite side of the front waveguide 114 from the PSR 700, the deflection features 118A being disposed internally within the front waveguide 114. In the embodiment of FIG. 3B, the deflection arrangement 112 and the front waveguide 114 each comprise the polarisation conversion retarder 73, and the deflection arrangement member 113 comprising the front element 288, the rear element 286 and a dichroic stack 276.

The front waveguide 114 comprises a front element 288 and a rear element 286 having a partially reflective layer 275 disposed therebetween wherein the partially reflective layer 275 comprises a dichroic stack 276.

The partially reflective layer 275 comprises first and second sections of opposite inclination alternating in a direction 193 along the front waveguide 114, the first sections comprising deflection feature 118A that is a reflector 117 and the second sections comprising deflection feature 118B arranged to pass the light passed by the PSR 700 that is incident thereon.

The deflection features 118A and transmission features 118B are elongate in the lateral direction 195, to provide a wide exit pupil 40 size in the lateral direction 195.

The deflection features 118A of the deflection element 116 comprise sections that are separated in a direction 193 along the front waveguide 114 to provide exit pupil 40 expansion in the transverse direction 197, as will be described further hereinbelow with reference to FIGS. 4A-C for example. The reflectors 117 of the deflection features 118A are partially reflective reflectors 117, each comprising a partially reflective layer 275.

The deflection arrangement 112 is arranged to deflect at least part of the light 460C_{R}(193) passed by the PSR 700 that is incident thereon towards an output direction 199(44) forwards of the anamorphic directional illumination device 1000.

The partially reflective layer 275 comprises at least one dielectric layer 274, and preferably a dichroic stack 276 of dielectric layers 274a-m as will be described further hereinbelow. Improved image uniformity may be provided. Alternatively or additionally, the partially reflective layer 275 may comprise a metallic partially reflective layer.

FIG. 3B illustrates a front waveguide 114, deflection arrangement 112 comprising deflection elements 116 comprising deflection features 118A and draft facet 118B wherein the reflector 117 comprises the deflection feature 118A.

The light deflection arrangement 112 may be formed by depositing the dielectric layers 714 of the dichroic stack 276 onto the front or rear elements 288, 286 that may be prismatic films. After deposition of the dichroic stack 276, a planarization layer 288 may be provided for the other of the front or rear elements 288, 286, and further providing the front guide surface 8 or a surface for attachment to the intermediate polarisation control retarder 73.

FIG. 3D illustrates an example of Fresnel reflectivities 903, 905 for s-polarised light polarisation state 902 and p-polarised light polarisation state 904 respectively at a single interface between SiO₂ and TiO₂. At Brewster's angle, the reflectivity of p-polarised light polarisation state 904 is close to zero and so light is transmitted by the dichroic stack 276 and s-polarised light polarisation state 902 is at least partially reflected. By comparison, for on-axis incidence, such as at the dichroic stack 712, light rays are transmitted for both polarisation states 902, 904. In practice, multilayer stacks such as the illustrative multilayer arrangement of TABLE 2 hereinbelow may be provided for the dichroic stacks 712, 276.

Considering FIG. 3B, in operation, light ray 460C(193) with a p-polarised light polarisation state 904 is returned from the light reversing reflector 140 and polarisation conversion retarder 72. The ray 460C(193) is transmitted from the waveguide member 111 through the dichroic stack 712 of the dichroic stack 712 of the PSR 700.

Light ray 460C(193) is converted from linear p-polarisation state 904 to linear s-polarisation state 902 by polarisation conversion retarder 73. Polarisation conversion retarder 73 may comprise a half-wave plate for a design wavelength such as 550 nm and may comprise a Pancharatnam stack of retarders to achieve improved spectral uniformity. The optical axis direction 773 may be arranged to provide rotation of the linear polarisation state 904 to the linear polarisation state 902 at the design wavelength.

Light ray 460C(193) from the polarisation conversion retarder 73 is incident on the draft facet 118B near to normal incidence, is transmitted at the dichroic stack 276 and propagates towards the deflection feature 118A.

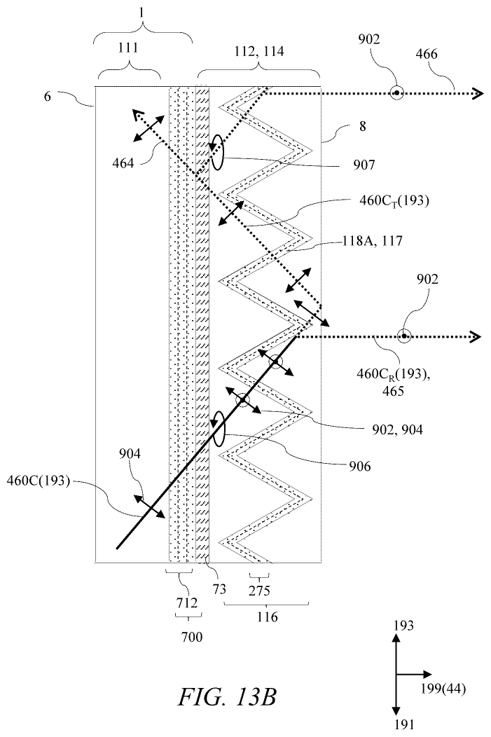

At the deflection feature 118A, the angle of incidence P is near to the Brewster angle, in an illustrative example β is 60 degrees, and at least some of the light with the polarisation state 902 is reflected towards the eye 45 of the user as light ray 463C_{R}(193). As the deflection feature 118A of FIG. 3B comprises a partially reflective layer 275, some of the light may further be transmitted as light ray 463C_{T}(193). The propagation of light ray 463C_{T}(193) will be considered further with respect to FIG. 13A hereinbelow.

Considering light from external objects 130 of FIG. 1A, an external polariser 90 may be provided. External light ray 134 is polarised by external polariser 90 with electric vector transmission direction 91 so that s-polarised polarisation state 902 is incident onto the PSR 700 and is transmitted. The half waveplate 73 provides polarisation rotate to p-polarised polarisation state 904 that is close to the Brewster's angle at the tilted dichroic stacks 275 and so is transmitted to the eye 45 of the user 45 with high efficiency. The deflection features 118A thus are arranged at angles α, that achieve high transmission of external light rays 134 and high reflectance of internal light rays 460C_{R}(193). Advantageously a high brightness augmented image may be overlaid with external scene information that is transmitted with high efficiency.

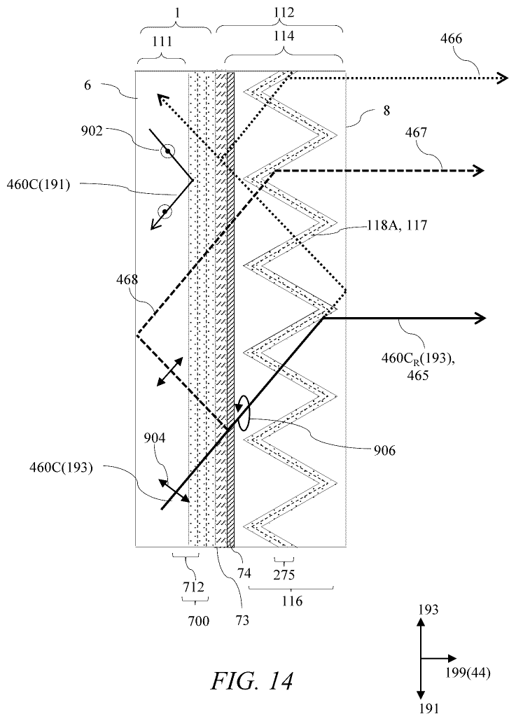

The embodiment of FIGS. 14A-B advantageously achieves high transmission of light ray 460C to the eye 45, while achieving high transmission of light ray 134 from external objects. Further the dichroic stacks 712, 276 may be conveniently provided by dichroic material deposition with low cost. The dichroic stacks 712, 276 may be provided by the same coating stack design to achieve desirable light propagation properties, advantageously providing reduced cost of manufacture.

The size w of the reflector 117 may be arranged to minimise diffractive blur in the image seen by the user. Advantageously improved fidelity of image quality may be achieved.

Considering light ray 134 from an external object 130, external input polariser 308 is arranged to pass polarisation state 902 into the waveguide member 111. The polarisation state 902 is rotated to polarisation state 904 by the intermediate polarisation conversion retarder 73 and is transmitted at least in part by the dielectric stack 276 of the reflector 117 and the draft facet 118B of the deflection element 116 without deflection. Visibility of external objects 130 with high image fidelity may advantageously be achieved. In other embodiments (not shown) it may be desirable that the electric vector transmission direction 91 of the external input polariser is vertical with p-polarisation state 904 transmission, for example for use outdoors. An external polarisation conversion retarder (not shown) that may be a half waveplate may be arranged between the external input polariser 90 and the waveguide member 111 to provide the s-polarisation state 902 at the input to the waveguide member 111. External polariser 90 may further reduce background object luminance in comparison to the luminance of the ANEDD 100. Advantageously image contrast of overlayed virtual images may be increased and double imaging reduced. Further reflections from the reflective linear polariser 702 may be reduced, advantageously increasing the visibility of eye 45, for increased social interaction.

In the present description, partial reflectivity may refer to layers such as dichroic stacks 712, 276 (or reflective polarisers 702 for example) that transmit some light for both polarisation states, or transmit one polarisation state and substantially reflect the orthogonal polarisation state. Typically the s-polarisation state 902 may have higher reflectivity than the p-polarisation state 904 at dichroic stacks.

Light ray 469 illustrates typical reflection properties of PSRs such as dichroic stack 712. Light ray 460C(191) has an s-polarisation state 902 that is reflected with high efficiency from the dichroic stack 712. By comparison light ray 460C(193) with a p-polarisation state 904 provides a reflected ray 469 from the dichroic stack 712. Such light ray is guided by the rear-guide surface 6 back towards the dichroic stack 712 and may be reflected at least in part by a reflector 117 of the deflection feature 118A. Advantageously the partial reflectivity of the ray 460C(193) may provide improved uniformity of the output. The structure of the stacks 712, 476 may be modified to achieve desirable uniformity.

Input and extraction of light into the extraction waveguide 1 of FIG. 1A will now be further described.

FIG. 3E is a schematic diagram illustrating a side view of light input into the extraction waveguide 1; FIG. 3F is a schematic diagram illustrating a side view of light propagation along the first direction 191 in the extraction waveguide 1; and FIG. 3G is a schematic diagram illustrating a side view of light extraction from the extraction waveguide 1. Features of the embodiments of FIGS. 3E-G not discussed in further detail may be assumed to correspond to the features with equivalent reference numerals as discussed above, including any potential variations in the features.

Extraction waveguide 1 comprises waveguide member 111 between the rear guide surface 6 and PSR 700 and deflection arrangement 112 between the PSR 700 and the front guide surface 8.

The input of transverse light cones 491_{T} into the extraction waveguide 1 will now be described with reference to FIG. 3E.

In the illustrative embodiment of FIG. 3E, the input end 2 of the extraction waveguide 1 is inclined, in particular having a surface normal that is inclined at angle δ with respect to the surface normal to the rear and front guide surfaces 6, 179A of the waveguide member 111, that is the input end 2 is inclined at angle δ with respect to the first and second directions 191, 193 along the extraction waveguide 1. The front guide surface 8 may be parallel to the guide surface 179A.

SLM 48 and transverse anamorphic component 60 formed by the transverse lens 61 are inclined at the angle δ with respect to the normal to the rear and front guide surfaces 6, 8. The direction of the optical axis 199(60) through the transverse anamorphic component 60 is thus inclined with respect to the first and second directions 191, 193 along the extraction waveguide 1. The optical axis 199(60) direction is typically parallel to the surface normal of the input end 2, such that the optical axis direction 199(60) is inclined at the angle 90−δ with respect to the first and second direction 191, 193. Referring to FIG. 1F, advantageously improved aberrations may be achieved and the height 454 of the pixel blur ellipse 452 may be reduced in at least the transverse direction 197.

The optical system 250 further comprises a tapered surface 18 that is a surface inclined at angle χ provided near the input end 2 to direct light bundles in the transverse direction 197 from the transverse anamorphic component 60 into the extraction waveguide 1 at desirable angles of propagation. The tapered surface 18 is arranged between the input end 2 and the light guide surface 8, with surface normal direction inclined at an angle χ with respect to the surface normal to the light guide surface 8. In alternative embodiments, the tapered surface 18 may be arranged on the rear guide surface 6.

TABLE 1 shows an illustrative embodiment of the geometry of the arrangement of FIG. 3E for an extraction waveguide 1 refractive index of 1.5.

TABLE 1

| Angle compared to direction 191 along the | Illustrative |
|---|---|
| extraction waveguide 1 | embodiment |
| Input end 2 inclination, δ | 60° |
| Tapered surface 18 inclination, χ | 44° |
| Cone 491_{T} half angle in the material of the | 10° |
| extraction waveguide, τ | |
| Reflector 117 tilt angle, β | 60° |
| Draft facet 118B tilt angle, α | 60° |
| Angle of incidence of central output ray | 90° |
| 460C at output surface 8, κ | |

Central pixel 222C provides illumination to the transverse anamorphic component 60 with illustrative light rays 460CA, 460CB. Light ray 460CA is input through the input end 2 without deflection and is directed to just miss the interface 19 of the tapered surface 18 and the front guide surface 8, and is thus undeflected. Light ray 460CB is however incident on the region of the rear guide surface 6 opposite the tapered surface 18 and is reflected by total internal reflection to the same interface 19, at which it is just totally internally reflected, such that the rays 460CA, 460CB overlap and are guided in the first direction 191 along the extraction waveguide 1.

The reflectors 117 desirably have a surface normal direction n₁₁₇ that is inclined with respect to the direction 191 along the extraction waveguide by an angle α′ (which in FIG. 3E is 90−α) in the range 20 to 40 degrees, preferably in the range 25 to 35 degrees and most preferably in the range 27.5 degrees to 32.5 degrees. Advantageously such an arrangement reduces stray light rays.

In alternative embodiments, the reflectors 117 may have an angle α′ that is in the range 50 to 70 degrees, preferably in the range 55 to 65 degrees and most preferably in the range 57.5 degrees to 62.5 degrees. Such arrangement directs light ray 460C through the light guide surface 8 when the ray has not reflected from the intermediate surfaces 176, 178 after reflection from the front light guide surface 8.

The draft facets 118B may have the equal and opposite tilt a to the tilt 3 of the reflectors 117. Advantageously the amount of light along light rays 31 from an external image 130 that passes through the reflector 117 and draft facet 118B may be equal so that the external image 130 may have improved image quality.

The embodiment of TABLE 1 illustrates a design for refractive index of 1.5. The refractive index of the extraction waveguide 1 may be increased, for example to a refractive index of 1.7 or greater. Advantageously the size of the light cone ϕ_{T} may be increased and a larger angular image seen in the transverse direction.

The outer pixels 222T, 222B in the lateral direction 195(48) define the outer limit of light cones 491_{T}A, 491_{T}B that propagate at angles τ either side of rays 460CA, 460CB. The tapered surface 18 is provided such that the whole of the light cone 491_{T}A is not deflected near to the input end 2, advantageously achieving reduced cross-talk and high efficiency. After the light cones 491_{T}A, 491_{T}B pass the interface 19, then they recombine to propagate along the extraction waveguide 1.

The propagation of transverse light cones 491_{T} along the extraction waveguide 1 in the first direction 191 will now be described with reference to FIG. 3F.

Considering FIG. 3F, the propagation of light rays in cone 491 that are distributed in the transverse direction 197 are illustrated. On-axis light ray 401 from a central pixel 222 of the SLM 48 is directed through the transverse anamorphic component 60 into the extraction waveguide 1.

The direction of the optical axis 199(60) through the transverse anamorphic component 60 is inclined at angle δ that is inclined at angle 90−δ to the first direction 191 along the extraction waveguide 1.

After the interface 19, the light cone 491_{T} is incident on the dichroic stack 712 with an angle of incidence 6 and is reflected such that a replicated light cone 491_{T}f is provided propagating along the extraction waveguide 1 in the direction 191.

FIG. 3G illustrates the propagation of corresponding reflected light cones 493_{T}, 493_{T}f after reflection at the light reversing component 140. In the transverse direction 197, the lateral anamorphic component 110 has no optical power and has a surface normal direction n₄ that is desirably parallel to the first directions 191, 193. The visibility of artefacts arising from stray light including double images and ghost images may be reduced.

The reflected light cones 493_{T}, 493_{T}f propagate along the second direction 193 with angle τ about optical axes 199(60) and 199f(60). Corresponding transverse directions 197(60), 197f(60) are also indicated.

Both cones 493_{T}, 493_{T}f comprise image data that between the cones 493_{T}, 493_{T}f is flipped about the direction 191 and thus provides degeneracy of ray directions for a given pixel 222 on the SLM 48. It is desirable to remove such degeneracy so that only one of the cones 493_{T}, 493_{T}f is extracted and a secondary image is not directed to the pupil 44 of the eye 45.

Output light ray 401 propagates by total internal reflection of opposing surfaces 6, 8 until it is incident on a guide surface 176 at which at least some light is reflected, and then at reflector 117 at which at least some light is further reflected as will be described further hereinbelow such that light cone 493_{T} is preferentially directed towards the front guide surface 8. After refraction at the light guide surface 8, light in the cone 495_{T} is extracted towards the eye 45, with a cone angle that has increased size compared to the cone 493_{T}.

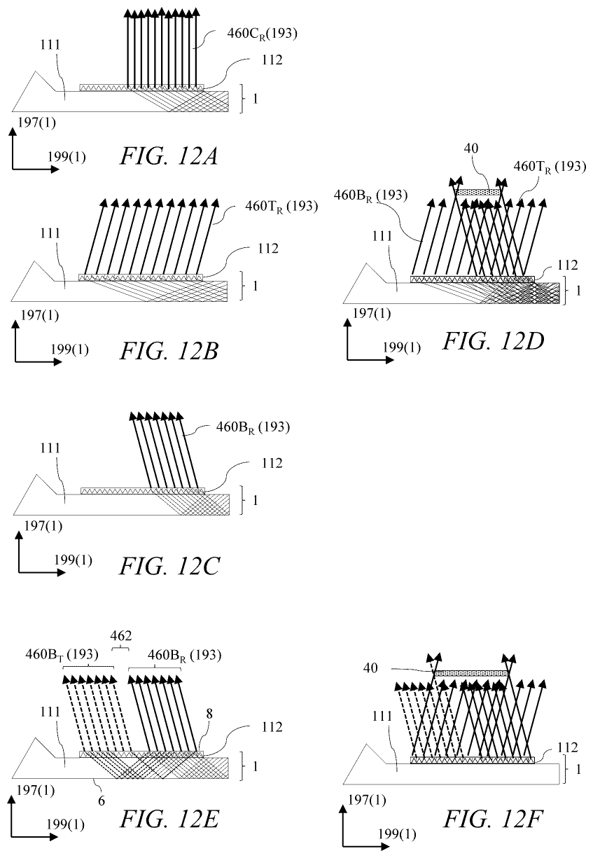

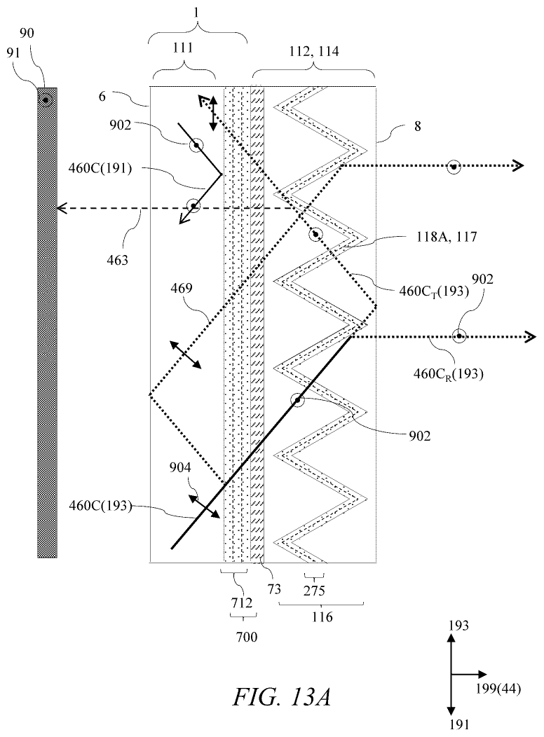

The reflectors 117 are inclined at the same angle, a such that for each of the light reflectors 117 of FIG. 1A, the light cones 493_{T} are parallel and image blur for light ray 401 extracted to the pupil 44 from different reflectors 117 across the extraction waveguide 1 is advantageously reduced. By way of comparison, the light cone 493_{T}f around light ray 461 which is incident on the rear guide surface 6 and then on reflector 117 provides an output location for ray 401f that is different to the light cone 493_{T}. Advantageously exit pupil 40 expansion is achieved as will be described hereinbelow with respect to FIGS. 4A-C and FIGS. 12A-F.

The inclined input end 2 and inclined transverse anamorphic component 60 thus provide cones 493_{T}, 493_{T}f that are not overlapping with one of said cones preferentially extracted towards the eye 45 and the other cone preferentially retained within the extraction waveguide. The tilted input end 2 and tilted transverse anamorphic component 60 thus advantageously achieve a single image visible to the eye 45 and double images are minimised. In some of the illustrative embodiments hereinbelow, the surface normal of the input end 2 is not inclined to the first and second directions 191, 193, however that is to simplify the illustrations hereinbelow rather than a typical arrangement.

In alternative embodiments (not shown), the central output ray 34C may be inclined to the surface normal to the light guide surface 8, for example to adjust the angular location of the centre of the field of view of the extracted light cone 495_{T}.

Pupil expansion in the transverse direction 197 will now be described.

FIG. 4A is a schematic diagram illustrating a side view of light output from the ANEDD 100 for a single reflector 117; FIG. 4B is a schematic diagram illustrating a side view of light output from the ANEDD 100 for multiple reflectors 117A-M to achieve a full ray cone input in the transverse direction 197(44) into the pupil 44 of the eye 45 of the viewer 47; and FIG. 4C is a schematic diagram illustrating a side view of light output from the ANEDD 100 for multiple reflectors 117A-N for a moving viewer 47 in the transverse direction 197(44). Features of the embodiments of FIGS. 4A-C not discussed in further detail may be assumed to correspond to the features with equivalent reference numerals as discussed above, including any potential variations in the features.

The array of reflectors 117 are distributed along the extraction waveguide 1 to provide exit pupil 40 expansion, that is increasing the size e_{T} of the eyebox 40 in the transverse direction 197 as will now be described.

Considering FIG. 4A, a single reflector 117 is arranged to output light cone 495_{T} towards the pupil 44. However, the limited size of the pupil 44 determines that only those light rays within the partial light cone 496_{T} are received by the eye 45 and the field of view of the image observed on the retina in the transverse direction 197(44) is smaller than that input into the extraction waveguide 1. It would be desirable to increase the field of view of observation.

Considering FIG. 4B, multiple reflectors 117A-M are provided sufficient to provide light rays 401C, 401T, 401B from the full cone 495_{T}. The pupil 44 has a height greater than the pitch of the reflectors 117. For example the pitch of the reflectors 117 may be 1 mm and the nominal diameter of the pupil 44 may be 3 mm to 6 mm. The pupil receives light from multiple reflectors 117A-M, and the field of view ϕ_{T} observed is the same as that input into the extraction waveguide 1 at the input end. The exit pupil 40 has a size e_{T} that is the same as the pupil 44 height in this limiting case.

Considering FIG. 4C, further reflectors 117A-N are provided sufficient to provide movement of the pupil 44 between pupil 44A location and pupil 44B location. In this manner e_{T} is increased and exit pupil expansion in the transverse direction is achieved. A transverse field of view ϕT is provided over an extended pupil 44 location advantageously achieving increased comfort of use and full image visibility.

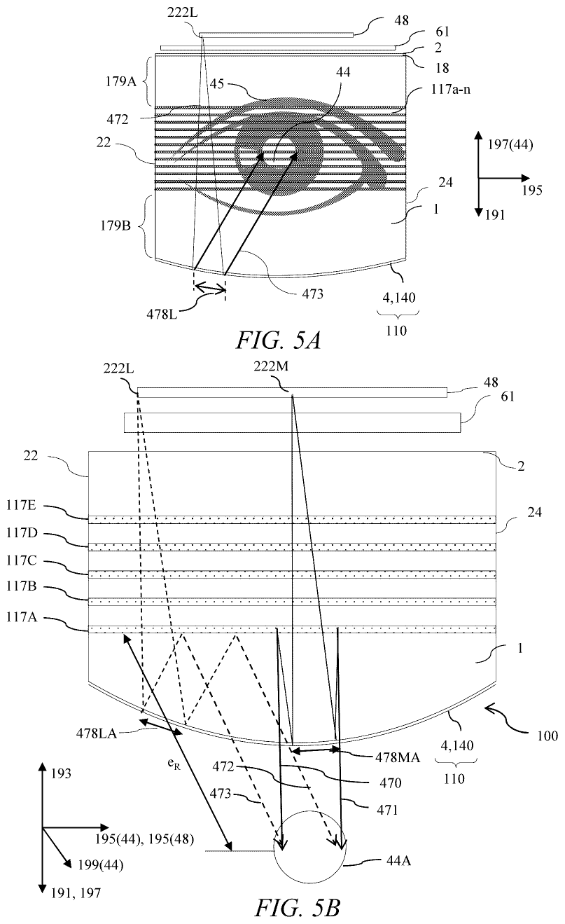

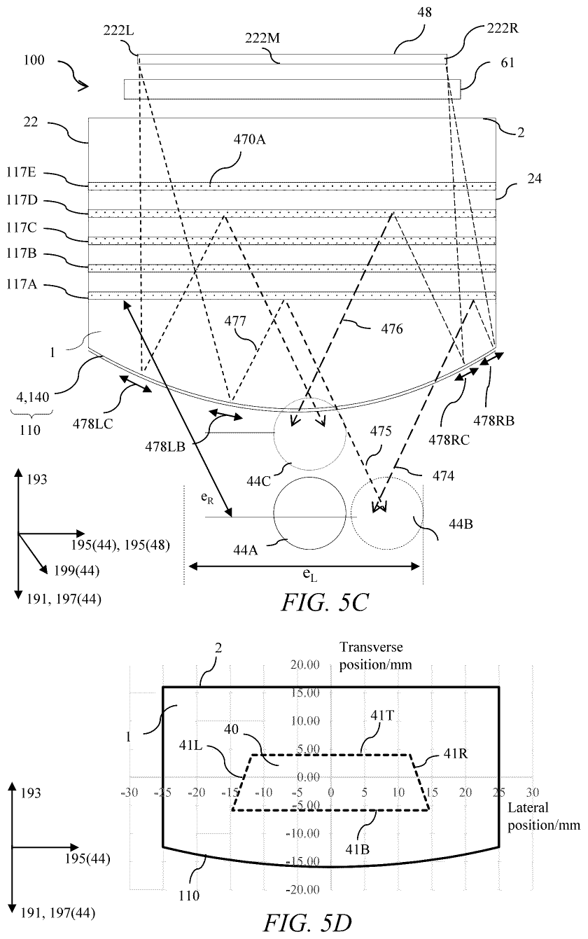

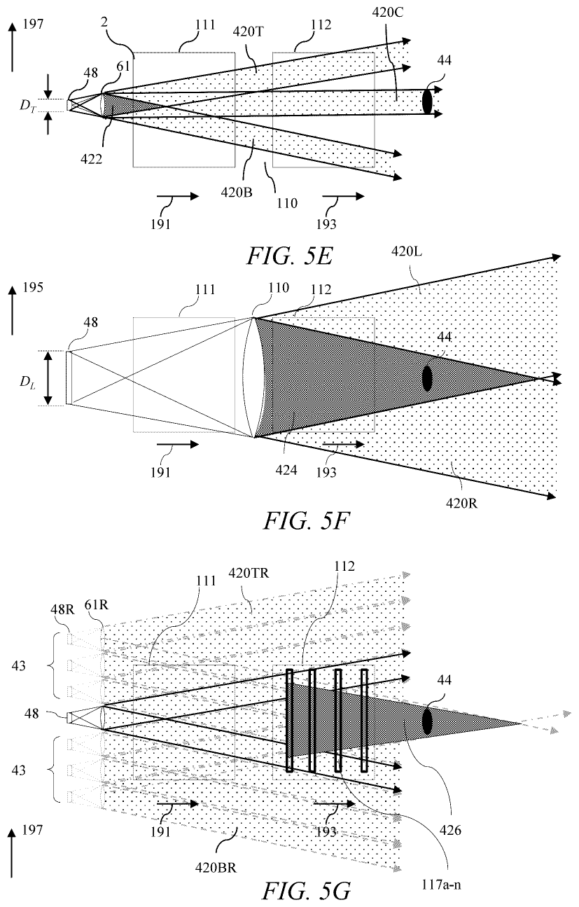

As will be described in FIGS. 5A-E hereinbelow, the lateral anamorphic component 110 further provides exit pupil 40 expansion in the lateral direction 195, that is increasing the size e_{L} of the eyebox 40 in the lateral direction 195.

The imaging properties of the ANEDD 100 in the lateral direction 195 will now be considered further.

FIGS. 5A-C are schematic diagrams illustrating rear views of light output from the ANEDD of FIG. 1A. Features of the embodiments of FIGS. 5A-C not discussed in further detail may be assumed to correspond to the features with equivalent reference numerals as discussed above, including any potential variations in the features.

FIG. 5A illustrates that a non-extracting light guiding region 179A is arranged between the tapered surface 18 and the first reflector 117 of the array of reflectors 117A-N; and a non-extracting light guiding region 179B is arranged between the array of reflectors 117A-N and the lateral anamorphic component 110. Non-extracting guiding sections 179A, 179B may provide increased height of the extraction waveguide 1 in the first direction 191 without reflectors 117. Efficiency of extraction is advantageously improved, and aberrational performance of the lateral anamorphic component 110 is further improved.

In the embodiment of FIG. 5A, the eye 45 is aligned in plan view and out-of-plane rays are not shown, however such a description provides an insight into the operation of the ANEDD 100 in the lateral direction 195. More than one reflector 117 overlays the pupil 44 of the eye 45. For example, the pitch of the reflector 117 is 1 mm and three to six reflectors 117 are provided across the pupil 44 of the eye 45 depending on the dilation of the pupil 44 of the eye 45. Advantageously luminance variation with eye position 45 may be reduced.

The pupil 44 receives the off-axis rays from pixel 222L at the edge of the SLM 48 after reflection from a region 478L of the lateral anamorphic component 110, which is the reflective end 4 of the extraction waveguide 1. While the lateral anamorphic component 110 in its entirety is a relatively fast optical element and thus prone to aberrations, particularly from its edges, the region 478 of the lateral anamorphic component 110 that is directing light into the pupil 44 for any one eye 45 location is small, and thus aberrations from the lateral anamorphic component 110 are correspondingly reduced. Considering FIG. 1F, desirably small width 455 of the blur ellipse 452 may be achieved.

In the embodiment of FIG. 5B, the eye 45 is aligned with out-of-plane rays to illustrate exit pupil 40 expansion in the lateral direction 195.

Light rays 470, 471 are directed from a central pixel 222M across the lateral direction 195 of the SLM 48 and transmitted through the transverse anamorphic component 60 formed by the transverse lens 61 without optical power in the lateral direction 195 and into the extraction waveguide 1. Said light rays 470, 471 propagate in the first direction 191 of the extraction waveguide 1 to the light reversing reflector 140 which provides positive optical power in the lateral direction 195 by means of the reflective end 4 which provides the lateral anamorphic component 110.

Such light rays 470, 471 are reflected in the extraction waveguide 1 in the second direction 193 from the region 478MA of the lateral anamorphic component 110 and at the reflector 117A is reflected away from the plane of the extraction waveguide 1 to the pupil 44 of the eye 45A at the viewing distance e_{R}. The eye 45 collects the rays 470, 471 and directs them to the same point on the retina 46 to provide a virtual pixel location as described elsewhere herein.

Similarly for off-axis pixel 222L offset in the lateral direction 195(48), at the edge of the SLM 48 provides rays 472, 473 that are directed into the extraction waveguide 1, reflected at region 478LA of the lateral anamorphic component 110 and reflected by reflector 117A to the eye 45A to provide an off-axis image point in the lateral direction 195(44) on the retina 46.

The lateral anamorphic component 110 has a positive optical power that provides collimated optical rays from each image point 222L, 222M in the lateral direction 195. In this manner the lateral distribution of field points are provided across the retina 46 by means of the optical power of the lateral anamorphic component 110, while the transverse anamorphic component 60 has optical power to provide the transverse distribution of field points across the retina 46. At diagonal field angles, such as illustrated in FIG. 1E with regards to the imaging of pixel 227, the field points are provided by a combination of the lateral and transverse optical powers of the lateral anamorphic component 110 and transverse anamorphic component 60 respectively.

FIG. 5C illustrates exit pupil 40 expansion in the lateral direction 195 and in the transverse direction 197. Rays 474, 475 for pixels 222R, 222L are directed to pupil 44B by reflection from regions 478RB, 478LB respectively of the lateral anamorphic component 110. Pupil 44B is offset from the pupil 44A in the lateral direction 195, wherein the rays 474, 475 are reflected at least by the reflector 117A. The width e_{L} of the exit pupil 40 is thus increased by the relatively large width of the lateral anamorphic component 110 allowing the regions 478 to be arranged over a desirable width. The viewing freedom of the eye 45 in the exit pupil 40 is increased, advantageously increasing viewing comfort for the eye 45 while achieving full field of view in the lateral direction.

FIG. 5C further illustrates the pupil expansion in the transverse direction 197. Light that is reflected from reflectors 117D is directed to pupil 44C that has a different height to the pupil 44A, as discussed hereinbefore with respect to FIG. 4C.

FIG. 5D is a schematic diagram illustrating a front view of an extraction waveguide 1 and aligned exit pupil 40. Features of FIG. 5D not discussed in further detail may be assumed to correspond to the features with equivalent reference numerals as discussed above, including any potential variations in the features.

The illustrative embodiment of FIG. 5D illustrates the location of the exit pupil 40 with edge loci 41L, 41R which are provided by the exit pupil 40 expansion in the lateral direction 195 as illustrated in FIG. 5B; and with edge loci 41T, 41B that are provided by the exit pupil 40 expansion in the transverse direction 197 as illustrated in FIG. 4B.

The size of the exit pupil 40 is further determined at least in part by the desired field of view ϕ_{L}, ϕ_{T} and the eye relief e_{R}.

Exit pupil 40 expansion will now be further described using illustrative unfolded geometries.

FIG. 5E is a schematic diagram illustrating a side view of an unfolded imaging system arranged to image in the transverse direction 197 wherein reflective deflection features (e.g. reflectors 117) are provided; FIG. 5F is a schematic diagram illustrating a top view of an unfolded imaging system arranged to image in the lateral direction; and FIG. 5G is a schematic diagram illustrating a side view of an unfolded imaging system arranged to image in the transverse direction wherein an array of reflectors 117 is provided, although the description is similarly applicable to other reflective deflection features. Features of FIGS. 5E-G not discussed in further detail may be assumed to correspond to the features with equivalent reference numerals as discussed above, including any potential variations in the features.

FIGS. 5E-G are unfolded representations of the ANEDD 100 of FIG. 1A and are provided for illustrative purposes only.

Considering FIG. 5E, light from SLM 40 illuminates transverse anamorphic component 60 and inputs light rays into unfolded waveguide member 111 in direction 191. Light passes through the lateral anamorphic component 110 without modification and into unfolded deflection arrangement 112 in direction 193. Ray bundles 420T, 420C, 420B are provided across the transverse direction for pixels 222T, 222C, 222B respectively on the SLM 48. The pupil 44 of the eye 45 only observes the full ray cone if located in the cone 422 which is close to the lens and thus not accessible to the eye 45. This is analogous to the illustrative embodiment of FIG. 4A.

Considering FIG. 5F, light from SLM 40 illuminates lateral anamorphic component 110 and inputs light rays into unfolded waveguide member 111 in direction 191. The light cone in the lateral direction from the pixels 222L, 222M, 222R is collimated by the lateral anamorphic component 110 and passes into the unfolded deflection arrangement 112 in direction 193. Ray bundles 420L, 420M, 420R are provided across the transverse direction. The pupil 44 of the eye 45 observes the full ray cone if located in the cone 424 which is accessible to the eye outside the unfolded deflection arrangement 112 because of the much larger width of the lateral anamorphic component 110 compared to the transverse anamorphic component 60. This is analogous to the illustrative embodiment of FIG. 5B.

The effect of the reflectors 117 on pupil expansion in the transverse direction 197 will now be further illustrated.

In comparison to FIG. 5E, FIG. 5G illustrates the deflection arrangement 112 being distributed along the extraction waveguide 1 to provide exit pupil 40 expansion. Each of the deflection features 118Aa-n effectively provides replicated images 48R, 60R of the SLM 48 and transverse anamorphic component 60 respectively. Such replicated images 48R, 60R further provide replicated light cones 420 of FIG. 5E, expanding the effective width of the final light cones 420TR, 420BR. Such replication provides replicated cone 426, from within which the pupil 44 receives light for the full field angles.

The cones 422, 424, 426 represent schematically the exit pupil 40 of the ANEDD in the lateral direction 195 or transverse direction 197. Thus in comparison to the exit pupil 40 represented by cone 422 that by way of comparison would be provided for a conventional micro-projector without pupil expansion, exit pupil 40 expansion is achieved by the lateral anamorphic component 110 and by the array of deflection features 118Aa-n that if FIG. 1A comprise reflectors 117A-N.

Alternative arrangements of PSR 700 will now be described.

FIG. 6A is a schematic diagram illustrating a side view of polarised light propagation in the ANEDD 100 of FIG. 1A; FIG. 6B is a schematic diagram illustrating a rear view of polarised light propagation in the ANEDD 100 of FIG. 1A. Features of the embodiments of FIGS. 6A-B not discussed in further detail may be assumed to correspond to the features with equivalent reference numerals as discussed above, including any potential variations in the features.

By way of comparison with FIGS. 3A-C, the alternative embodiments of FIGS. 6A-F comprise a PSR 700 that is a reflective linear polariser 702.

In the alternative embodiment of FIGS. 6A-B the reflective linear polariser 702 is arranged to reflect light guided in the first direction 191 having the input linear polarisation state 902 so that the PSR 700 is arranged to guide light in the first direction 191. The reflection of guided light from the front light guide surface 8 is provided by total internal reflection, while the reflection of guided light from the reflective linear polariser 702 is by means of metallic reflection in the case of a wire grid type reflective polariser such as from Moxtek or by means of stack of Fresnel reflections in the case of a dielectric stack type reflective polariser such as APF from 3M Corporation.

The polarisation conversion retarder 72 is disposed between the light reversing reflector 140 and the deflection arrangement 112 and is further disposed between the light reversing reflector 140 and the reflective linear polariser 702. The polarisation conversion retarder 72 has a retardance of a quarter wavelength at a wavelength of visible light, for example 550 nm or may be tuned for another visible wavelength for example to match the peak luminance of a monochrome display. The retardance of the polarisation conversion retarder 72 may be different to a quarter wavelength, but selected to provide the same effect. For example, the polarisation conversion retarder 72 may have a retardance of three quarter wavelengths or five quarter wavelengths, for example. Retarder 72 may comprise a stack of composite retarders arranged to achieve the operation of a quarter-wave retarder over an increased spectral band, for example comprising a Pancharatnam stack (which is different to the Pancharatnam-Berry Lens described hereinbelow). Advantageously colour uniformity may be increased. The polarisation conversion retarder 72 may be provided with additional retarder layers to increase the field of view of the quarter-wave retarder function, to advantageously achieve increased uniformity across the field of view of observation. The polarisation conversion retarder 72 most generally serves to provide the polarisation modification to provide conversion from polarisation state 902 to polarisation state 904 for light ray 401.

In the alternative embodiment of FIGS. 6A-B, the polarisation conversion retarder 72 is provided within the extraction waveguide 1 and across the input aperture of the lateral anamorphic component 110. Such an arrangement may be suitable for an extraction waveguide 1 wherein the light reversing reflector 140 is assembled as a separate component to the extraction region of the extraction waveguide 1 comprising reflectors 117. In such an arrangement, the reflector surface of the light reversing reflector 140 is not arranged on the polarisation conversion retarder 72. The surface quality of the light reversing reflector 140 may be increased. Modulation transfer function contrast may advantageously be increased and sharper images achieved. For illustrative purposes, in FIG. 6B, the reflectors 117 are shown and draft facets 174 and guide facets 176, and guide portions 178 omitted.

Considering FIGS. 6A-B, for the exemplary light ray 401, the polarisation conversion retarder 72 is arranged to convert the polarisation state 902 of light passing therethrough between the linear polarisation state 902 and a circular polarisation state 922 and between a circular polarisation state 924 and a linear polarisation state 904 after reflection at the light reversing reflector 140 of the lateral anamorphic component 110. The polarisation conversion retarder 72 and the light reversing reflector 140 are arranged in combination to rotate the input linear polarisation state 902 of the light guided in the first direction 191 so that the light guided in the second direction 193 and output from the polarisation conversion retarder 72 has an orthogonal linear polarisation state 904 that is orthogonal to the input linear polarisation state 902.

FIG. 6C is a schematic diagram illustrating a side view of polarised light propagation in an ANEDD 100 wherein the polarisation state 902 propagating along the first direction 191 is orthogonal to the arrangement of FIG. 6A; and FIG. 6D is a schematic diagram illustrating a rear view of polarised light propagation in the ANEDD 100 of FIG. 6C. Features of the embodiments of FIGS. 6C-D not discussed in further detail may be assumed to correspond to the features with equivalent reference numerals as discussed above, including any potential variations in the features.

In the alternative embodiment of FIGS. 6C-D, the input linear polariser 70 is disposed within the extraction waveguide 1. In comparison to the embodiment of FIGS. 6A-B, depolarization that may take place from scatter with the region 179A of the extraction waveguide 1 may be reduced, advantageously improving contrast. Further, the polarisation conversion retarder 72 is arranged on the end 4 of the extraction waveguide 1. Advantageously complexity of construction may be reduced.

Further the input linear polarisation state 902 is a p-polarisation state in the extraction waveguide 1 in comparison to the s-polarisation state of FIGS. 6A-B and the linear polarisation state 904 is an s-polarised state in comparison to the p-polarisation state of FIGS. 6A-B.

In comparison to the embodiments of FIGS. 3A-C and FIGS. 6A-B, in the alternative embodiment of FIG. 6C, the intermediate polarisation conversion retarder 73 may be omitted. Advantageously cost and complexity is reduced.

The transmission and reflectivity characteristics of the reflective linear polariser 702 may be different for incident s-polarised and p-polarised light. In the illustrative example of FIGS. 6C-D, for light propagating in the second direction 193, some of the s-polarised light of polarisation state 904 may be reflected by the reflective linear polariser 702 rather than transmitted, and may guide between the reflective linear polariser 702 and the front guide surface 8, advantageously achieving increased uniformity of extraction in comparison to the embodiment of FIGS. 6A-B.

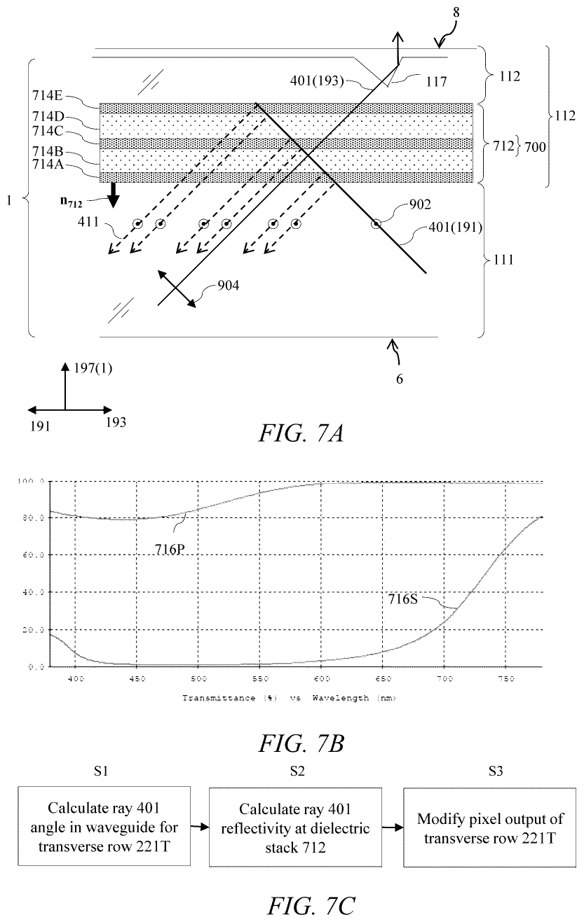

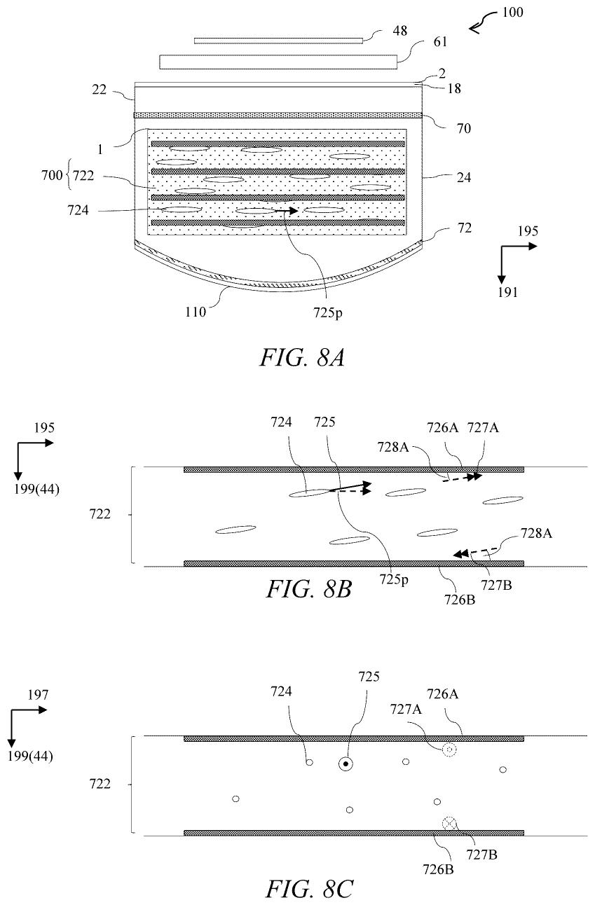

Alternative embodiments of the PSR 700 will now be described. In the following examples, specific examples of the PSR 700 are shown (for example being reflective linear polariser 702 in FIG. 1A, dielectric stack 712 in FIG. 7A and nematic liquid crystal layer 722 in FIG. 8A and so on), but this is not limitative and in general any of the PSRs disclosed herein may alternatively be applied in the following examples. Similarly, the various features of the following examples may be combined together in any combination.

The PSR 700 comprising the dichroic stack 712 comprising a stack of dielectric layers will now be described further.

FIG. 7A is a schematic diagram illustrating a side view of the operation of an alternative PSR 700 comprising a thin film dichroic stack 712. Features of the embodiment of FIG. 7A not discussed in further detail may be assumed to correspond to the features with equivalent reference numerals as discussed above, including any potential variations in the features.

The PSR 700 may comprise at least one dielectric layer 714 that has a different refractive index to waveguide member 111 and deflection arrangement 112 and is arranged to provide polarisation-sensitive reflection to incident illumination with polarisation states 902, 904, for example by Fresnel reflections or total internal reflections and in the embodiment of FIG. 7A the at least one dielectric layer 714 comprises a stack 712 of dielectric layers 714A-E.

Dielectric stack 712 comprises multiple dielectric layers 714A-E with an illustrative embodiment in TABLE 2. Light rays 401(191) propagating in the first direction 191 with the s-polarised polarisation state 902 are incident onto the dielectric stack 712 and are reflected as light rays 411. Light rays 401(193) that are propagating in the second direction 193 through the extraction waveguide 1 with the p-polarised polarisation state 904 are transmitted at least in part through the dielectric stack 712.

TABLE 2

| | Illustrative | Refractive | Thickness |
|---|---|---|---|
| Item | material | index | (nm) |
| Waveguide member 11A | PMMA | 1.50 | — |
| Dielectric layer 714A | TiO₂ | 2.6 | 54 |
| Dielectric layer 714B | SiO₂ | 1.5 | 181 |
| Dielectric layer 714C | TiO₂ | 2.6 | 55 |
| Dielectric layer 714D | SiO₂ | 1.5 | 181 |
| Dielectric layer 714E | TiO₂ | 2.6 | 55 |
| Waveguide member 11B | PMMA | 1.49 | — |

FIG. 7B is a schematic graph illustrating the variation of thin film stack transmission against wavelength for incident s-polarised polarisation state 902 and p-polarised polarisation state 904. Features of the embodiment of FIG. 7B not discussed in further detail may be assumed to correspond to the features with equivalent reference numerals as discussed above, including any potential variations in the features.

The profiles 716S, 716P are the average transmission over a 20 degrees cone angle incident at a nominal angle of 60 degrees from the normal n₇₁₂ of the dielectric layer 712 for the s-polarisation state 902 and p-polarisation state 904 respectively. Over visible wavelengths, the dielectric stack 712 may achieve high reflectivity for light rays 401(191) propagating in the first direction 191 and high transmission for light rays 401(193) propagating in the second direction 191.

The arrangement of TABLE 2 achieves high efficiency of propagation of light in the first direction. In comparison with wire grid polarisers, the dielectric stack 712 may be conveniently provided on the waveguide member 111 or deflection arrangement 112 by known deposition techniques. The dielectric stack 712 may have low thickness and not require thermally and mechanically stable substrates for deposition, advantageously achieving reduced cost. Absorption losses in the dielectric stack may be lower than for wire grid polarisers, advantageously achieving increased efficiency.

The number and thickness of the layers of TABLE 2 may be modified to achieve reduced cost or increased bandwidth in wavelength and reflectivity for the desirable cone of illumination angles.

Further some of the polarisation state 904 may be reflected by the dielectric stack 712 such that the length over which uniform extraction occurs may be increased.

The dichroic stack 276 for the layer 275 of FIG. 3B may comprise the same dichroic stack as in TABLE 2. Such an arrangement advantageously may achieve desirable reflection and transmission characteristics. Advantageously cost of fabrication of the PSR 700 and dichroic stack 276 may be reduced.

It would be desirable to provide increased uniformity across the dielectric stack 712.

FIG. 7C is a flow chart illustrating compensation of pixel level to correct for transmission of a dielectric stack 712 and more generally for the PSRs 700 described elsewhere herein. Features of the embodiment of FIG. 7C not discussed in further detail may be assumed to correspond to the features with equivalent reference numerals as discussed above, including any potential variations in the features.

For a given ray angle within the extraction waveguide 1 in the transverse direction 193, the reflectivity of the dielectric stack 712 can vary. Such variations may provide luminance variations in the transverse direction. In a first step S1 the angle of incidence onto the dielectric stack 712 ray 401 for a transverse pixel 222 in row 221T is calculated. In a second step S2, the transmission of the ray 401 in the first and second directions 191, 193 is calculated. In a third step S3, the output of the pixel 222 in the row 221T is modified to compensate for the varying transmission of the ray 401 corresponding to the row 221T at the dielectric stack 712. Advantageously improved uniformity of images at the retina 47 of the eye 45 may be achieved.

A PSR 700 comprising a liquid crystal layer will now be described.

FIG. 8A is a schematic diagram illustrating a rear view of an ANEDD 100 comprising an alternative PSR 700 comprising an in-plane nematic liquid crystal layer 722; FIG. 8B is a schematic diagram illustrating in top view the liquid crystal layer of the PSR of FIG. 8A; and FIG. 8C is a schematic diagram illustrating in side view the liquid crystal layer of the PSR of FIG. 8A. Features of the embodiment of FIGS. 8A-C not discussed in further detail may be assumed to correspond to the features with equivalent reference numerals as discussed above, including any potential variations in the features.

In comparison to the embodiment of FIG. 1A wherein the PSR 700 is a reflective linear polariser 702; or of FIG. 7A wherein the PSR 700 is a dielectric stack 712, in the alternative embodiment of FIGS. 8A-C, the PSR 700 comprises a liquid crystal layer 722 comprising liquid crystal molecules 724 with optical axis direction 725. The liquid crystal molecules may be nematic liquid crystal molecules and arranged in an aligned layer. The liquid crystal molecules 724 are arranged between first and second opposing alignment layers 726A, 726B with alignment directions 727A, 727B with pretilts 728A, 727B respectively that provide alignment of the optical axis directions 725 of the liquid crystal molecules 724. The component of the optical axis of the liquid crystal layer 722 in the plane of the liquid crystal layer 722 may be parallel or orthogonal to the first direction 191 along the extraction waveguide.

The liquid crystal molecules may be uncured. Alternatively the molecules may comprise cured liquid crystal molecules such as reactive mesogen molecules that have been cured in UV illumination after alignment. The alignment layers 726A, 726B may be removed after curing, so that the nematic liquid crystal layer 722 does not include the alignment layers 726A, 726B.

The pretilts 728A, 728B may be for example 2 degrees and may be anti-parallel to reduce the presence of alignment disclinations, advantageously reducing scatter. In alternative embodiments, the pre-tilts 728A, 728B may be higher, for example 88 degrees, or may be different. The liquid crystal molecules may have positive dielectric anisotropy as illustrated in FIGS. 8A-C or may have negative dielectric anisotropy. In FIG. 8A, the optical axis direction 725 is aligned with a component 725p in the plane of the liquid crystal layer 722 that is orthogonal to the direction 191 along the extraction waveguide 1. In other embodiments (not illustrated), the optical axis direction 725 may be aligned with a component 725p in the plane of the liquid crystal layer 722 that is parallel to the direction 191 along the extraction waveguide 1.

The operation of the extraction waveguide 1 of FIG. 8A will now be further described.

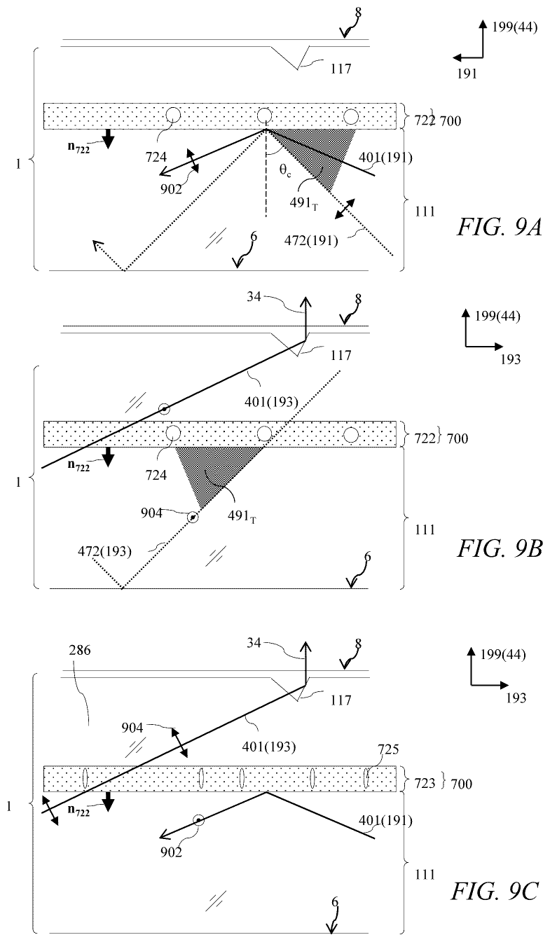

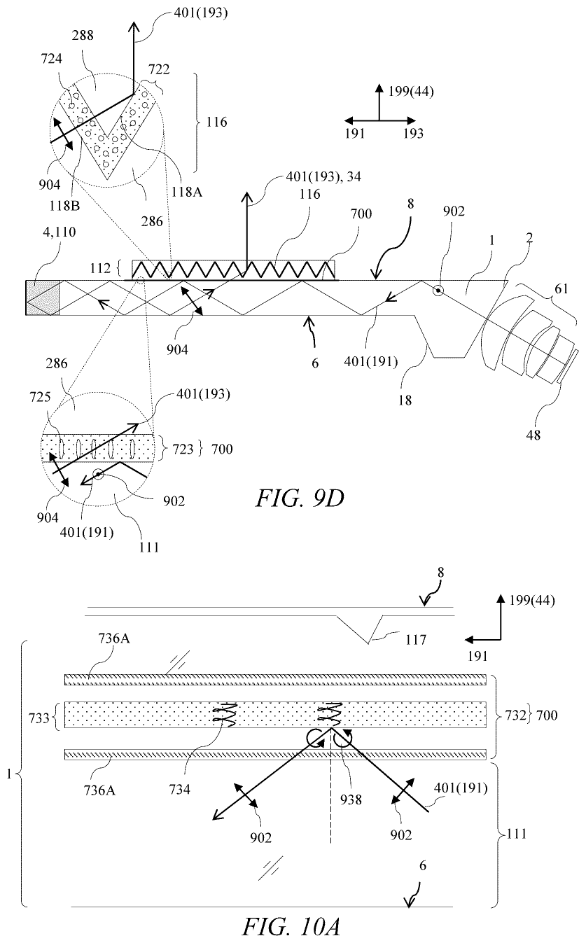

FIG. 9A is a schematic diagram illustrating a side view of the operation of an alternative PSR 700 comprising nematic liquid crystal layer 722 for p-polarised light polarisation state 902 propagating in the first direction 191 along the extraction waveguide 1; and FIG. 9B is a schematic diagram illustrating a side view of the operation of the alternative PSR 700 of FIG. 9A for s-polarised light polarisation state 904 propagating in the second direction 193 along the extraction waveguide 1. Features of the embodiment of FIGS. 9A-B not discussed in further detail may be assumed to correspond to the features with equivalent reference numerals as discussed above, including any potential variations in the features.

An illustrative embodiment of the PSR 700 comprising nematic liquid crystal layer 722 is shown in TABLE 3.

TABLE 3

| | Illustrative |
|---|---|
| Item | value |
| Waveguide member 111 refractive index | 1.80 |
| Liquid crystal molecule 725 ordinary refractive | 1.50 |
| index, nₒ | |
| Liquid crystal layer molecule 725 extraordinary | 1.80 |
| refractive index, nₑ | |
| Waveguide member 111 refractive index | 1.80 |
| Critical angle, qc at interface of constituent part 111 | 56° |
| and nematic liquid crystal layer 722 | |

In the alternative embodiment of FIG. 9A, the polarisation state 902 of rays 401(191), 472(191) see the ordinary refractive index of the liquid crystal molecules 724 and undergo total internal reflection. The light cone 491_{T} has a cone size that is limited by the critical angle θ_{c} at the interface of the waveguide member 111 and the nematic liquid crystal layer 722 for the incident polarisation state 902.

Thus light rays 401(191) within the cone 491_{T} guide between the PSR 700 and the light guide surface 8.

FIG. 9B illustrates that the rays 401(193) propagating in the second direction 193 are index matched at the interface with the nematic liquid crystal layer 722 and are transmitted for incidence onto the rear guide surface 6. Advantageously the nematic liquid crystal layer 722 may be conveniently manufactured with high uniformity and low cost and provided in a thin layer between the waveguide member 111 and deflection arrangement 112.

FIG. 9C is a schematic diagram illustrating a side view of the operation of an alternative PSR 700 comprising homeotropically aligned liquid crystal layer 723; and FIG. 9D is a schematic diagram illustrating a side view of an ANEDD 100 comprising a PSR 700 comprising homeotropically aligned liquid crystal material 725 and deflection features 118A comprising homogeneously aligned liquid crystal material 724. Features of the embodiments of FIGS. 9C-D not discussed in further detail may be assumed to correspond to the features with equivalent reference numerals as discussed above, including any potential variations in the features.

By way of comparison with the embodiment of FIGS. 9A-B, the refractive index of the waveguide member 111 is close to the extraordinary refractive index of the liquid crystal molecules 725, and higher than the extraordinary refractive index. In rod-like liquid crystal molecules 725, the extraordinary refractive index is higher than the ordinary refractive index and the refractive index of the waveguide member 111 is thus higher than for FIGS. 9A-B. Advantageously a larger light cone 491T may be provided within the waveguide member 111 and a larger field of view may be achieved in the transverse direction 197.

Considering FIG. 9C, light rays 401(191) are guided by total internal reflection along the waveguide 1 in the first direction 191. Light rays returning along the waveguide 1 have a p-polarisation state component at the liquid crystal layer 723 and see a refractive index of the liquid crystal material 724 that is more closely matched to the index of the waveguide member 111. Such light at least in part is transmitted through the liquid crystal layer 723 and output by reflection at the reflector 117.

Considering FIG. 9D, the p-polarisation state of light ray 401(193) is input into the rear element 286 of the deflection arrangement 112. The deflection element 116 comprises deflection features 118A that comprise a layer 722 of homogeneously aligned liquid crystal material 724. Light with near-normal incidence is transmitted through draft feature 118B and reflected by total internal reflection at reflection feature 118A. The materials 724, 725 may be the same to advantageously reduce cost and complexity; or may be different to modify output performance.

It may be desirable to provide an increased field of view in the transverse direction 197.

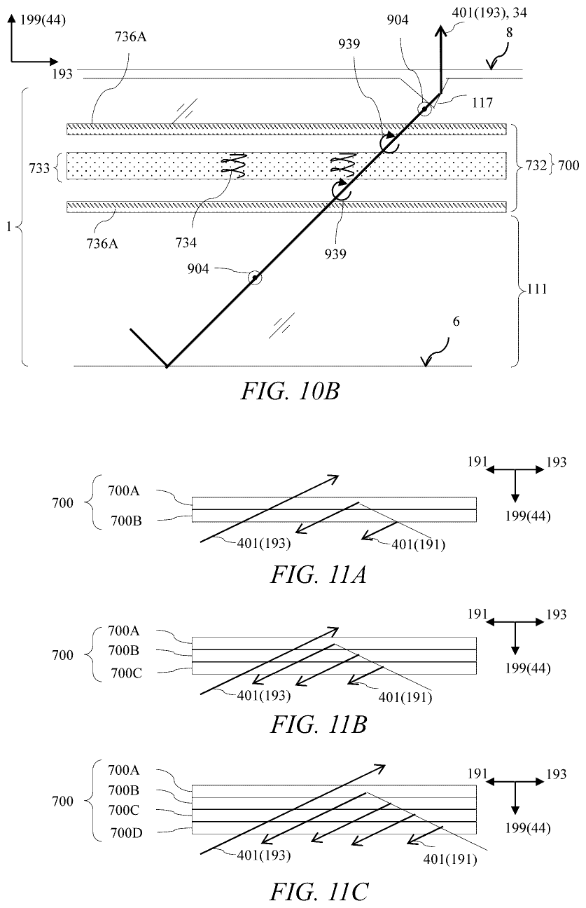

FIG. 10A is a schematic diagram illustrating a side view of the operation of an alternative PSR 700 comprising a cholesteric liquid crystal layer 732 for p-polarised light polarisation state 902 propagating in the first direction 191 along the extraction waveguide 1; and FIG. 10B is a schematic diagram illustrating a side view of the operation of the cholesteric liquid crystal layer 732 of FIG. 9A for s-polarised light polarisation state 904 propagating in the second direction 193 along the extraction waveguide 1. Features of the embodiment of FIGS. 10A-B not discussed in further detail may be assumed to correspond to the features with equivalent reference numerals as discussed above, including any potential variations in the features.

In comparison to the embodiment of FIG. 9A, in the alternative embodiment of FIG. 10A, the PSR 700 comprises a cholesteric liquid crystal reflector 732 comprising a layer 733 of cholesteric liquid crystal material 734.

The ANEDD 100 further comprises a polarisation conversion retarder 736A arranged between rear guide surface 6 and the cholesteric liquid crystal retarder 733, wherein the polarisation conversion retarder 736A is arranged to convert a polarisation state of light passing therethrough between a linear polarisation state 902 and a circular polarisation state 938, and the polarisation conversion retarder 736A and the cholesteric liquid crystal layer 733 are arranged in combination to reflect the input linear polarisation state 902 of the light guided in the first direction 401(191) and to transmit the linear polarisation state 904 of the light 401(193) guided in the second direction. The ANEDD further comprises a polarisation conversion retarder 736B arranged between rear guiding surface 6 and the cholesteric liquid crystal retarder 733 wherein the polarisation conversion retarder 736B is arranged to convert a polarisation state of light passing therethrough between a linear polarisation state 904 and a circular polarisation state 939.

In other words, layer 733 is arranged between opposing polarisation conversion retarders 736A, 736B that are arranged to convert off-axis polarisation state 902 to a circular polarisation state 938 and a circular polarisation state 938 to a linear polarisation state 902; and to convert off-axis polarisation state 904 to a circular polarisation state 939 and a circular polarisation state 939 to a linear polarisation state 904. Polarisation conversion retarders 736A, 736B may be quarter-wave retarders when considering off-axis illumination of light rays 401, and may thus have a different retardance to quarter-wave retarders for on-axis light.

Polarisation conversion retarders 736A, 736B advantageously provide linear polarisation states to guide within the extraction waveguide 1 that increases efficiency and uniformity. By way of comparison, guiding of circular polarisation states, in which polarisation conversion retarders 736A, 736B are omitted causes depolarisation of light during guiding and reduces efficiency.

In operation, the incident polarisation state 902 is incident onto the polarisation conversion retarder 736A and polarisation state 938 is output and incident onto layer 733 of cholesteric material 734 that is aligned with chirality and pitch to reflect the incident light rays 401. The reflected polarisation state from the layer 733 does not undergo a phase shift that would happen for a mirror, and so the polarisation state 938 on reflection from the layer 933 is not reflected in comparison to the reflected polarisation states 922, 924 described in FIG. 6A for example.

The cholesteric liquid crystal layer 733 may have a chirped pitch structure to achieve increased bandwidth and may have different orientations to increase angular reflectivity.

Output polarisation state 902 is provided after the second pass of the ray 401(191) through the polarisation conversion retarder 736A and light guides along the extraction waveguide 1 between the cholesteric liquid crystal reflector 732 and the front light guide surface 8 as described elsewhere herein.

FIG. 10B illustrates the propagation in the second direction 193, wherein the polarisation state 904 is incident onto the cholesteric liquid crystal reflector 732. Circular polarisation state 939 is incident onto the layer 939 and is transmitted and output as the same polarisation state 904 into the deflection arrangement 112 for illumination of the second light guide surface.

In comparison to the embodiment of FIGS. 9A-B, the cone angle 491_{T} may be increased in size and the field of view ϕ_{T} in the transverse direction advantageously increased. Further the refractive index of the waveguide member 111 and deflection arrangement 112 may be reduced, advantageously reducing cost.

It may be desirable to improve the efficiency and uniformity of the PSR 700.

FIGS. 11A-C are schematic diagrams illustrating side views of various arrangements of PSRs 700. Features of the embodiments of FIGS. 11A-C not discussed in further detail may be assumed to correspond to the features with equivalent reference numerals as discussed above, including any potential variations in the features.

The PSR 700 may further comprise multiple PSR elements. FIG. 11A illustrates a dual-layer PSR 700, FIG. 11B illustrates a three-layer PSR 700 and FIG. 11C illustrates a four-layer PSR 700. Each of the PSRs 700A-D may comprise a reflective linear polariser 702, a dielectric stack 712, a nematic liquid crystal layer 722 or a cholesteric liquid crystal layer 732. Other known polarisation-sensitive reflective layers may alternatively be provided.

Advantageously the efficiency of discrimination between polarisation states 902, 904 propagating in first and second directions 191, 193 can be increased or modified. System efficiency and image uniformity across the exit pupil 40 may be increased.

In an illustrative embodiment, the PSR 700A may comprise a reflective linear polariser 702 and the PSR 700B may comprise a dielectric stack 712. For light rays 401(191) the dielectric stack 712 of PSR 700B may have high reflectivity and any residual light that passes through the dielectric stack is reflected by the reflective linear polariser 702. Advantageously the light is efficiently guided between the PSR 700 and the front light guide surface 8 in the first direction 191. As much of the reflectivity is provided by the dielectric stack 712 then absorption losses from reflection at the reflective linear polariser 702 are reduced and the efficiency of guiding along the extraction waveguide 1 increased.

For light rays 401(193), the dielectric stack 712 may be arranged to provide residual reflectivity of the incident p-polarisation state. Such residual reflectivity provides increased light that guides along the extraction waveguide 1 in the second direction after the first reflection at the PSR 700, and advantageously achieves increased uniformity.

The formation of exit pupil 40 for different pixels will now be described.

FIG. 12A is a schematic diagram illustrating a side view of light extraction from waveguide 1 for a central pixel 222C; FIG. 12B is a schematic diagram illustrating a side view of light extraction from waveguide 1 for a top pixel 222T; FIG. 12C is a schematic diagram illustrating a side view of light extraction from waveguide 1 for a bottom pixel 222B; and FIG. 12D is a schematic diagram illustrating a side view of exit pupil 40 geometry for an arrangement without guiding of light through the layer of the light deflection features. Features of the embodiment of FIGS. 12A-D not discussed in further detail may be assumed to correspond to the features with equivalent reference numerals as discussed above, including any potential variations in the features.

FIG. 12A illustrates output rays 460C_{R}(193) for a central pixel 222C (referring to the SLM 48 of FIG. 1C) where no light is guided by the front guide surface 8 back into the waveguide 1; similarly FIG. 12B illustrates the output rays 460T_{R}(193) for top pixel 222T and FIG. 12C illustrates the output rays 460B_{R}(193) for bottom side pixel 222B, such as illustrated in FIG. 1D.

FIG. 12D illustrates the combined ray angular output for rays 460T_{R}(193) and 460B_{R}(193), to provide an exit pupil 40 at the overlap of said rays. An observer's pupil 44 placed in the exit pupil 40 will see the full image data across the transverse direction 197.

It would be desirable to increase the size of the exit pupil 40.

FIG. 12E is a schematic diagram illustrating a side view of light extraction for a left side pixel 222L when some of the light is guided from the front guide surface 8 of the front waveguide 114; and FIG. 12F is a schematic diagram illustrating a side view of exit pupil 40 formation for an arrangement with guiding of light from the front guide surface 8. Features of the embodiment of FIGS. 12E-F not discussed in further detail may be assumed to correspond to the features with equivalent reference numerals as discussed above, including any potential variations in the features.

Returning to the description of FIG. 3B, ray 460C_{T}(193) is partially transmitted by the dichroic stack reflector 117 and is reflected back through the light deflection arrangement 112 comprising the layer 275 of tilted dichroic deflection feature 118A, and draft facet 118B. Some of the rays 460C_{T}(193) may be arranged to increase the size of the exit pupil 40. Such guiding preserves visibility of said ray angles such that the reflector 117 provides output of all ray angles.

By way of comparison with FIG. 12C, FIG. 12E illustrates rays 460B_{T}(193) are provided that are transmitted through the layer comprising the deflection feature 118A, and draft facet 118B and are incident for a second time on the light deflection arrangement 112.

FIG. 12F illustrates that such additional rays 460B_{T}(193) achieve increased size of exit pupil 40. Advantageously the viewer freedom may be increased, and the appearance of vignetted images reduced.

Region 462 represents a “hole” in the distribution from which no light may propagate and may provide undesirable non-uniformities to the eye 45 of an observer. It would be desirable to provide light in the region of the hole region 462 wherein missing ray angles are reduced or eliminated and advantageously uniformity of the field of ray angles seen by the eye 45 is increased. Further, the size of the transverse anamorphic component 60 in the transverse direction is increased for a given desirable thickness. Advantageously brightness may be increased and/or thickness of the extraction waveguide 1 reduced.

FIG. 13A is a schematic diagram illustrating a side view of an alternative ANEDD further comprising partially reflective layer 275 dichroic stacks 276. Features of the embodiment of FIG. 13A not discussed in further detail may be assumed to correspond to the features with equivalent reference numerals as discussed above, including any potential variations in the features.

Continuing the description of FIG. 3B, the deflection arrangement 112 comprises the front waveguide 114 having a front guide surface 8 on the opposite side of the front waveguide 114 from the extraction waveguide 1, the deflection features 118A being disposed internally within the front waveguide 114.

The front waveguide 114 comprises a front element 288 and a rear element 286 having a partially reflective layer 275 disposed therebetween, the partially reflective layer 275 comprising first and second sections of opposite inclination alternating in a direction along the front waveguide, the first sections comprising the reflective reflectors 117 and the second sections being arranged to pass the light passed by the PSR 712 that is incident thereon.

Considering further light ray 460C_{T}(193) that is transmitted by the partially reflective layer 275 of the reflector 117, such ray 460C_{T}(193) comprises an s-polarisation state that guides between the front guide surface 8, and the PSR 712, such that extraction takes place at a further spatial locations along the deflection arrangement 112 to the ray 460C_{R}(193). Such light rays 460C_{T}(193) may provide an increased pupil 40 size as illustrated in FIGS. 12E-F.

Some stray light 463 may reflect from reflective facet 118B towards the external environment. The polarisation conversion retarder 73 rotates the polarisation state 902 to the polarisation state 904 which is absorbed at the external polariser 90. Advantageously glow from the stray light is reduced.

FIG. 13B is a schematic diagram illustrating a side view of an alternative ANEDD further comprising a polarisation conversion retarder 73 arranged to provide an elliptical polarisation state 906. Features of the embodiment of FIG. 13B not discussed in further detail may be assumed to correspond to the features with equivalent reference numerals as discussed above, including any potential variations in the features.

By way of comparison with FIG. 13A, the alternative embodiment of FIG. 13B provides a polarisation conversion retarder 73 that has a retardance/and or optical axis direction 773 that is arranged to provide an elliptical polarisation state 906 that may be resolved as s-polarisation state 902 and p-polarisation state 904 within the front waveguide 114. For example, the polarisation conversion retarder 73 may be a quarter-wave plate so that the polarisation state 906 is a circular polarisation state.

The reflectors 117 may be partially transmissive to the s-polarisation state 902, or may be partially transmissive. At least some of light ray 460C_{R}(193) with polarisation state 902 is reflected at the reflector 117 to provide output light ray 465.

The p-polarisation state 904 component is transmitted through the reflector 117 and is reflected by total internal reflection from the front guide surface 8. The reflected light is incident onto the polarisation conversion retarder 73, wherein the polarisation conversion retarder 73 and PSR 700 provides polarisation state 902, 904 components from elliptical polarisation state 907 in reflection that is directed to reflector 117 and outputs as ray 466. The transmitted ray 464 provides a p-polarisation state 904 in transmission that is reflected from the rear guide surface 6 and output at a further location along the deflection arrangement 112. Advantageously such light rays 464, 466 may provide illumination in the region of the region 462 in FIG. 12E. Advantageously the size of the exit pupil 40 may be expanded and the uniformity of output may be increased.

The modified retardation of the polarisation conversion retarder 73 may be provided in other of the alternative embodiments of the present disclosure to desirably increase exit pupil 40 size and uniformity.

FIG. 14 is a schematic diagram illustrating a side view of an alternative ANEDD 100 further comprising a partial reflector arranged between the PSR 700 and the deflection arrangement 112. Features of the embodiment of FIG. 14 not discussed in further detail may be assumed to correspond to the features with equivalent reference numerals as discussed above, including any potential variations in the features.

By way of comparison with FIG. 3B, the alternative embodiment of FIG. 14 illustrates a deflection arrangement 112 comprising a partial reflector 74 arranged to pass part of the light 460C(193) that is incident thereon and to reflect the remainder of the light as ray 468 that is incident thereon back into the extraction waveguide 1; wherein a deflection element 116 is arranged to deflect the part of the light that is passed by the partial reflector forwards of the ANEDD 100. The deflection element 116 comprises an array of deflection features 118A that are arranged to deflect the part of the light 465 that is passed by the partial reflector 74 forwards of the ANEDD 100.

The partial reflector 74 may comprise a metal material or may comprise a further partially reflective layer such as a dichroic stack.

By way of comparison with FIG. 13B, FIG. 14B illustrates that some light may be reflected back into the extraction waveguide 1 to provide additional locations for output rays 467, achieving increased pupil 40 size and image uniformity.

In operation, increased size of exit pupil 40 may be achieved. The partial reflector 74 may be provided in other of the alternative embodiments of the present disclosure to desirably increase exit pupil 40 size and uniformity.

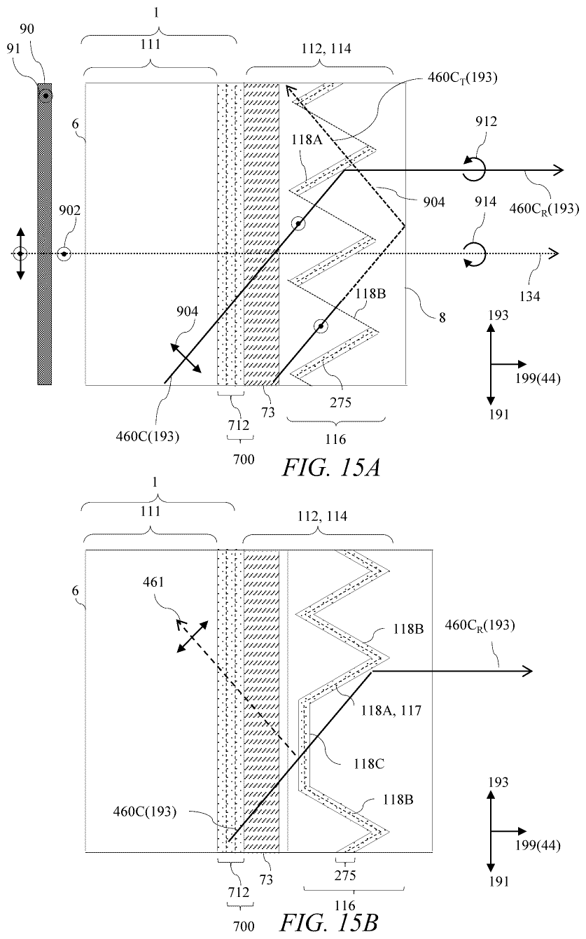

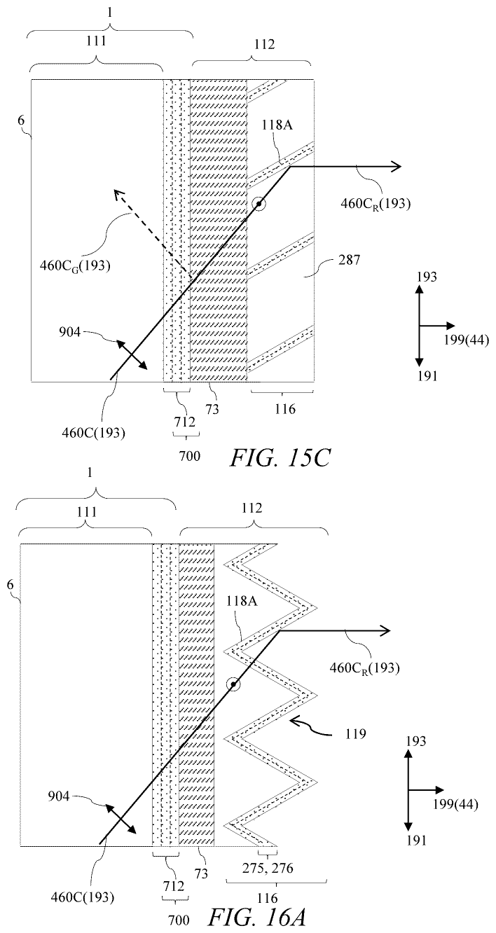

FIG. 15A is a schematic diagram illustrating a side view of an alternative ANEDD wherein one of the inclined deflection features does not comprise a dichroic stack. Features of the embodiment of FIG. 15A not discussed in further detail may be assumed to correspond to the features with equivalent reference numerals as discussed above, including any potential variations in the features.

By way of comparison with FIG. 14, the alternative embodiment of FIG. 15A illustrates that the draft facets 118B may be provided with no dichroic stack 276.

Such an arrangement may be achieved by oblique deposition of the dichroic stack onto the facets 118A, minimising the coating onto draft facets 118B. In operation, light rays 460C(193) are transmitted at the location of the draft facets 118B and reflected by the facets 118A. Advantageously efficiency is increased and stray light reduced, achieving reduced glare and cross-talk.

The uncoated draft facets 118B may be provided in other of the alternative embodiments of the present disclosure to desirably reduce stray light.

FIG. 15B is a schematic diagram illustrating a side view of an alternative ANEDD 100 further comprising guide facets 118C. Features of the embodiment of FIG. 15B not discussed in further detail may be assumed to correspond to the features with equivalent reference numerals as discussed above, including any potential variations in the features.

By way of comparison with FIG. 3B, the guide facets 118C provides further light rays 461 that direct light along the extraction waveguide in the second direction 193. Advantageously the size of the exit pupil 40 may be expanded and the uniformity of output may be increased. The guide facets 118C may be coated with the same material as the reflectors 117.

The guide facets 118C may be provided in other of the alternative embodiments of the present disclosure to desirably increase exit pupil 40 size and uniformity.

FIG. 15C is a schematic diagram illustrating a side view of an alternative ANEDD wherein the dichroic stack is provided on inclined deflection features arranged as a pile of plates 287. Features of the embodiment of FIG. 15C not discussed in further detail may be assumed to correspond to the features with equivalent reference numerals as discussed above, including any potential variations in the features.

By way of comparison with the embodiment of FIG. 15A, draft facets 118B, front element 288 and the rear element 286 are omitted, and each reflective feature 118A is provided between adjacent plates 287. Advantageously efficiency and stray light is improved.

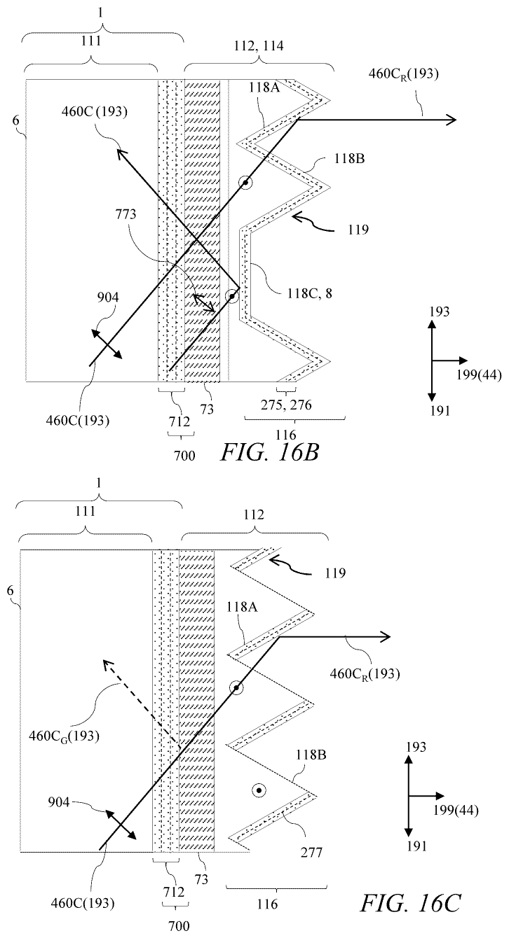

FIG. 16A is a schematic diagram illustrating a side view of an alternative ANEDD 100 wherein the dichroic stack is provided on inclined deflection features and a guiding deflection feature. Features of the embodiment of FIG. 16A not discussed in further detail may be assumed to correspond to the features with equivalent reference numerals as discussed above, including any potential variations in the features.

The deflection element 116 has a front surface 119 on the opposite side thereof from the extraction waveguide 1, the front surface 119 comprising inclined facets 118A that form the deflection features and draft facets 118B.

The front surface of the deflection element 116 further comprises draft facets 118B that alternate with the inclined facets and are of an opposite inclination to the inclined facets that form the deflection features 118A, the draft facets 118B being arranged to pass the light passed by the PSR 700 that is incident thereon. The front surface has a partially reflective layer 275 disposed thereon.

By way of comparison with FIG. 3B, the alternative embodiment of FIG. 16A may have reduced cost and complexity of manufacture. Such an embodiment may be suitable for virtual image presentation and not for viewing of objects 130 directly.

FIG. 16B is a schematic diagram illustrating a side view of an alternative ANEDD 100 wherein the front element 288 is omitted. Features of the embodiment of FIG. 16B not discussed in further detail may be assumed to correspond to the features with equivalent reference numerals as discussed above, including any potential variations in the features.

The deflection element 112 comprises a front waveguide 114 having a front surface 8 on the opposite side of the front waveguide 114 from the extraction waveguide 1, the front surface 8 comprising guide facets 118C that are arranged to guide light incident thereon in the second direction 193 along the front waveguide 114 and inclined facets 118A that form the deflection elements 116.

The front surface 8 of the front waveguide 114 further comprises draft facets 118B that are of an opposite inclination to the inclined facets that form the deflection features 118A, the draft facets 118B being arranged to pass the light passed by the PSR 700 that is incident thereon.

The front surface 119 of the front waveguide has a partially reflective layer disposed thereon.

By way of comparison with FIG. 15B, the alternative embodiment of FIG. 16B may have reduced cost and complexity of manufacture. Such an embodiment may be suitable for virtual image presentation and not for viewing of objects 130 directly.

FIG. 16C is a schematic diagram illustrating a side view of an alternative ANEDD wherein the dichroic stack 276 is provided on the inclined deflection features 118A, and the dichroic stack 276 is not provided on the inclined draft facets 118B. Features of the embodiment of FIG. 16C not discussed in further detail may be assumed to correspond to the features with equivalent reference numerals as discussed above, including any potential variations in the features.

The deflection element 116 has a front surface 109 on the opposite side thereof from the extraction waveguide 1, the front surface 109 comprising inclined facets that form the deflection features 118A.

The front surface 109 of the deflection element 116 further comprises draft facets 118B that alternate with the inclined facets and are of an opposite inclination to the inclined facets that form the deflection features 118A, the draft facets 118B being arranged to pass the light passed by the PSR 700 that is incident thereon.

By way of comparison with FIG. 15A, in the alternative embodiment of FIG. 16C, the front element 288 is omitted. Further the deflection features 118A may be coated by a high reflectivity reflective material 277 such as a high efficiency dichroic coating or a metallic coating disposed thereon. Advantageously increased efficiency of output may be achieved.

Alternative arrangements of reflective extraction elements 116 will now be described.

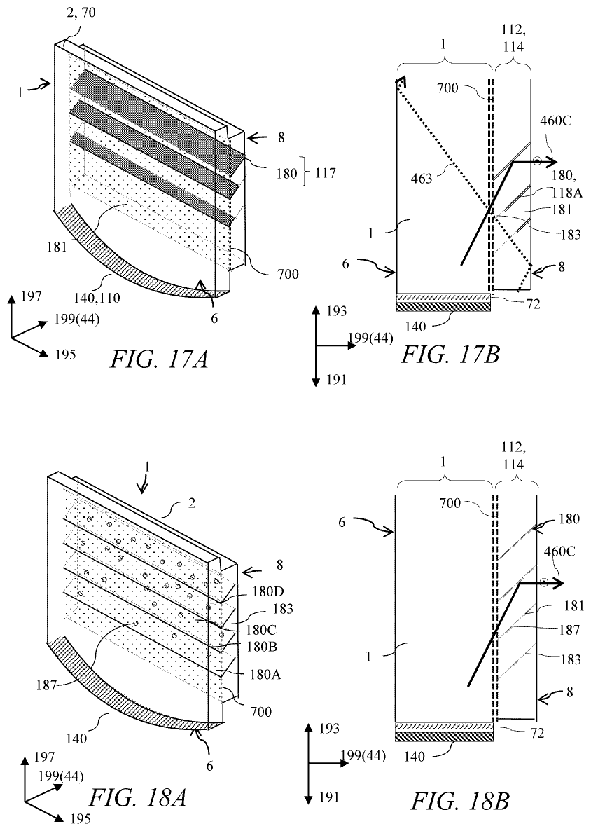

FIG. 17A is a schematic diagram illustrating in rear perspective view an alternative arrangement of the ANEDD 100 of FIG. 17A wherein some of the partially reflective surfaces 180 do not extend the entirety of the thickness of the extraction waveguide 1 between the PSR 700 and the rear light-guide surface 6; and FIG. 17B is a schematic diagram illustrating in side view the operation of the ANEDD 100 of FIG. 17A. Features of the embodiment of FIGS. 17A-B not discussed in further detail may be assumed to correspond to the features with equivalent reference numerals as discussed above, including any potential variations in the features.

In the alternative embodiment of FIGS. 17A-B, the reflectors 117 are partially reflective surfaces 180 that extend across part of the front waveguide 114 and provide the deflection features 118A. The partially reflective surfaces 180 may be provided on the surface of plates 181. The draft facets 118B hereinabove are omitted.

The array of partially reflective surfaces 180 may have reflectivities defined across their overall area that increase with increasing distance along the optical axis 199 along the front waveguide 114 in the second direction 193. In region 183 of the interface between plates 181 is arranged to be transmissive. Alternatively or additionally the partially reflective surfaces 180 may be patterned to have different reflective areas providing reflectivities defined across their overall area that increase with increasing distance along the optical axis 199(60) in the second direction 193.

Such partially reflective surfaces 180 may be manufactured by masking of the plates 180 during the formation of a dichroic stack comprising dielectric layers or metal layers, for example by deposition. Some regions 181 of the surfaces of the plates may thus have no dielectric stack.

In operation, some light rays 463 are redirected back towards the extraction waveguide 1 to provide pupil expansion as discussed hereinabove.

FIG. 18A is a schematic diagram illustrating in rear perspective view an alternative arrangement of the ANEDD 100 of FIG. 17A, wherein the partially reflective surfaces 180 comprise patterned reflectors 187; and FIG. 18B is a schematic diagram illustrating in side view the operation of the ANEDD 100 of FIG. 18A. Features of the embodiment of FIGS. 18A-B not discussed in further detail may be assumed to correspond to the features with equivalent reference numerals as discussed above, including any potential variations in the features.

In the alternative embodiment of FIGS. 18A-B, the partially reflective surfaces 180 have a density by area of patterning of reflector 187 separated by transmissive region 183 that increases with distance along the front waveguide 114 in the direction 193 away from the light reversing reflector 140 to achieve the desirable reflectivity profile.

The patterning of the partially reflective surfaces 180 may achieve reduced complexity of fabrication of the plates 180. Further, the partially reflective surfaces 180 may comprise patterned reflectors 187 that comprise high reflectivity metal compared to the dielectric stacks discussed elsewhere herein. Advantageously cost of fabrication of the partially reflective surfaces 180 may be reduced.

Deflection arrangements 112 that comprise diffractive structures will now be described.

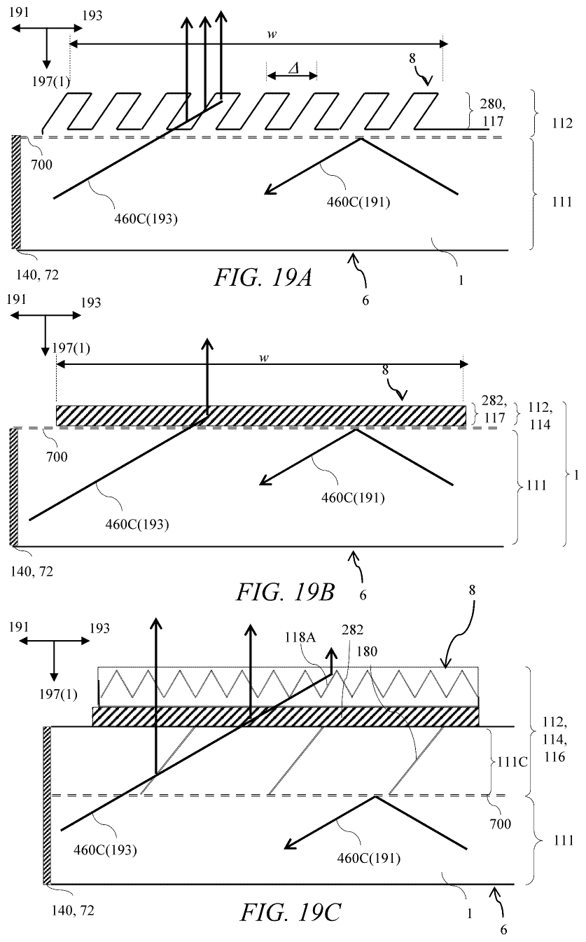

FIG. 19A is a schematic diagram illustrating a side view of the operation of an array of reflectors 117 comprising a surface relief grating 280. Features of the embodiment of FIG. 19A not discussed in further detail may be assumed to correspond to the features with equivalent reference numerals as discussed above, including any potential variations in the features.

In the alternative embodiment of FIG. 19A, the front guide surface 8 comprises a surface relief grating 280 comprising the reflectors 117 provided by the surface structure of the surface relief grating. The pitch Δ of the surface relief grating 280 is arranged to provide reflection of incident light through the front light guide surface 8 to the exit pupil 40.

In comparison to the prism structures 171 comprising reflective reflectors 117 of FIG. 12E, the embodiment of FIG. 19A provides reduced blurring due to diffraction from the large aperture width, w of the reflector 117. Advantageously image resolution may be increased.

FIG. 19B is a schematic diagram illustrating a side view of the operation of an array of reflectors 117 comprising a volume diffractive optical element 282. Features of the embodiment of FIG. 19B not discussed in further detail may be assumed to correspond to the features with equivalent reference numerals as discussed above, including any potential variations in the features.

In comparison to the embodiment of FIG. 19A, in the alternative embodiment of FIG. 19B, the volume diffractive optical element 282 may comprise diffractive structure disposed within the extraction waveguide 1 comprising modulated phase grating comprising the array of reflective deflection features so that the volume diffractive optical element 282 is arranged to provide reflection of incident light through the front light guide surface 8 to the exit pupil 40.

The extraction waveguide 1 of FIG. 19B may be formed by forming the PSR 700 on the front surface of waveguide member 111 and forming the volume diffractive optical element 282 on the PSR 700. Advantageously thickness may be reduced.

In comparison to the prism structures of FIG. 3B for example, the embodiment of FIG. 19B provides reduced blurring due to diffraction from the large aperture width, w of the reflector 117. Advantageously image resolution may be increased.

The spectral bandwidth of reflection may be increased by providing chirped or multiple volume diffractive optical elements 282.

FIG. 19C is a schematic diagram illustrating a side view of the operation of an array of reflectors 117 comprising different types of extraction features. Features of the embodiment of FIG. 19C not discussed in further detail may be assumed to correspond to the features with equivalent reference numerals as discussed above, including any potential variations in the features.

In the above examples, specific examples of the deflection arrangement 112 are shown (for example being deflection feature 118A in FIG. 3B, plates 181 with coatings 180 in FIGS. 17A-B, diffractive optical elements in FIGS. 19A-B and so on), but this is not limitative and in general any of the reflectors 117 disclosed herein may alternatively be applied in the above examples. Similarly, the various features of the following examples may be combined together in any combination.

In the alternative embodiment of FIG. 19C, in the first direction 191, light 460C(191) is guided between the PSR 700 and the front light guide surface 8. In the second direction 193, at least some light 460C(193) is transmitted through the PSR 700 and incident on the deflection arrangement 112 comprising the front guide surface 8 and array of reflectors 117 comprising deflection features 118A, diffractive optical element 282, partially reflective surfaces 180 and stepped extraction reflectors 186 for extraction through the front light guide surface 8 to the exit pupil 40.

In alternative embodiments, other combinations of deflection features may be used. The embodiment for example of FIG. 19C illustrates that the different types of deflection features may be used to achieve improved image resolution, efficiency and uniformity to the eye 45 of the user.

It may be desirable to improve output uniformity for locations across the exit pupil 40.

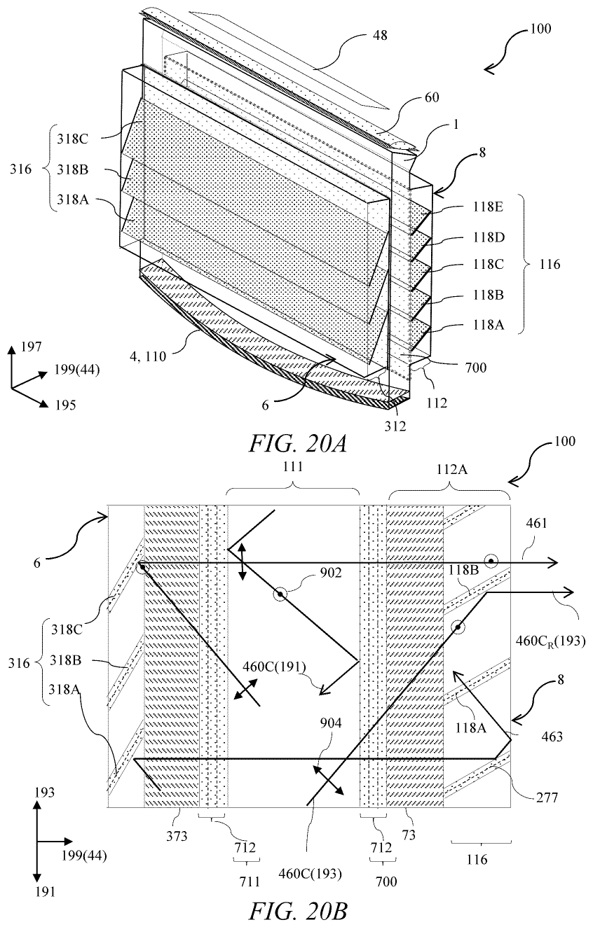

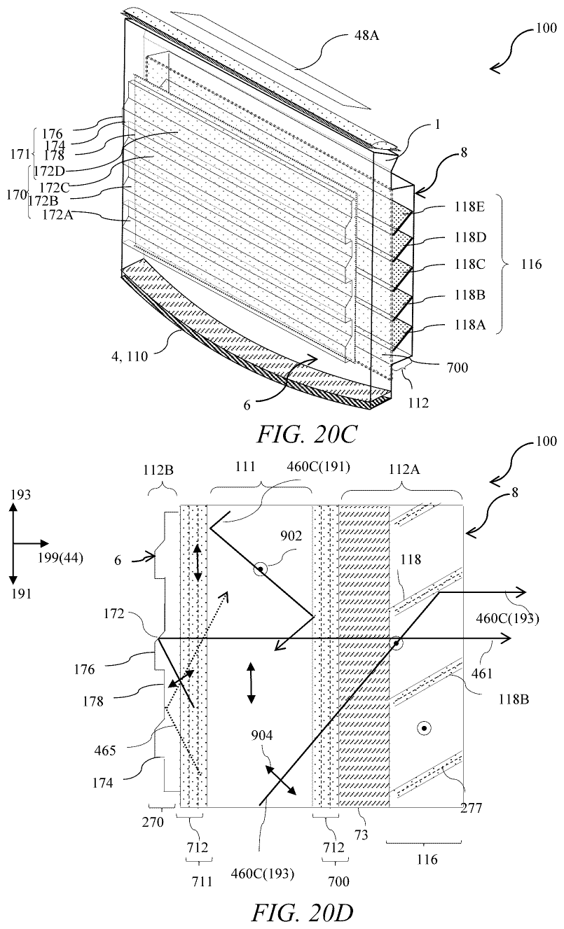

FIG. 20A is a schematic diagram illustrating in rear perspective view an alternative arrangement of the ANEDD 100 comprising first and second PSRs 700, 711 and respective first and second deflection elements 116, 316 that comprise deflection reflectors 118, 318; and FIG. 20B is a schematic diagram illustrating in side view the operation of the alternative arrangement of FIG. 20A. Features of the embodiment of FIGS. 20A-B not discussed in further detail may be assumed to correspond to the features with equivalent reference numerals as discussed above, including any potential variations in the features.

By way of comparison with the embodiment illustrated for example in FIG. 15C, the alternative embodiment of FIGS. 20A-B illustrates an ANEDD 100 comprising a PSR 711 that is a dichroic stack 712 opposing the front guide surface 8 such that waveguide member 111 is provided between the PSRs 700, 716. Input light rays 460C(191) from the input end 2 of the waveguide with polarisation state 902 that is an s-polarisation state in the waveguide member 111 is guided along the waveguide in the first direction 191.

A further polarisation conversion retarder 373 and a further deflection element 316 comprising deflection reflectors 318A-C is arranged to receive light rays 460C(193) reflected by the light reversing reflector 14 that are propagating in the second direction 193 along the waveguide 1.

Some of the light rays 460C(193) that have p-polarisation state 904 are transmitted by the PSRs 700, 716. Light rays that are incident on deflection reflectors 318A-C are reflected towards the front guide surface 8; some light rays 461 are transmitted through the regions between the deflection reflectors 118 and transmitted towards the eye 45 (not shown); while rays that are incident onto the deflection reflectors 118 are reflected for extraction at different locations along the waveguide 1.

The reflection deflectors 318 may comprise dichroic stacks or other polarisation sensitive layers, or may be metallic. Metallic reflection deflectors 318 achieve higher reflectance for incident angles that are close to the normal and the retarder 373 may be omitted. Advantageously extraction efficiency is increased and complexity reduced.

The alternative embodiment of FIGS. 20A-B advantageously increased uniformity of extraction across the exit pupil 40, improving freedom of eye movement and reducing image artefacts. Alternative arrangements of light deflecting elements and polarisation-sensitive reflections as described elsewhere herein may be used for the rear elements 712, 316.

FIG. 20C is a schematic diagram illustrating in rear perspective view an alternative arrangement of the ANEDD 100 comprising first and second PSRs 700, 711, a front deflection elements 118 that comprises polarisation-sensitive deflection reflectors 118 and a rear deflection element 270 that comprises a structured rear guide surface 6; and FIG. 20D is a schematic diagram illustrating in side view the operation of the alternative arrangement of FIG. 20C. Features of the embodiment of FIGS. 20C-D not discussed in further detail may be assumed to correspond to the features with equivalent reference numerals as discussed above, including any potential variations in the features.

By way of comparison with FIGS. 20A-B, the alternative embodiment of FIGS. 20C-D extraction element 270 is disposed outside the PSR 711, the extraction element 270 comprising: the rear guide surface 6 opposing the front guide surface 8; and an array of extraction features 170. The array of extraction features 170 is arranged on the rear guide surface 6 that comprises plural prisms 171 that protrude outwardly. The prisms 171 each comprise at least one extraction facet 172, and at least one draft facet 174. At least one primary guide facet 176 may be arranged between the respective at least one extraction facet 172 and the at least one draft facet 174. The rear guide surface 6 further comprises guide portions 178 between the prisms 171. Alternative embodiments of deflection elements 270 for use in rear deflection elements of the structures of FIGS. 20C-D are described in U.S. Patent Publ. No. 2024-0061248, which is herein incorporated by reference in its entirety.

Light rays 461 propagating in the second direction 193 pass through the PSR 711 and are reflected by total internal reflection at the extraction facet 172 back through the PSR 711 and towards the front guide surface 8. Other light rays 465 are guided by the primary guide facet 176 or the guide portions 178.

The alternative embodiment of FIGS. 20C-D advantageously increased uniformity of extraction across the exit pupil 40, improving freedom of eye movement and reducing image artefacts. The extraction element 270 may be more conveniently manufactured at low cost in comparison to the extraction element 316 of FIG. 20B.

As illustrated in FIG. 3G, some light may return to the input end 2. It would be desirable to minimise cross-talk and increase contrast of the ANEDD 100.

FIG. 21A is a schematic diagram illustrating a side view of optical isolation near the input end 2 of an ANEDD 100 comprising an emissive SLM 48; and FIG. 21B is a schematic diagram illustrating optical axis alignment directions through the polarisation control components of FIG. 21A. Features of the embodiment of FIGS. 21A-B not discussed in further detail may be assumed to correspond to the features with equivalent reference numerals as discussed above, including any potential variations in the features.

In the alternative embodiment of FIGS. 21A-B, the optical system 250 further comprises: an input linear polariser 70 disposed between the transverse optical component 60 and the input end 2 of the extraction waveguide 1; and a polarisation conversion retarder 71 with orientation of optical axis 871 disposed between the the transverse optical component 60 and the input linear polariser 70, the polarisation conversion retarder 71 being arranged to convert a polarisation state of light passing therethrough between a linear polarisation state 934, 939 and a circular polarisation state 936, 938 respectively.

In other words, the input linear polariser 70 is disposed after the transverse anamorphic component 60, and the optical system 250 further comprises a polarisation conversion retarder 71 disposed between the transverse anamorphic component 60 and the input linear polariser 70, the polarisation conversion retarder 71 being arranged to convert a polarisation state of light passing therethrough between a linear polarisation state and a circular polarisation state.

The polarisation conversion retarder 71 has a retardance of a quarter wavelength at a wavelength of visible light, for example 550 nm and may be a Pancharatnam stack of retarders for example. The retardance of the polarisation conversion retarder 71 may be different to a quarter wavelength, but selected to provide the same effect. For example, the polarisation conversion retarder 71 may have a retardance of three quarter wavelengths or five quarter wavelengths, for example.

In operation, light ray 401 from the SLM 48 is output with unpolarised light state 930 and then polarised by input linear polariser 70 to provide linear polarisation state 902 in the extraction waveguide 1. Some light rays 435 as described elsewhere herein may return towards the input end 2 and are transmitted through the input linear polariser 70.

The light ray 435 which is returning in the second direction 193 along the extraction waveguide 1 towards the input end 2 may have been partially depolarised within the extraction waveguide 1 and has incident polarisation state 932 that can be considered a superposition of p-polarised and s-polarised polarisation states. Linear polarisation state 934 which is p-polarised is transmitted by the input linear polariser 70 while the orthogonal (s-polarised) polarisation state is absorbed. Light ray 435 with p-polarisation state 934 is converted to circular polarisation state 936 by the polarisation conversion retarder 71 and is incident on surfaces of transverse lens 61 and SLM 48. Fresnel reflections of rays 35F at said surfaces are reflected back towards the additional polarisation conversion retarder 71 with a π phase shift so that the orthogonal polarisation state 938 is reflected. Polarisation conversion retarder 71 provides s-polarised polarisation state 939 which is absorbed by the input linear polariser 70. Back reflections from the SLM 48 and transverse lens 61 are advantageously reduced. Additional polarisation conversion retarder 71 thus provides optical isolation of such returning light rays 435 such that light rays 35F that are reflected from surfaces of the transverse lens 61 back into the extraction waveguide 1 are reduced. Advantageously image contrast is increased.

Input linear polariser 70 and an additional polarisation conversion retarder 71 may be bonded to the input end 2. Advantageously improved reduction of reflections from the input end may be achieved.

FIG. 21C is a schematic diagram illustrating a side view of optical isolation for an ANEDD 100 comprising a transmissive or reflective SLM 48; and FIG. 21D is a schematic diagram illustrating optical axis alignment directions through the polarisation control components of FIG. 21C. Features of the embodiment of FIGS. 21C-D not discussed in further detail may be assumed to correspond to the features with equivalent reference numerals as discussed above, including any potential variations in the features.

In comparison to FIG. 21A, in the alternative embodiment of FIG. 21C the SLM 48 comprises an output linear polariser 70S and a further polarisation conversion retarder 71S with optical axis direction 871S. In operation, the input linear polariser 70 and polarisation conversion retarder 71 operate as for FIG. 21A. Output linear polariser 70S provides a linear polarisation state 941 that is transmitted through the further polarisation conversion retarder 71S to provide a circular polarisation state 943. Said polarisation state 943 is converted back to a linear polarisation state 902 by the polarisation conversion retarder 71 and transmitted through the input linear polariser 70. Advantageously brightness and contrast may be improved in SLMs 48 comprising a polarised output such as LCD and LCOS.

Further illustrative arrangements of the reflectors 117 will now be described. In the embodiments hereinbelow, most typically the reflectors 117 are illustrated as reflectors 117. However, other types of extraction features such as step facets 12, partially reflective stepped extraction reflectors 186, partially reflective surfaces 180, surface relief gratings 280 or volume diffractive optical elements 282 may additionally or alternatively be provided. Similarly, the PSR 700 may be provided as described elsewhere herein.

It would be desirable to increase the capture efficiency of light from SLMs 48 that emit unpolarised light.

FIG. 21E is a schematic diagram illustrating in side view a polarisation recirculation arrangement for light input into a waveguide 1; and FIG. 21F is a schematic diagram illustrating in side view operation of a polarisation recirculation arrangement for light input into the waveguide 1 from a SLM 48. Features of the embodiments of FIGS. 21E-F not discussed in further detail may be assumed to correspond to the features with equivalent reference numerals as discussed above, including any potential variations in the features.

Considering FIG. 21E for a single input ray 485 comprising unpolarised light that can be resolved into s-polarisation state 902 and p-polarisation state 904 input light through the input side 2. Light ray 485 is incident onto a PSR 486, such as PSRs 702, 712, 722, 723 described elsewhere hereinabove. The s-polarisation state 902 may be reflected by the PSR 486 as ray 487 and the p-polarisation state 904 transmitted as ray 489. The p-polarisation state 904 is converted to an s-polarisation state by a polarisation conversion retarder 488 that may for example be a half wave retarder and may be tuned for off-axis illumination. Light of the same polarisation state 902 is directed along the waveguide 1. In manufacture the waveguide 1 may comprise guiding members 111A, 111B that are bonded, with the PSR 486 and retarder 488 arranged therebetween. Advantageously increased efficiency may be achieved.

FIG. 21F illustrates the propagation of ray bundles from an unpolarised SLM 48 such as a micro-LED display. Advantageously the polarisation recirculation may be achieved for the transverse ray cone input into the waveguide 1. Display brightness may be increased or power consumption reduced.

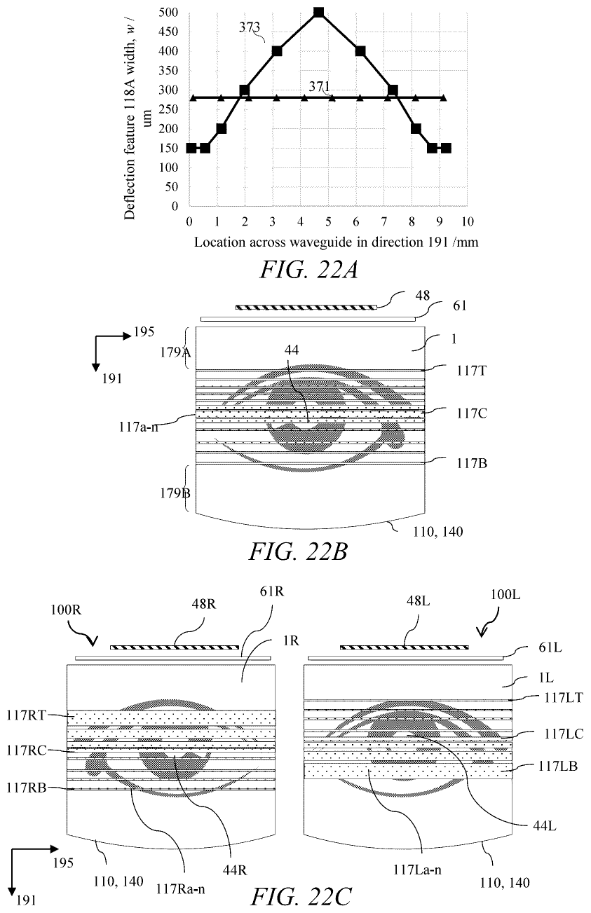

FIG. 22A is a schematic graph of the variation of facet width w with position along the extraction waveguide 1 for various illustrative arrangements of deflection features 118A; and FIG. 22B is a schematic diagram illustrating in rear view an arrangement of chirped reflectors 117 for a monocular ANEDD 100. Features of the embodiments of FIGS. 22A-B not discussed in further detail may be assumed to correspond to the features with equivalent reference numerals as discussed above, including any potential variations in the features.

The reflector 117 width, w provides a diffracting aperture for the light rays 401 directed towards the pupil 44 of the eye and so a diffractive blur is added to the image data in the transverse direction 197. It would be desirable to increase the extent w and thus reduce diffractive blur in the transverse direction, to minimise the blur ellipse height 454 in the transverse direction 197 of FIG. 1F.

In alternative embodiments wherein the reflectors 117 may have a varying pitch, s along the extraction waveguide 1 in the direction 191. Further, the reflectors 117 have a varying extent w along the extraction waveguide 1 in the direction 191. Thus considering the central reflector 117C, the extent w is 0.5 mm whereas the top reflector 117T has an extent of 0.15 mm. Diffractive blur is reduced for light from the centre of the extraction waveguide 1 which may be a preferred viewing location for the pupil 44. Thus high image quality may be achieved for the preferred viewing location, whereas off-axis imagery from the top and bottom reflectors 117T, 117B is somewhat degraded. The best image quality is provided in the preferred viewing direction, advantageously achieving high image performance for the most commonly used image data.

It would be desirable to further reduce the appearance of image blur due to diffraction in the lateral direction 197 from the extent w of the reflectors 117.

FIG. 22C is a schematic diagram illustrating in rear view an arrangement of chirped reflectors 117 for a binocular near-eye anamorphic display apparatus 1. Features of the embodiment of FIG. 22C not discussed in further detail may be assumed to correspond to the features with equivalent reference numerals as discussed above, including any potential variations in the features.

In the alternative embodiment of FIG. 22C the reflectors 117Ra-n for the pupil 44R of the right-eye 45R have a first profile of pitch s and extent w in the first direction 191 along the extraction waveguide 1. Further the reflectors 117La-n have a second profile of pitch s and extent w that is different to the first profile.

In the illustrative embodiment of FIG. 22C, the top reflector 117RT for directing light towards the right pupil 44R has a large pitch and thus low diffraction blur while the bottom reflector 117RB for directing light towards the right pupil 44R has a small pitch and thus increased diffraction blur. Further the top reflector 117LT for directing light towards the left pupil 44L has a small pitch and thus higher diffraction blur while the bottom reflector 117LB for directing light towards the left pupil 44L has a larger pitch and thus reduced diffraction blur. In operation, the human visual system may combine the two different blurs of the left-eye and right-eye images. Such combination may achieve perceived blur that is improved in comparison to arrangements in which the first and second profiles of pitch s and extent w are the same. Advantageously improved image quality may be perceived.

Headwear 600 comprising the ANEDD 100 will now be described.

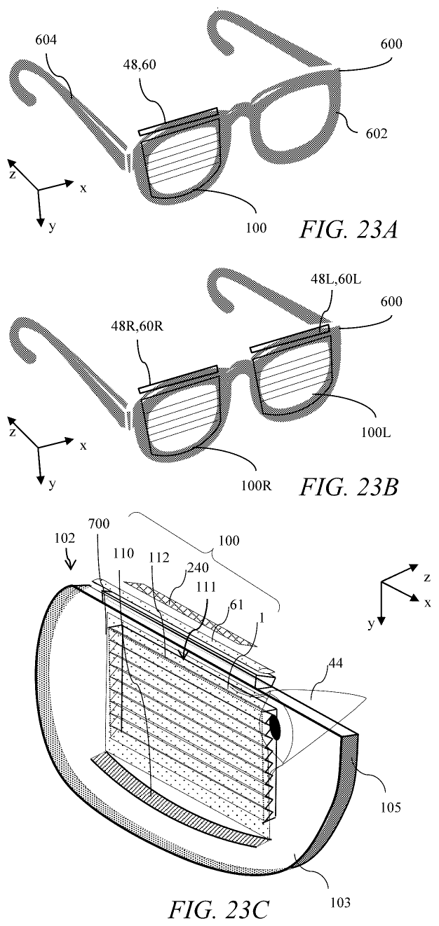

FIG. 23A is a schematic diagram illustrating in rear perspective view AR head-worn display apparatus 600 comprising a monocular anamorphic display apparatus arranged with SLM 48 and transverse anamorphic component 60 formed by the transverse lens 61 in brow position; and FIG. 23B is a schematic diagram illustrating in rear perspective view AR head-worn display apparatus 600 comprising binocular ANEDDs 100L, 100R arranged with SLMs 48R, 48L and transverse anamorphic components 60R, 60L in brow position. Features of the embodiments of FIGS. 23A-B not discussed in further detail may be assumed to correspond to the features with equivalent reference numerals as discussed above, including any potential variations in the features.

The head-worn display apparatus 600 of FIGS. 23A-B each comprise at least one ANEDD 100 and a head-mounting arrangement 602 arranged to mount the ANEDD 100 on a head of a wearer with the ANEDD 100 extending across at least one eye 45 of the wearer.

The head-worn display apparatus 600 may comprise a pair of spectacles comprising the ANEDD 100 described elsewhere herein that is arranged to extend across at least one eye 45 of a viewer 47 when the head-worn display apparatus 600 is worn. The head-worn display apparatus 600 may comprise a pair of spectacles comprising spectacle frames with the head-mounting arrangement 602 comprising rims 603 and arms 604. In general, any other head-mounting arrangement may alternatively be provided. The rims 602 and/or arms 604 may comprise electrical systems for at least power, sensing and control of the illumination system 240. The ANEDD 100 of the present embodiments may be provided with low weight and may be transparent. The head-worn display apparatus 600 may be tethered by wires to remote control system or may be untethered for wireless control. Advantageously comfortable viewing of AR, mixed reality or virtual reality (VR) content may be provided.

It may be desirable to provide improved aesthetic appearance of the ANEDD 100.

FIG. 23C is a schematic diagram illustrating in rear perspective view an eyepiece arrangement 102 for an AR head-worn display apparatus 600 comprising an embedded display apparatus 100. Features of the embodiment of FIG. 23C not discussed in further detail may be assumed to correspond to the features with equivalent reference numerals as discussed above, including any potential variations in the features.

The eyepiece arrangement 102 may be arranged within the head-worn display apparatus 600 and may comprise the ANEDD 100. The extraction waveguide 1 may be embedded with a substrate 103 that extends around the components 111, 110 of the ANEDD 100. The shape of the substrate 103 may be profiled to fit various shaped head-worn display apparatus, for example spectacles. Advantageously aesthetic appearance may be improved.

The edge 105 of the substrate 103 may be provided with a light absorbing surface that absorbs incident light from the ANEDD 100. The light absorbing surface may be a structured anti-reflection surface that is coated with an absorbing material. Advantageously image contrast is improved.

It may be desirable to change the illumination system 240 positioning in the head-worn display apparatus 600.

The eye-piece arrangement 102 comprising substrate 103 may further be provided for others of the embodiments of the present disclosure.

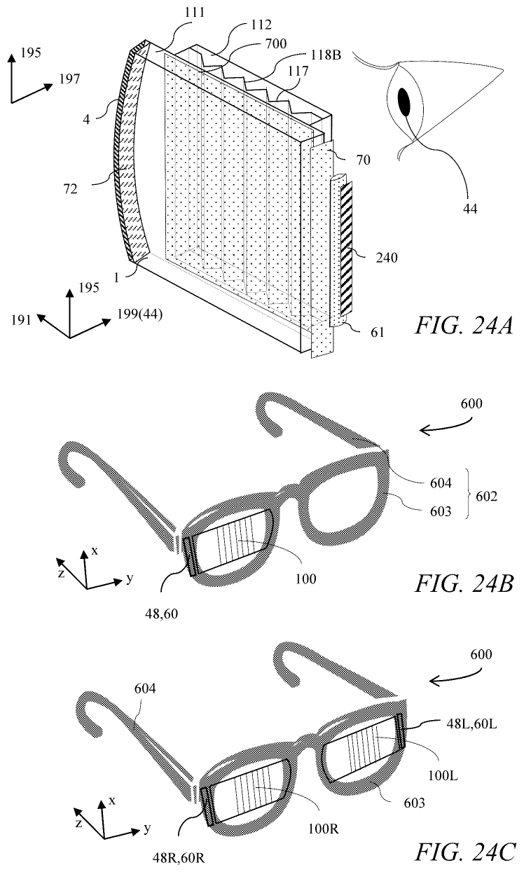

FIG. 24A is a schematic diagram illustrating in rear perspective view an ANEDD 100 with SLM 48 in temple location; FIG. 24B is a schematic diagram illustrating in rear perspective view AR head-worn display apparatus 600 comprising a left-eye anamorphic display apparatus arranged with SLM in temple position; and FIG. 24C is a schematic diagram illustrating in rear perspective view AR head-worn display apparatus 600 comprising left-eye and right-eye anamorphic display apparatuses arranged with SLM in temple position. Features of the embodiments of FIGS. 24A-C not discussed in further detail may be assumed to correspond to the features with equivalent reference numerals as discussed above, including any potential variations in the features.

In comparison to the arrangement of FIG. 1A, in the alternative embodiment of FIG. 24A, the illumination system 240 is arranged on the side of the extraction waveguide 1 and the direction 191 in which the extraction waveguide 1 extends in the horizontal direction for the eyes 45 of the user. Thus the lateral direction 195 for the pupil 44 is vertical and the transverse direction 197 is horizontal. The ANEDD 100 may be arranged within the arms of the headwear 600, reducing the bulk of the rims of the head-worn display apparatus. Advantageously the aesthetic appearance of the head-worn display apparatus may be improved. Further the connectivity between the illumination system 240 and control electronics arranged in the arms 604 may be provided with reduced complexity, reducing cost.

It would be desirable to provide a VR head-worn display apparatus 600 in which the head-worn display apparatus is not transparent to external images.

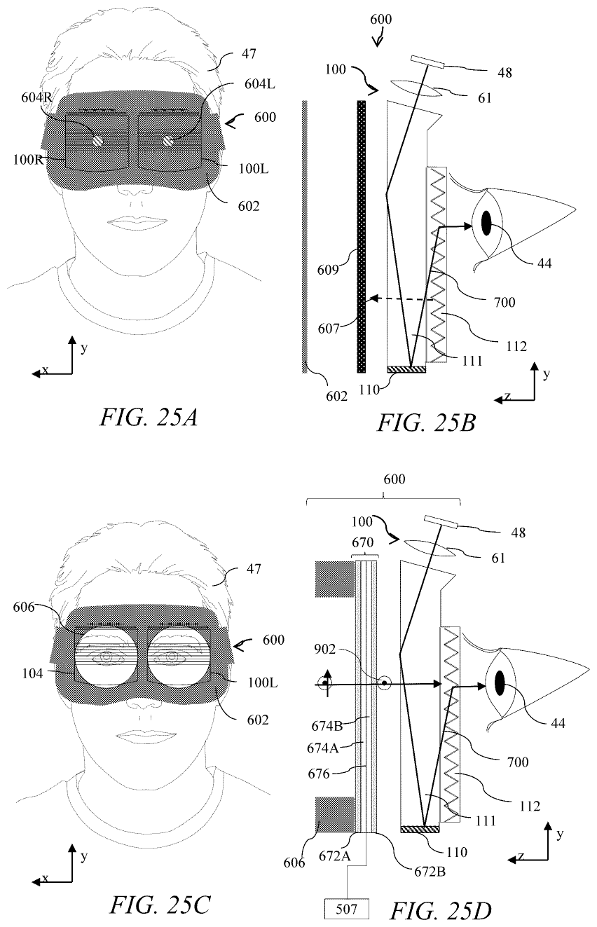

FIG. 25A is a schematic diagram illustrating in rear view VR head-worn display apparatus 600 comprising left-eye and right-eye ANEDDs 100R, 100L and head-mounting arrangement 602; and FIG. 25B is a schematic diagram illustrating in side view a VR head-worn display apparatus 600 comprising an ANEDD 100. Features of the embodiment of FIGS. 25A-B not discussed in further detail may be assumed to correspond to the features with equivalent reference numerals as discussed above, including any potential variations in the features.

The alternative embodiment of head-worn display apparatus 600 of FIG. 25A may comprise display apparatuses 100R, 100L that have larger size than desirable for spectacle head-worn display apparatus 600 of FIG. 23B. Referring to FIG. 1F aberrations may be reduced for a given field angle, field of view increased for a given ellipse blur 452 limit. Further image brightness may be increased.

FIG. 25B illustrates an alternative arrangement wherein a light trap layer 609 is provided between the head-worn display apparatus 600 head-mounting arrangement 602 and extraction waveguide 1 to receive stray light rays 607 output from the extraction waveguide 1. Advantageously image contrast is improved.

Cameras 604L, 604R may further be provided to record pass-through image data of the outside world as described further hereinabove, for example with respect to FIGS. 10G-H or FIG. 12.

It may be desirable to increase the visibility of pass-through images.

FIG. 25C is a schematic diagram illustrating in rear view an alternative VR head-worn display apparatus comprising left-eye and right-eye anamorphic display apparatuses; and FIG. 25D is a schematic diagram illustrating in side view the VR head-worn display apparatus of FIG. 25C. Features of the embodiment of FIGS. 25C-D not discussed in further detail may be assumed to correspond to the features with equivalent reference numerals as discussed above, including any potential variations in the features.

By way of comparison with the embodiment of FIGS. 25A-B, the alternative embodiment of FIGS. 25C-D comprises apertures 606 in the head-mounting arrangement arranged to transmit external light. A shutter 670 is provided that comprises polarisers 672A, 672B, transparent substrates 674A, 674B and a switchable liquid crystal layer 676 that is controlled by a controller 507. In a VR mode of operation the controller is switched to block the external light and advantageously image contrast is improved. In a pass-through mode of operation, the liquid crystal layer 767 is switched so that some light of the polarisation state 902 is transmitted through the waveguide 1 of the ANEDD 100. Advantageously improved pass-through operation is achieved in comparison to digitally generated images from the cameras 604L, 604R of FIG. 25A.

It may be desirable to reduce the number of illumination systems in a binocular near-eye display.

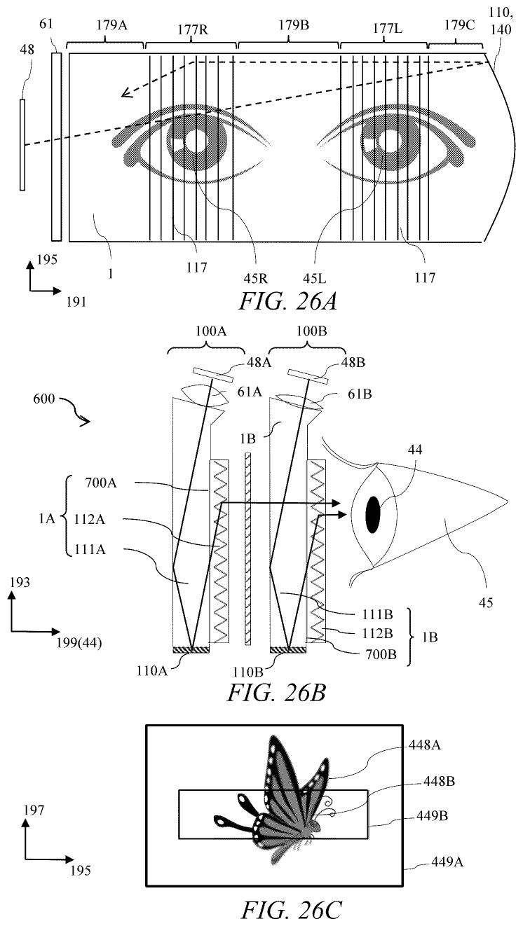

FIG. 26A is a schematic diagram illustrating in rear view an ANEDD 100 comprising a single waveguide 1 suitable for use by both eyes of a display user. Features of the embodiment of FIG. 26A not discussed in further detail may be assumed to correspond to the features with equivalent reference numerals as discussed above, including any potential variations in the features.

The array of reflectors 117 comprises two separated regions 177L, 177R, each region 177L, 177R being arranged to extract light guided along the extraction waveguide 1 towards a respective eye 45L, 45R of the viewer 47. Non-extracting regions 179A-C are arranged in the extraction waveguide 1 outside of the separated regions 177L, 177R.

Thus a single illumination system 240 comprising SLM 48 may be arranged to provide illumination to both eyes 45R, 45L. Advantageously cost and complexity is reduced.

It may be desirable to increase the performance and functionality of the head-worn display apparatus 600.

FIG. 26B is a schematic diagram illustrating in side view a head-worn display apparatus comprising two ANEDDs; and FIG. 26C is a schematic diagram illustrating a composite image provided by the head-worn display apparatus 600 of FIG. 26B to the eye 45. Features of the embodiments of FIGS. 26B-C not discussed in further detail may be assumed to correspond to the features with equivalent reference numerals as discussed above, including any potential variations in the features.

In the alternative embodiment of FIG. 26B, the ANEDD 100A is a first near-eye display apparatus and the head-worn display apparatus 600 further comprises a second ANEDD 100B, wherein the second ANEDD 100B is arranged in series with and to receive light from the first ANEDD 100A.

ANEDD 100A comprises SLM 48A with a first size and pixel 222 density; transverse anamorphic component 60A with a first transverse optical power; and extraction waveguide 1A comprising a lateral anamorphic component 110A with a first lateral optical power. ANEDD 100B comprises SLM 48B that may have size and pixel 222 density that is the same or different to the SLM 48A; transverse anamorphic component 60B with a second transverse optical power that may be the same or different to the first transverse optical power; and extraction waveguide 1A comprising a lateral anamorphic component 110A with a second lateral optical power that may be the same or different to the first lateral optical power.

The SLMs 48A, 48B, transverse anamorphic components 60A, 60B; lateral anamorphic components 110A, 110B and the reflectors 117 may be arranged to provide desirably increased optical performance including at least one of (i) increased image resolution; (ii) increased brightness; (iii) increased exit pupil 40 size; (iv) reduced image diffraction; (v) increased field of view; and (vi) multiple focal planes.

In the illustrative embodiment of FIG. 26B, the SLMs 48A, 48B are the same but the transverse anamorphic components 60A, 60B and lateral anamorphic components 110A, 110B are different so that the magnification provided by the respective ANEDDs 100A, 100B are different. FIG. 26C illustrates that an outer image region 448A with border 449A is provided by the ANEDD 100A and the central image region 448B with border 449B is provided by the ANEDD 100B. Advantageously a high resolution image may be provided in the central region 448A, overlaid on a lower resolution image in the outer region 448B. Such an arrangement may advantageously achieve increased image fidelity for the most common viewing directions while providing large field of view.

FIG. 26B also illustrates that the reflectors 117 may be provided with different alignments to achieve increased exit pupil 40 size and to reduce diffraction blur.

It may be desirable to increase the performance of VR display systems.

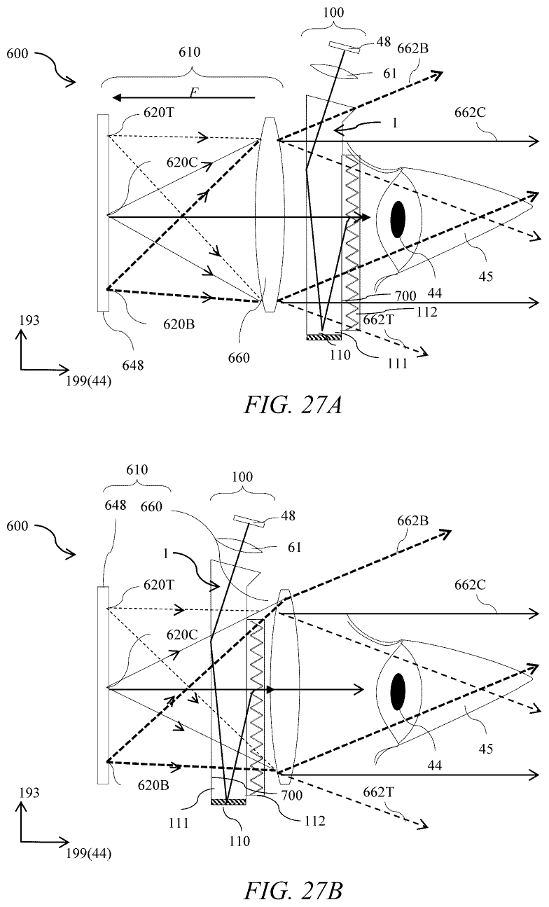

FIG. 27A is a schematic diagram illustrating in side view a VR head-worn display apparatus 600 comprising an ANEDD 100 arranged to receive light from a magnifying lens 610; and FIG. 27B is a schematic diagram illustrating in side view a VR head-worn display apparatus comprising an ANEDD arranged between the anamorphic SLM and magnifying lens of a non-ANEDD. Features of the embodiments of FIGS. 27A-B not discussed in further detail may be assumed to correspond to the features with equivalent reference numerals as discussed above, including any potential variations in the features.

In the alternative embodiment of FIG. 27A, head-worn display apparatus 600 further comprises a non-ANEDD 610, wherein the non-ANEDD 610 comprises a non-anamorphic SLM 648 and a non-anamorphic magnifying optical system such as lens 660; and wherein the at least one ANEDD 100 is arranged in series with and to receive light from the non-ANEDD 610.

FIG. 27A is an example of a head-worn display apparatus 600 comprising lens 660 having optical power, the ANEDD 100 overlying the lens 660. The lens 660 may comprise a refractive lens or may be catadioptric, for example a pancake lens.

In the alternative embodiment of FIG. 27B, the ANEDD 100 may be arranged in series with the non-anamorphic SLM 648, being arranged between the non-anamorphic SLM 648 and the non-ANEDD 610. The ANEDD may be arranged substantially at the pupil of the magnifying optical system 660 to provide no optical power to light from the non-ANEDD 610. Alternatively some small optical power for light from the ANEDD 100 may be provided modifying the virtual image distance. The total thickness of the optical system may be reduced, advantageously achieving reduced bulk.

In the embodiments of FIGS. 27A-B, the non-anamorphic magnifying optical system 660 may comprise a lens such as a Fresnel lens, a pancake lens or other known non-anamorphic magnifying lenses and is arranged to provide the eye 45 with a virtual image of the SLM 648. In comparison to the ANEDD 100, the non-ANEDD 610 provides magnification of pixels 622 on the non-anamorphic SLM 648 that is equal in the lateral and transverse directions 195, 197. The non-anamorphic magnifying optical system 660 is typically circularly symmetric.

In operation, top pixel 620T of the non-anamorphic SLM 648 provides light rays 662T, central pixel 620C provides light rays 662C and bottom pixel 620B provides light rays 662B. The eye of the viewer 45 collects the light rays 460T, 460C, 460B and produces an image on the retina of the eye such that an image is perceived with angular size that is magnified in comparison to the angular size of the SLM 48.

The SLMs 48, 648, non-anamorphic magnifying optical system 660, transverse anamorphic component 60; lateral anamorphic component 110 and the reflectors 117 may be arranged to provide desirably increased optical performance including at least one of (i) increased image resolution; (ii) increased brightness; (iii) increased exit pupil 40 size; (iv) reduced image diffraction; (v) increased field of view; and (vi) multiple focal planes.

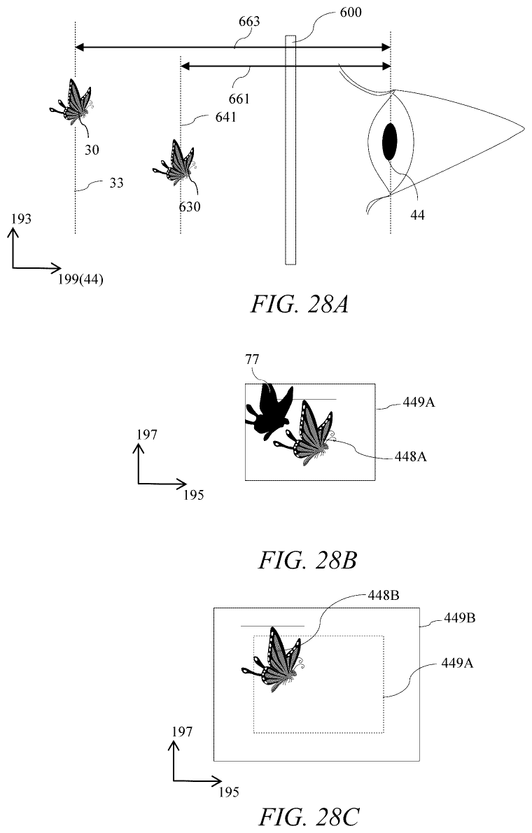

FIG. 28A is a schematic diagram illustrating in side view an arrangement of virtual image distances for a VR display apparatus. Features of the embodiment of FIG. 28A not discussed in further detail may be assumed to correspond to the features with equivalent reference numerals as discussed above, including any potential variations in the features.

Considering the embodiment of FIG. 27A, the virtual image distance 61 from the eye 44 to the virtual image 30 provided by the ANEDD 100 may be at an infinite conjugate image plane 41 distance 663, whereas by control of the back working distance, F of the SLM 648 to the non-anamorphic magnifying system 660 the virtual image 630 provided by the non-ANEDD 610 may be at a finite conjugate plane 641 distance 661.

More generally a virtual image distance for light from the first ANEDD 100A, may be different from a virtual image distance for light from the second ANEDD 100B or non-ANEDD 610 respectively.

Advantageously comfort of display use may be increased.

FIGS. 28B-C are schematic diagrams illustrating displayed virtual images for the arrangement of FIG. 28A. Features of the embodiments of FIGS. 28B-C not discussed in further detail may be assumed to correspond to the features with equivalent reference numerals as discussed above, including any potential variations in the features.

FIG. 28B illustrates the image 448A with border 449A provided by the ANEDD 100 whereas FIG. 28C illustrates the image 448B with border 449B provided by the non-ANEDD 610.

The background image 448A and foreground images 448B are provided so that the image 448A may further comprise an occlusion image 77 that is aligned in operation to the foreground images 448B that overlay the background image. Opaque foreground images may advantageously be achieved.

Alternative arrangements of lateral anamorphic component 110 comprising Pancharatnam-Berry lenses will now be described.

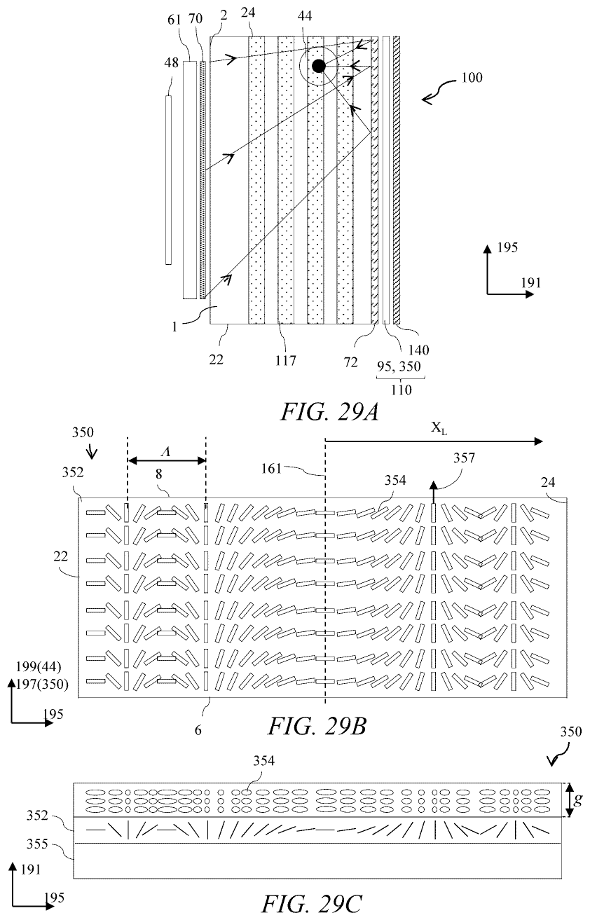

FIG. 29A is a schematic diagram illustrating in rear view an ANEDD 100 comprising a reflective end 4 comprising a Pancharatnam-Berry lens 350. Features of the embodiment of FIG. 29A not discussed in further detail may be assumed to correspond to the features with equivalent reference numerals as discussed above, including any potential variations in the features.

In the alternative embodiment of an ANEDD 100 of FIG. 29A, the lens 95 of the lateral anamorphic component 110 is a Pancharatnam-Berry lens 350 and the light reversing reflector 140 is a planar mirror. Thus the Pancharatnam-Berry lens 350 is arranged between the extraction waveguide 1 and reflective end 4.

In the alternative embodiment of FIG. 29A, the extraction waveguide 1 is illustrated with extraction reflectors 174 arranged between plural plates 180 although the other extraction reflectors described hereinbefore may be provided as alternatives.

In operation, the Pancharatnam-Berry lens 350 provides optical power in the lateral direction 195(350) and no optical power in the transverse direction 197(350). The Pancharatnam-Berry lens 350 thus provides a similar operation to the curved reflective end 4 and curved reflective ends 4 with lens 95 described hereinabove. In alternative embodiments, not shown, the reflective end 4 may comprise a curved mirror and the optical power of the lateral anamorphic component 110 may be shared between the Pancharatnam-Berry lens 350 and the curved reflective end 4. Advantageously aberrations may be improved.

FIG. 29B is a schematic diagram illustrating in end view the optical structure of a Pancharatnam-Berry lens 350; and FIG. 29C is a schematic diagram illustrating in rear view the optical structure of the Pancharatnam-Berry lens of FIG. 29B. Features of the embodiment of FIGS. 29B-C not discussed in further detail may be assumed to correspond to the features with equivalent reference numerals as discussed above, including any potential variations in the features.

The alternative embodiments of FIG. 29B and FIG. 29C illustrate a Pancharatnam-Berry lens 350 comprising liquid crystal molecules 354 arranged on alignment layer 352 and support substrate 355. The alignment layer 352 provides component 357 of the liquid crystal molecule 354 director direction (typically the direction of the extraordinary index) that varies across the Pancharatnam-Berry lens 350 in the lateral direction 195. In the transverse direction 197(350) there is no variation of the component 357 of the director direction and so no phase modulation is provided by the Pancharatnam-Berry lens 350.

During manufacture, the alignment layer 352 may be formed for example by exposure and curing of a photoalignment layer with circularly polarised light with the desirable phase profile to achieve a variation of the optical axis direction 357. More specifically, an interference pattern is created between two oppositely circularly polarized wavefronts that creates locally linear polarized light whose orientation varies in the plane of the alignment layer to provide the desired alignment profile by the alignment layer 352. The alignment layer is thus oriented with linear polarized light to provide an optical axis direction 357 in the layer of liquid crystal material 354 that provides desirable optical power profile.

The layer of liquid crystal material 354 may have a thickness g that has a half-wave thickness at a desirable wavelength of light, for example 550 nm. The liquid crystal material 354 may be a cured liquid crystal material such as a liquid crystal polymer or may be a nematic phase liquid crystal material arranged between opposing alignment layers.

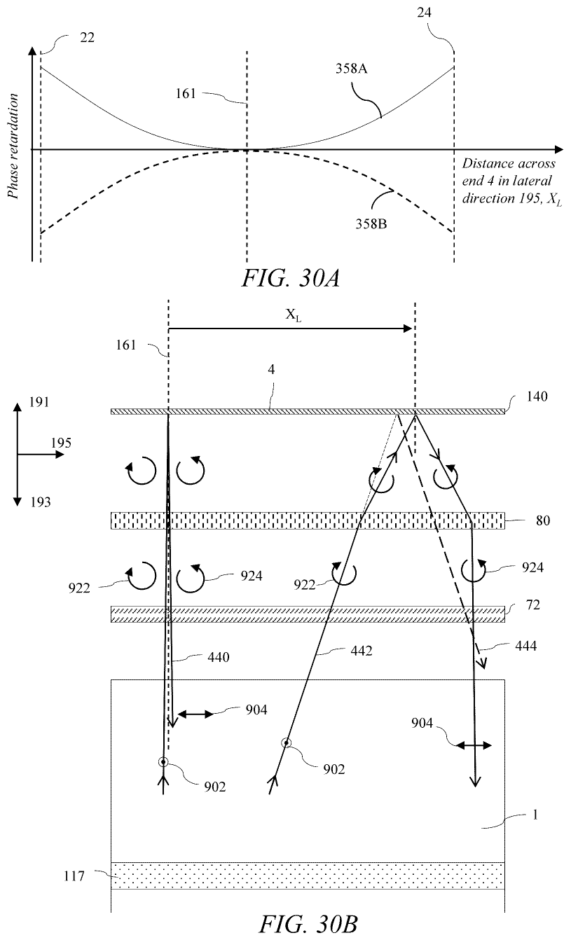

FIG. 30A is a schematic graph illustrating the variation of phase difference with lateral position for an illustrative Pancharatnam-Berry lens of FIG. 29B. FIG. 30A illustrates the profile 358A of phase retardation across the Pancharatnam-Berry lens 350 across the end 4 in the lateral direction 195 for a monochromatic circularly polarised planar wave incident onto the Pancharatnam-Berry lens 350. The pitch Λ of the profile of phase across the Pancharatnam-Berry lens 350 varies across the lateral direction 195 to achieve said profile 358A, with a large pitch at the location 161 which may be the centre of the Pancharatnam-Berry lens 350 and reducing pitch Λ either side. As illustrated in FIG. 29B, the liquid crystal material director rotates across the pitch Λ, which for the circularly polarised incident light provides the phase difference and hence deflection of the incident wavefront.

At one location 161 of the Pancharatnam-Berry lens 350 that is typically the centre of the end 4 of the extraction waveguide 1, the liquid crystal molecules 354 are aligned such that there is no relative phase difference. Profile 358A illustrates the phase modulation for a first circular polarisation state (which may be right-handed circular polarisation state) and profile 358B illustrates the phase modulation for a second circular polarisation state orthogonal to the first polarisation state (which may be left-handed circular polarisation state).

FIG. 30B illustrates in rear view the operation of a portion of a Pancharatnam-Berry lens 350 to provide the lateral anamorphic component 110 across the end 4 of the extraction waveguide 1 in the lateral direction 195. Features of the embodiment of FIG. 30B not discussed in further detail may be assumed to correspond to the features with equivalent reference numerals as discussed above, including any potential variations in the features.

The light rays 440, 442 incident onto the Pancharatnam-Berry lens 350 propagating along the direction 191 of the extraction waveguide 1 are polarised with the linear polarisation state 902.

For light ray 440 at the location 161, the incident polarisation state 902 is transmitted by the polarisation control retarder 72 with phase difference to provide circularly polarised state 922. The Pancharatnam-Berry lens 350 uses the polarisation control retarder 72 that is the same as the retarder used to optimise the transmission and reflectivity to polarised light of the dielectric layers of the reflectors 117, advantageously achieving improved efficiency.

The Pancharatnam-Berry lens 350 provides no relative phase modulation at the location 161, so that the reflection of light ray 440 from the light reversing reflector 140 provides the orthogonally circularly polarised state 924 that is transmitted as polarisation state 924 along the direction 193 back towards the extraction elements 116 that may be reflectors such as reflectors 117 as described hereinabove.

For light ray 442 at the location offset by distance XL in the lateral direction 195 from the location 161, the incident polarisation state 902 is again transmitted by the polarisation control retarder 72 with phase difference to provide circularly polarised state 922. The Pancharatnam-Berry lens 350 provides a gradient of phase difference so that the ray 442 representing a planar phase front is deflected in comparison to an illustrative undeflected ray 444. After reflection from the light reversing reflector 140, a further phase shift is provided by the Pancharatnam-Berry lens 350 so that the light ray 442 undergoes a further deflection. The reflected ray 442 propagating in the direction 193 along the extraction waveguide 1 is parallel to the returning ray 440. Thus the Pancharatnam-Berry lens 350, light reversing reflector 140 and polarisation control retarder 72, achieve the desirable optical function of the lateral anamorphic component 110.

Advantageously the physical size of the lateral anamorphic component 110 is reduced and a more compact arrangement achieved. The phase profile may further provide correction for aberrations of the lateral anamorphic component 110.

In other embodiments, plural Pancharatnam-Berry lenses 350 or Pancharatnam-Berry lenses 350 in combination with refractive lenses 95 and curved reflective end 4, for example as illustrated in FIG. 25A that may be separated in the direction 191 along the extraction waveguide 1 may be provided. Improved control of aberrations may be achieved and exit pupil 40 expanded in the lateral direction 195. Advantageously the blur ellipses 452 of FIG. 1F may have a reduced width 455.

Lenses for use with the ANEDD 100 will now be described.

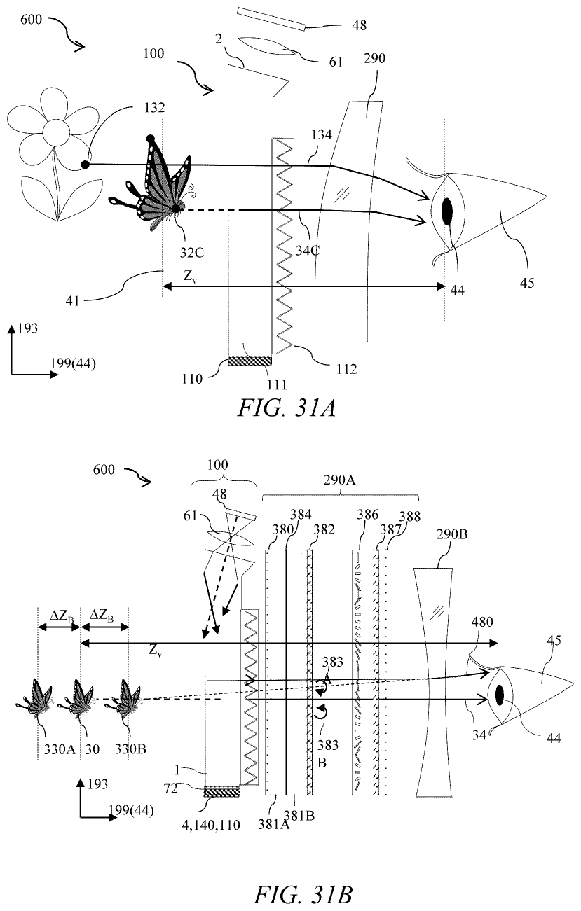

FIG. 31A is a schematic diagram illustrating in side view the operation of an ANEDD 100 further comprising a lens 290. Features of the embodiment of FIG. 31A not discussed in further detail may be assumed to correspond to the features with equivalent reference numerals as discussed above, including any potential variations in the features.

FIG. 31A and other embodiments disclosed herein are further examples of a head-worn display apparatus 600 comprising lens 660 having optical power, the ANEDD 100 overlying the lens 660.

The ANEDD 100 described hereinabove provides virtual images 36 that are located in the far field, so that the nominal viewing distance Zᵥ is infinite. It may be desirable to provide modification of the distance Zᵥ to the virtual image plane 41 of the virtual image 36 provided by the ANEDD 100.

The head-worn display apparatus 600 further comprises at least one lens 290 that may be a corrective lens having optical power for correcting eyesight. The correction of eyesight may be for example to correct for presbyopia, astigmatism, myopia or hyperopia of the display user 45.

The lens 290 may further or alternatively be a focal plane modifying lens for providing the virtual image plane 41 such that the distance Zᵥ is a finite distance. Such an arrangement may provide suitable accommodation cues for the display user 47 such that virtual images that are desirably close to the user 47 are provided at desirable accommodation distances. In stereoscopic display applications, the accommodation correction of the lens 290 may be arranged to approximate the convergence distance of the imagery. Accommodation-convergence mismatch may be reduced and advantageously visual stress reduced, increasing comfort of use.

Such lenses 290 may be used for example in the spectacles head-worn display apparatus 600 of FIGS. 23A-B or the VR head-worn display apparatus 600 of FIG. 25A.

It may be desirable to adjust the accommodation distance Zᵥ of the virtual image.

FIG. 31B is a schematic diagram illustrating in side view the operation of an ANEDD 100 further comprising a Pancharatnam-Berry lens 386. Features of the embodiment of FIG. 31B not discussed in further detail may be assumed to correspond to the features with equivalent reference numerals as discussed above, including any potential variations in the features.

In the alternative embodiment of FIG. 31B, the ANEDD 100 is arranged to direct output light rays 401 into lens 290 that comprises a switchable optical stack.

Switchable optical stack comprises input polariser 380, transparent substrates 381A, 381B with an electrically switchable liquid crystal layer 384 provided therebetween and a quarter-wave retarder 382. In a first state, the liquid crystal layer 384 is arranged to provide no polarisation rotation of the polarised light from the polariser 380 and the switchable optical stack provides a first circularly polarised output polarisation state 383A. In a second state, the liquid crystal layer 384 is arranged to provide a polarisation rotation of the polarised light from the polariser 380 and the switchable optical stack provides a second circularly polarised output polarisation state 383B, orthogonal to the polarisation state 383A.

The Pancharatnam-Berry lens 386 comprises a circularly symmetric alignment of liquid crystal molecules with similar but different alignment across each radius of the circularly symmetric alignment to that illustrated across the lateral direction 195 in FIG. 30AA hereinabove. The Pancharatnam-Berry lens 386 thus provides a circularly symmetric first phase radial profile similar to profile 358A of FIG. 30AB for the light with polarisation state 383A and a circularly symmetric second phase radial profile similar to profile 358B of FIG. 30AB for the light with polarisation state 383B. The output polarisation state from the Pancharatnam-Berry lens 386 is analysed by quarter-wave retarder 387 and linear polariser 388.

Output light from the lens 290A with positive or negative power modification of the wavefront from the ANEDD 100 is then incident onto the fixed lens 290B so that the eye 45 observes one of the two power corrections.

Considering the virtual image 30, in the absence of the lens 290A would provide a virtual image at distance Zv. In the first state of the liquid crystal layer 384, the virtual image 330A is provided with a separation ΔZ_{A} from the distance Zv; and in the second state of the liquid crystal layer 384, the virtual image 330B is provided with a separation ΔZ_{B} from the distance Zv.

In alternative embodiments, the lens 290B may be provided by a Pancharatnam-Berry lens. Advantageously thickness may be reduced.

The lenses 290A, 290B thus achieve adjustable accommodation distances for virtual images 330A, 330B. Stacks of lenses 290A with for example a geometric sequence of optical power adjustments may be provided to achieve increased fidelity in location of the virtual image 330. Accommodation conflicts with the provided imagery may advantageously be reduced and image comfort increased. Comfortable usage time for the head-worn display apparatus 600 may be extended.

It may be desirable to provide a virtual image 30 that does not have an infinite conjugate while not modifying the object 130 magnification or distance Z_{R}.

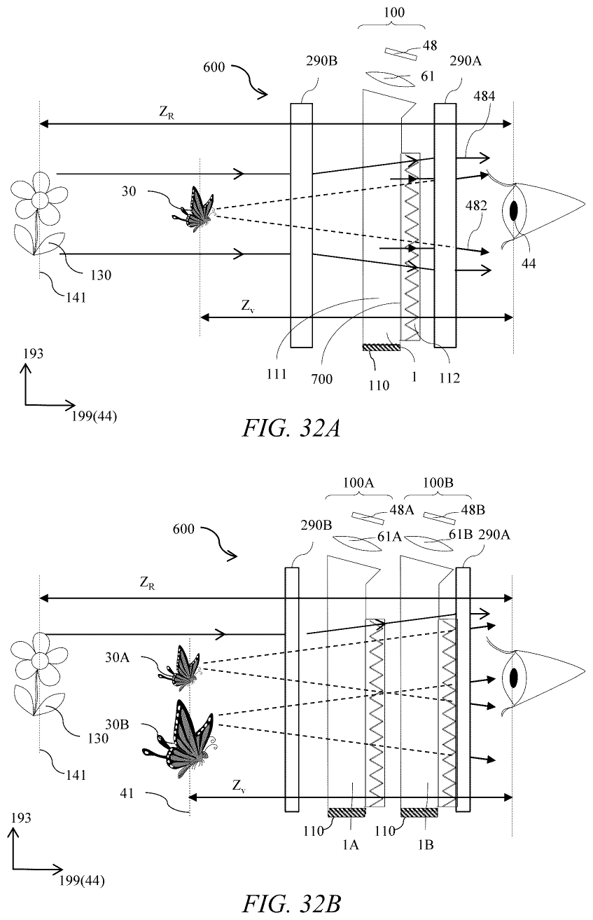

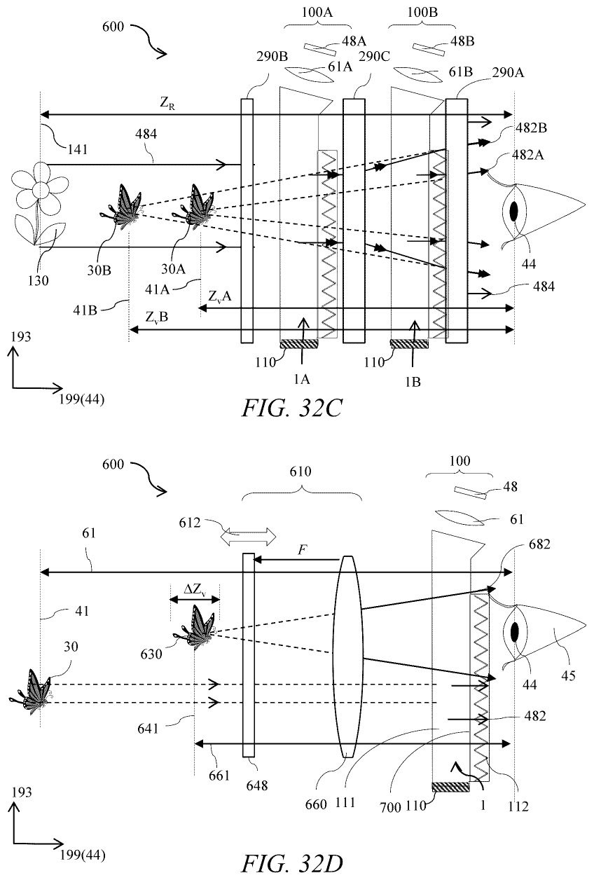

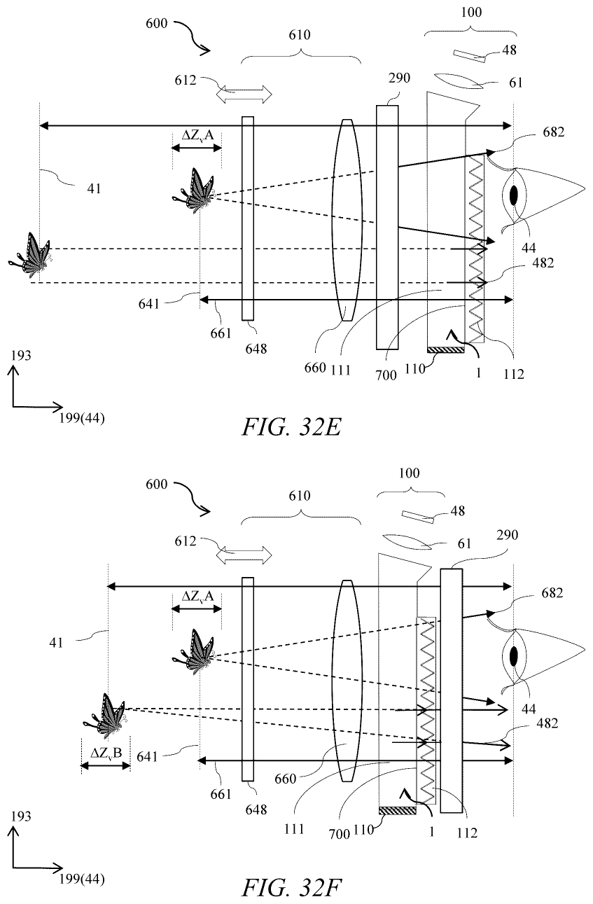

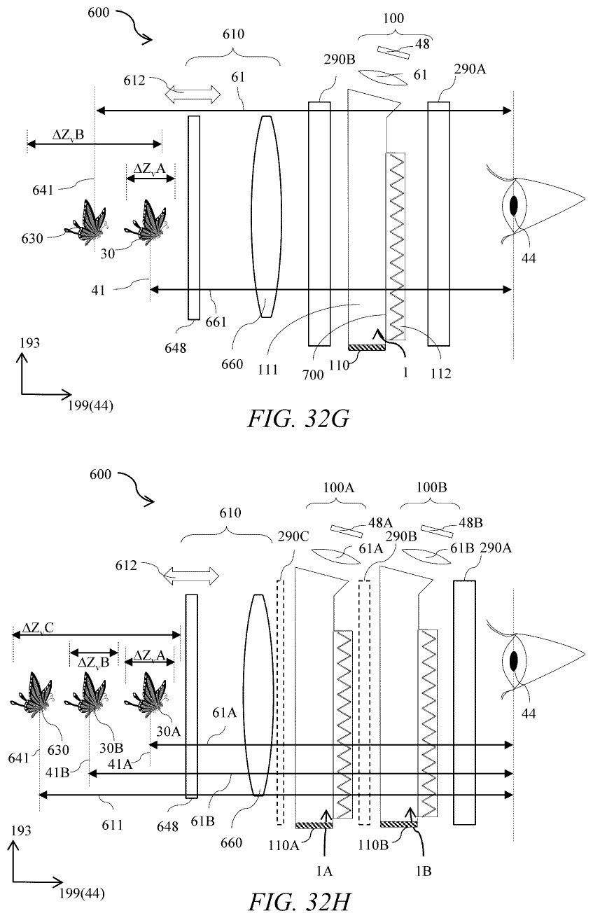

FIG. 32A is a schematic diagram illustrating in side view a head-worn display apparatus 600 comprising first and second focal plane modifying lenses 290A, 290B. Features of the embodiment of FIG. 32A not discussed in further detail may be assumed to correspond to the features with equivalent reference numerals as discussed above, including any potential variations in the features.

In the alternative embodiment of FIG. 32A, ANEDD 100 is arranged between the focal plane modifying lenses 290A, 290B. The lens 290A is a focal plane modifying lens that is arranged to modify the distance Zᵥ to the virtual image 30 by deflection of light rays 482 from the ANEDD 100.

The lens 290B is a correction lens arranged to correct for the optical power of the lens 290A, so that light rays 484 from object 130 are undeflected by the head-worn display apparatus 600. Advantageously virtual images 30 may be provided near to the eye, for example to provide a user interface and overlayed with real-world images, advantageously reducing the degradation of the real-world objects 130.

The lenses 290A, 290B may be Pancharatnam-Berry lenses as described hereinabove, so that the distance Zv may be modified in correspondence to desired image data. The lenses 290A, 290B may have the same optical design and the lens 290B may be driven in the opposite output to the lens 290A to achieve resultant zero power of lenses 290A, 290B. Advantageously cost and complexity may be reduced.

FIG. 32B is a schematic diagram illustrating in side view a head-worn display apparatus 600 comprising plural extraction waveguides and further comprising first and second focal plane modifying lenses. Features of the embodiment of FIG. 32B not discussed in further detail may be assumed to correspond to the features with equivalent reference numerals as discussed above, including any potential variations in the features.

In the alternative embodiment of FIG. 32B, two ANEDDs 100A, 100B are provided to achieve multiple virtual images 30A, 30B. The performance of the head-worn display apparatus may be increased, for example as described with respect to FIG. 26B hereinabove. Further, focal plane modifying lenses 290A, 290B are provided with operation as described in FIG. 32A. Advantageously real-world objects 130 may be provided with reduced degradation.

It may be desirable to provide virtual images 30A, 30B with different focal distances ZᵥA, ZᵥB.

FIG. 32C is a schematic diagram illustrating in side view a head-worn display apparatus 600 comprising plural extraction waveguides and three focal plane modifying lenses 290A, 290B, 290C. Features of the embodiment of FIG. 32C not discussed in further detail may be assumed to correspond to the features with equivalent reference numerals as discussed above, including any potential variations in the features.

In comparison to the embodiment of FIG. 32B, in the alternative embodiment of FIG. 32C a further focal plane modifying lens 290C is provided to receive light from the ANEDD 100A and to pass light to the further ANEDD 100B. The virtual image distance ZᵥA for light from one of the ANEDDs 100A is different to the virtual image distance ZᵥB for light from at least one other ANEDD 100B. The multiple image planes 41A, 41B may advantageously achieve increased image comfort.

The lens 290C cooperates with the lens 290A to provide the second virtual image 34B, and the lens 290B cooperates with the lenses 290A, 290C to provide zero total optical power. In an alternative embodiment (not shown) the lens 290B may be omitted, for example for VR applications. Advantageously cost and complexity may be reduced.

It may be desirable to increase the performance of a VR head-worn display apparatus by providing increased control of focal planes 41, 641.

FIG. 32D is a schematic diagram illustrating in side view a head-worn display apparatus 600 comprising a non-ANEDD 610 and an ANEDD 100. Features of the embodiment of FIG. 32D not discussed in further detail may be assumed to correspond to the features with equivalent reference numerals as discussed above, including any potential variations in the features.

In comparison to the embodiment of FIG. 27A, in the alternative embodiment of FIG. 32D, the non-ANEDD 610 comprises an actuator 612 arranged to move the further SLM 648 in relation to the non-anamorphic magnifying optical system 660, adjusting the magnification of the non-ANEDD 610. The virtual image distance 663 for light from the ANEDD 100 provided by rays 482 is different to the virtual image distance 661 for light from the non-ANEDD 610 provided by rays 482. The distance F may be adjusted in correspondence to desired image data that may be in response to measured viewing direction of the eye 45. Advantageously user comfort may be increased.

FIG. 32E is a schematic diagram illustrating in side view a head-worn display apparatus 600 comprising a non-ANEDD 610; an ANEDD 100; and a focal plane modifying lens 290. Features of the embodiment of FIG. 32E not discussed in further detail may be assumed to correspond to the features with equivalent reference numerals as discussed above, including any potential variations in the features.

In the alternative embodiment of FIG. 32E, an additional focal plane modifying lens 290 is provided between the non-ANEDD 610 and the ANEDD 100. The lens 290 may comprise a controllable Pancharatnam-Berry lens. The actuator 612 may optionally be omitted. The range of focal distances ΔZᵥA may be increased and the speed of control may be increased. User comfort may advantageously be increased.

FIG. 32F is a schematic diagram illustrating in side view a head-worn display apparatus comprising a non-ANEDD 610; an ANEDD 100; and a focal plane modifying lens 290 arranged to receive light from the non-ANEDD and the ANEDD. Features of the embodiment of FIG. 32F not discussed in further detail may be assumed to correspond to the features with equivalent reference numerals as discussed above, including any potential variations in the features.

In the alternative embodiment of FIG. 32F, the focal plane modifying lens 290 is arranged to provide finite virtual image distances 41, 641. Further, the focal plane modifying lens 290 may be controllable to achieve variable focal plane distances ΔZᵥA, ΔZᵥB from the displays 610, 100 respectively. User comfort may advantageously be increased.

FIG. 32G is a schematic diagram illustrating in side view a head-worn display apparatus 600 comprising a non-ANEDD 610; an ANEDD 100; and two focal plane modifying lenses 290A, 290B. Features of the embodiment of FIG. 32G not discussed in further detail may be assumed to correspond to the features with equivalent reference numerals as discussed above, including any potential variations in the features.

In comparison to the embodiments of FIGS. 32E-32F, in the alternative embodiment of FIG. 32G, focal plane modifying lenses 290A, 290B are arranged with the ANEDD 100 provided therebetween. Focal plane control of both virtual images 41, 641 may be provided. Advantageously user comfort may be further increased.

FIG. 32H is a schematic diagram illustrating in side view a head-worn display apparatus 600 comprising a non-ANEDD 610; two anamorphic extraction waveguides 1100A, 100B; and focal plane modifying lenses 290A, 290B, 290C. Features of the embodiment of FIG. 32H not discussed in further detail may be assumed to correspond to the features with equivalent reference numerals as discussed above, including any potential variations in the features.

In the alternative embodiment of FIG. 32H, multiple images 30A, 30B, 630 may be provided with multiple focal ranges ΔZᵥA, ΔZᵥB, ΔZᵥC that may overlap. Control of virtual image planes 41A, 41B, 641 may be provided. Advantageously user comfort may be further increased.

It would be desirable to provide a finite viewing distance for perceived virtual images.

FIG. 33A is a schematic diagram illustrating a rear perspective view of an ANEDD 100 arranged to provide visibility of an external real object 130 and to provide a virtual image 30 at a finite viewing distance Z wherein an optical waveguide 1 comprises light deflection features 118A that are deflection features 118A that extend through the optical waveguide 1. Features of the embodiment of FIG. 33A not discussed in further detail may be assumed to correspond to the features with equivalent reference numerals as discussed above, including any potential variations in the features.

As discussed hereinabove the spatially separated pixels 222 on the SLM 48 are directed to the pupil 44 of the eye 45 as angularly separated pixel light cones. The lens of the eye 45 of the viewer 47 relays the angular pixel light cones, illustrated by rays 34 to retinal image 36 with spatially separated pixels at the retina 46 of the eye 45. For example virtual image point 32C is directed to retinal image 36 point 35C and virtual image point 32U is directed to retinal image 36 point 35U.

By way of comparison with FIG. 1A, in the alternative embodiment of FIG. 33A, the ANEDD 100 is configured such that the output light 34 from each point 230 of the spatial light modulator 48 has vergence 38(197) in the transverse direction 197 and, when the output light 34 is viewed by an eye 45 of a viewer 47, the vergence 38 allows the eye 45 of the viewer 47 to focus the output light 34 from a finite viewing distance ZV₁₉₇ in the transverse direction 197. In the embodiment of FIG. 33A, the vergence 38 is divergence.

In the embodiment of FIG. 1A, a well-corrected eye 45 provides focussing onto the retina 46 when focussing for an infinite conjugate distance ZV, that is input rays 34C from point 230C are substantially parallel at the pupil 44 from across the waveguide 1 and directed towards retinal point 35C. Similarly the eye 45 of the viewer 47 may receive light from an external real object 130 with rays 134 that are substantially parallel so that image 136 is also focussed at the retina 46.

To increase image realism, it may be desirable to provide focussing of the eye 45 so that the virtual image 30 appears to be in a different image plane 41 to the image plane 141 for the real world object 130. By way of comparison with FIG. 1A, the alternative embodiment of FIG. 33A illustrates that virtual image plane 41 may have a finite conjugate distance that is different to the object plane 141 (that may for example have an infinite conjugate distance ZR). Such finite distance ZV may be provided by modification of the deflection arrangement 112 and/or the lateral anamorphic component 110 as will be described hereinbelow.

Retinal image 36 formation will now be further described.

FIG. 33B is a schematic diagram illustrating a rear perspective view of virtual image 36 formation from the ANEDD 100 of FIG. 33A; and FIG. 33C is a schematic diagram illustrating a rear perspective view of real image 136 formation through the ANEDD 100 of FIG. 33A. Features of the embodiments of FIGS. 33B-C not discussed in further detail may be assumed to correspond to the features with equivalent reference numerals as discussed above, including any potential variations in the features.

FIGS. 33A-B further illustrate the virtual image 30 comprising a central virtual image point 32C provided by the imaging of a point 230C of a pixel 222C of the SLM 48, and an upper virtual image point 32U provided by the imaging of a point 230U of a pixel 222U of the SLM 48. In the present embodiments, the pixel 222 and optical system 250 provide output light that has an angular cone of size ϕ corresponding to the angular light cone from across a pixel 222. By comparison, the vergence 38 of the present embodiments is an angular cone of finite size that is provided for each point 230 on the spatial light modulator 48.

The deflection arrangement 112 is configured to output light from a point 230 that has divergence 38(197) in the transverse direction 197 such that, when the output light from the point 230 is viewed by the eye 45 of a viewer 47, the divergence 38 of the output light allows the eye 45 of a viewer 47 to focus the output light from a finite viewing distance ZV₁₉₇ in the transverse direction 197. The point 230 may be imaged as a virtual image point 32 that is provided at a virtual image plane 41.

The ANEDD 100 is further configured to output light from a point 230 that has divergence 38(195) in the lateral direction 195 such that, when the output light from the point 230 is viewed by the eye 45 of a viewer 47, the divergence 38(195) of the output light allows the eye 45 of the viewer 47 to focus the output light from a finite viewing distance ZV₁₉₅ in the lateral direction 195. The lateral anamorphic component 110 and the deflection arrangement 112 are configured such that the output light 34 from each point 230 of the spatial light modulator 48 has vergence 38(195) in the lateral direction 195 so that, when the output light 34 is viewed by an eye 45 of a viewer 47, the vergence 38(195) of the output light 34 allows the eye 45 of the viewer 47 to focus the output light 34 from a finite viewing distance ZV₅₁₉ in the lateral direction 195.

In order to focus on the virtual image 30 that appears to be at a finite viewing distance ZV, the human visual system (HVS) adopts a focal condition such that an image 36 with central and upper image points 35C, 35U is provided at the retina 46. The focal condition may be achieved for example by adjustment of the lens of the eye 45.

Output light rays 34C and corresponding virtual light rays 37C; and output light rays 34U with corresponding virtual light rays 37U are provided in ray bundles with divergence 38 wherein the divergence 38 represents a solid angle and may be measured as the steradians subtended for a 1 mm pupil diameter. Within the eye 45, said light rays 34C, 34U are focused to provide image points 35C, 35U. In an illustrative embodiment, the distance ZV may be 2 metres so the divergence 38 has a solid angle of 0.2 microsteradians for the 1 mm pupil diameter.

The present embodiments achieve the divergence of rays 34C, 34U from common virtual image points 32C, 32U such that a finite virtual image distance ZV for virtual images 30 may be provided by the ANEDD 100. The divergence 38 may comprise the lateral divergence 38(195) and the transverse divergence 38(197) may alternatively be measured in degrees across a 1 mm diameter pupil. In the illustrative example, the lateral and transverse divergences 38(195), 38(197) are each desirably 0.029°.

The deflection features 118A have tilts r such that the light 34 from each point 230 of the spatial light modulator 48 has the vergence in the transverse direction 197. As will be further described with reference to FIG. 33D hereinbelow for example, the deflection features 118A have tilts r that vary along the extraction waveguide 1 in the first direction 191 such that for at least one pixel 222 the output light 34 is light from a point 230 that has divergence 38(197) in the transverse direction 197.

As will be described with reference to FIG. 33F hereinbelow for example, the deflection features 118A and/or the lateral anamorphic component 110 are arranged to provide divergence 38(195) in the lateral direction 195. Said transverse divergence 38(197) and lateral divergence 38(195) provide divergence 38 from the point 230C that provides the virtual image point 32C. The visual system of the viewer 47 then provides the perception of the virtual image point 32C at a finite viewing distance ZV₁₉₇ in the transverse direction 197 and finite viewing distance ZV₁₉₅ in the lateral direction 195.

Desirably the divergences 38(195), 38(197) and respective viewing distance ZV₁₉₇, ZV₁₉₅ are the same or similar for a well-corrected eye 45 but may be different for example to provide visual correction as described further hereinbelow.

As illustrated in FIG. 33C, for the real object 130, the divergence 138 of the light rays 134 (for example with zero divergence) is different to the divergence 38 from the point 230 and corresponding virtual image point 32, and the location of the image 136 within the eye 45 is different to the location of the image 36. In a first focal condition the eye 45 may be accommodated so that the image 36 is at the retina 46, while in a second focal condition, the eye 45 may be accommodated so that the image 136 is at the retina. In this manner, the accommodation of the eye may vary between viewing real object 130 and the virtual image 30. Such adjustment of accommodation may advantageously achieve improved comfort of image viewing for nearby virtual images.

Thus in the focal condition of the eye 45 of FIGS. 33B-C, the eye 45 provides virtual image 36 at the retina 46 and the image 136 of the object 130 is imaged within the eye 45 and is out of focus on the retina to provide a blur region 133 at the retina 46.

In a different focal condition (not shown) of the eye 45, the image 136 may be focused onto the retina 46, and the image 36 is provided as an out-of-focus image at the retina 46 with blur 33. In a further different focal condition that the object 130 is provided at the distance ZV then both images 36, 136 are provided in focus at the retina 46 for the appropriate focal condition of the eye 45.

An arrangement of the deflection features 118A to achieve divergence 38(197) will now be described.

FIG. 33D is a schematic diagram illustrating a side view of light output from the ANEDD 100 of FIG. 1B to provide a virtual image 30 at a finite viewing distance ZV₁₉₇ in the transverse direction 197. Features of the embodiment of FIG. 33D not discussed in further detail may be assumed to correspond to the features with equivalent reference numerals as discussed above, including any potential variations in the features.

By way of comparison with FIG. 33A, the alternative embodiment of FIG. 33D illustrates deflection features 118A that are deflection features 118AA-118AF wherein each deflection features 118A is linear in the transverse direction 197.

Light rays 434CR are incident onto the deflection features 118A and output through the front guide surface as light rays 34C. Illustrative light rays 34C include 34C-AA and 34C-AB output from different parts of the deflection feature 118AA; light rays 34C-BA and 34C-BB from deflection feature 118AB; light rays 34C-EA, 34C-EB from deflection feature 118AE; and light ray 34C-G from deflection feature 118AG.

Divergence 38(197) is provided by the difference in the tilt τ between the deflection features 118AD, 118AE, for example the deflection features 118AG has a tilt τ_{G}(X_{G}, Y_{G}) that may vary across the waveguide 1 and is different to the tilt τ_{F}(X_{F}, Y_{F}), τ_{H}(X_{H}, Y_{H}) of adjacent deflection features 118AF, 118AH respectively.

Illustrative light rays 34C-DA, 34C-DB, 34C-E and 34U-E are transmitted through the pupil 44 onto the retina 46 to provide respective retinal points 35(197)C-DA, 35(197)C-DB, 35(197)C-E and 35(197)U-E that the eye 45 and HVS determine as from virtual image 30 with respective virtual points 32C and 32U.

Light rays 34C-DA and 34C-DB are provided by reflection of rays 434CR from the same linear deflection feature 118AD and thus are parallel. Respective retinal points 35(197)C-DA, 35(197)C-DB at the retina 46 provide an image blur 33(197) across the transverse direction 197. Such blur 33(197) provides perceived blur 31(197) of the virtual image point 32C across the transverse direction 197.

It would be desirable to reduce the blur 31(197) of the virtual points 32.

FIG. 33E is a schematic diagram illustrating a side view of light output from the ANEDD 100 of FIG. 33D to provide a virtual image 30 at a finite viewing distance ZV₁₉₇ in the transverse direction 197 with reduced blur 31(197) in comparison to the arrangement of FIG. 33D. Features of the embodiment of FIG. 33E not discussed in further detail may be assumed to correspond to the features with equivalent reference numerals as discussed above, including any potential variations in the features.

By way of comparison with FIG. 33D, the alternative embodiment of FIG. 33E illustrates that the deflection features 118AA-AH are curved with a curvature p as will be described further in FIG. 3B hereinbelow. Such curvature p provides a variation in the deflection angle across each of the deflection features 118A of the guided rays 434CR to provide output rays 34C that have a divergence 38(197). In operation, points 35(197)C-EA, 35(197)C-EB and 35(197)C-F may be provided (in the appropriate focal condition of the eye 45) at the same location on the retina 46 and blur 33(197) reduced, achieving improved visibility of virtual image point 32C with reduced blur 31(197).

FIG. 33E further illustrates that the virtual image plane 41(197) may be curved. Such curvature may arise from aberrations of the deflection features 118A for example.

In alternative embodiments (not illustrated) some of the deflection features 118AA-AH may be curved and some may be linear. Advantageously reduced blur may be provided in some regions of the exit pupil 40 and other regions blur 33(197) may be increased but the fabrication cost and complexity of the extraction waveguide 1 may be reduced.

By way of comparison with FIG. 33D, the alternative embodiment of FIG. 33E further illustrates that the deflection features 118A comprise deflection features 118AA-AG that extend across part of the extraction waveguide 1 between the front guide surfaces 8 and the PSR 700. Deflection features 118A have radius of curvature ρ, conic constant K and height h from the front guide surface 8 at the distance Y_{D} from the centre of the lateral anamorphic component 110. The variation of height h may provide increased transmitted light in the direction 193 along the waveguide 1 and advantageously achieve improved uniformity across the exit pupil 40.

An alternative illustrative embodiment of extraction waveguide 1 is provided in TABLE 4.

TABLE 4

| Item | Property |
|---|---|
| Waveguide 1 refractive index | 1.49 |
| Input side 2 inclination, δ | 60° |
| Waveguide 1 thickness, τ | 3.00 mm |
| SLM48 height w₁₉₇ in transverse direction 197 | 3.4 mm |
| SLM48 width w₁₉₅ in lateral direction 195 | 45 mm |
| Lens 61 focal length in transverse direction 197 | 8.60 mm |
| Lateral mirror focal length in lateral direction 140, 110 | 35.02 mm |

TABLE 5 illustrates an embodiment of deflection features wherein the virtual image point 32 is provided at infinity, for example as illustrated in FIG. 1A.

TABLE 5

| | | Lateral | | | |
|---|---|---|---|---|---|
| | Lateral | conic | Transverse | | |
| | radius | constant | radius | Height | Tilt |
| Item | ρ₁₉₅/mm | k₁₉₅/mm | Q₁₉₇/mm | h₁₉₇/mm | τ₁₉₇/deg |
| Deflection feature | 0 | 0 | 0 | 1.40 | −30.00 |
| 174A-H | | | | | |
| Lateral light | 105 | 0.58 | 0 | 3.0 | 0 |
| reversing reflector | | | | | |
| 140, 110 | | | | | |

In the embodiment of FIGS. 33D-E, in the transverse direction 197, each deflection feature 118A is curved and with the same curvature 1/ρ₁₉₇. Advantageously the complexity of manufacture of the deflection features 118 is reduced. In alternative embodiments, each deflection feature 118 such as reflector 117 may be curved with a curvature 1/ρ₁₉₇ that changes along the extraction waveguide 1 in the second direction 193.

Provision of divergence 38(195) in the lateral direction 195 will now be described.

FIG. 33F is a schematic diagram illustrating a front perspective view of an ANEDD 100 comprising deflection features 118 that are curved with negative optical power in the lateral direction 195 that is the same across the array of deflection features 118. Features of the embodiment of FIG. 33F not discussed in further detail may be assumed to correspond to the features with equivalent reference numerals as discussed above, including any potential variations in the features.

FIG. 33F further illustrates the embodiment of FIG. 33A wherein in the lateral direction 195, each deflection feature 118A is a deflection feature 118A that is curved.

The lateral anamorphic component 110 and the deflection arrangement 112 are configured such that the ANEDD 100 outputs light from a point 230 that has divergence 38(195) in the lateral direction 195 so that, when the output light from the point 230 is viewed by the eye 45 of a viewer 47, the divergence 38(195) of the output light allows the eye 45 of the viewer 47 to focus the output light from a finite viewing distance ZV₁₉₅ in the lateral direction 195.

Considering light from left side pixel 222L, the light rays 434LR within the extraction waveguide 1 and propagating in the second direction 193 are parallel after reflection from the light reversing reflector 140. The deflection features 118A are curved with negative optical power in the lateral direction 195 to cause divergence 38(195) in the lateral direction 195.

Further, as illustrated in FIG. 33A, the deflection features 118A have tilts r that vary such that the output light is light from a point 230 that has divergence 38(197) in the transverse direction 197 and, when the output light from the point 230 is viewed by the eye 45 of a viewer, the divergence 38(197) of the output light allows the eye 45 of the viewer 47 to focus the output light from a finite viewing distance ZV₁₉₇ in the transverse direction 197.

FIG. 33G is a schematic diagram illustrating a front perspective view of an ANEDD 100 comprising deflection features 118 that are straight in the lateral direction 195 and the shape of the lateral anamorphic component 110 is provided with additional negative optical power. Features of the embodiment of FIG. 33G not discussed in further detail may be assumed to correspond to the features with equivalent reference numerals as discussed above, including any potential variations in the features.

By way of comparison with FIG. 33F, the alternative embodiment of FIG. 33G illustrates that in the lateral direction 195, each deflection feature 118A is linear across the lateral direction 195 and the lateral anamorphic component 110 is configured to cause divergence 38(195) in the lateral direction 195. The deflection features 118A are linear in the lateral direction 195 to cause no change of the divergence 38(195) of the output light 34L in the lateral direction 195.

In comparison to FIG. 33F, divergence 38(195) is provided by an adjustment to the lateral anamorphic component 110, for example the radius and/or conic constant of the end 4 of the extraction waveguide 1. Advantageously the cost and complexity of the deflection features 118A is reduced.

TABLE 6 shows an illustrative embodiment of the present disclosure arranged to provide the points 32 at a distance of 2 metres and using linear deflection features 118A in the lateral direction 195, for example as described further in FIG. 33G. By way of comparison with TABLE 5, the embodiment of TABLE 6 illustrates that the deflection features 118A are tilted with tilts that vary along the second direction 193.

TABLE 6

| | | Lateral | | | |
|---|---|---|---|---|---|
| | Lateral | conic | Transverse | | |
| | radius | constant | radius | Height | Tilt |
| Item | ρ₁₉₅/mm | k₁₉₅/mm | ρ₁₉₇/mm | h₁₉₇/mm | τ₁₉₇/deg |
| Extraction feature | 0 | 0 | −6261 | 2.40 | −30.06 |
| 174A | | | | | |
| Extraction feature | 0 | 0 | −6261 | 2.20 | −30.04 |
| 174B | | | | | |
| Extraction feature | 0 | 0 | −6261 | 2.00 | −30.03 |
| 174C | | | | | |
| Extraction feature | 0 | 0 | −6261 | 1.80 | −30.01 |
| 174D | | | | | |
| Extraction feature | 0 | 0 | −6261 | 1.60 | −30.00 |
| 174E | | | | | |
| Extraction feature | 0 | 0 | −6261 | 1.40 | −29.99 |
| 174F | | | | | |
| Extraction feature | 0 | 0 | −6261 | 1.20 | −29.98 |
| 174G | | | | | |
| Extraction feature | 0 | 0 | −6261 | 1.00 | −29.97 |
| 174H | | | | | |
| Extraction feature | 0 | 0 | −6261 | 0.80 | −29.96 |
| 174I | | | | | |
| Lateral light | 105 | 0.58 | −6261 | 3.00 | 0 |
| reversing reflector | | | | | |
| 140, 110 | | | | | |

FIG. 33H is a schematic diagram illustrating a front perspective view of an ANEDD comprising deflection features 118 that are curved in the lateral direction 195 with negative optical power that varies across the array of deflection features 118. Features of the embodiment of FIG. 33H not discussed in further detail may be assumed to correspond to the features with equivalent reference numerals as discussed above, including any potential variations in the features.

By way of comparison with FIG. 33F, the alternative embodiment of FIG. 33H illustrates that each deflection feature 118 is curved in the lateral direction 195 with a curvature 1/ρ₁₉₅ that changes along the extraction waveguide 1 in the second direction 193.

Considering light ray 434LR propagating within the extraction waveguide 1 in the second direction 193, output light rays 34L-A, 34L-B, 34L-C, 34L-D and 34L-E are output from reflective deflection feature 118A-E respectively. At the location of the incident ray 434LR onto each extraction feature 118A-E, the surface normal direction of the deflection feature 118A varies in both the transverse direction 197 and the lateral direction 195. The curvature of the deflection feature 118A in the lateral direction 195 may be varied along the waveguide 1 in the second direction 193 so that the output light rays 34L-A, 34L-B, 34L-C, 34L-D and 34L-E are provided with desirable divergence 38.

The location of the virtual image point 32L may not change for different eye 45 locations in the exit pupil 40, advantageously improving image stability.

FIG. 33I is a schematic diagram illustrating a front perspective view of an ANEDD comprising deflection features 118 that are curved with positive optical power in the lateral direction 195 and the shape of the lateral anamorphic component 110 is provided with additional negative optical power. Features of the embodiments of FIG. 33I not discussed in further detail may be assumed to correspond to the features with equivalent reference numerals as discussed above, including any potential variations in the features.

By way of comparison with FIG. 33F, the alternative embodiment of FIG. 33I illustrates the deflection features 118A are curved with positive optical power in the lateral direction 195 to reduce the divergence 38(195) caused by the lateral anamorphic component 110 in the lateral direction 195 in a similar manner to that described in FIG. 33H. The location of the virtual image point 32L may not change for different eye 45 locations in the exit pupil 40, advantageously improving image stability.

The deflection features 118A of FIG. 33I may further have a different curvature along the extraction waveguide 1 in the second direction 193 to improve stability of virtual image point 32 location in a similar manner to that described with reference to FIG. 33H.

TABLE 7 shows an illustrative embodiment of the present disclosure arranged to provide the points 32 at a distance of 2 metres and using curved deflection features 118A in the lateral direction 195, for example as described further in FIG. 33I. By way of comparison with TABLE 6 and FIG. 33G, the embodiment further comprises an adjusted arrangement of curvature of the light reversing reflector 140.

TABLE 7

| | | Lateral | | | |
|---|---|---|---|---|---|
| | Lateral | conic | Transverse | | |
| | radius | constant | radius | Height | Tilt |
| Item | ρ₁₉₅/mm | k₁₉₅/mm | ρ₁₉₇/mm | h₁₉₇/mm | τ₁₉₇/deg |
| Extraction feature | 1935.4 | 0 | −6261 | 2.40 | −30.06 |
| 174A | | | | | |
| Extraction feature | 1935.4 | 0 | −6261 | 2.20 | −30.04 |
| 174B | | | | | |
| Extraction feature | 1935.4 | 0 | −6261 | 2.00 | −30.03 |
| 174C | | | | | |
| Extraction feature | 1935.4 | 0 | −6261 | 1.80 | −30.01 |
| 174D | | | | | |
| Extraction feature | 1935.4 | 0 | −6261 | 1.60 | −30.00 |
| 174E | | | | | |
| Extraction feature | 1935.4 | 0 | −6261 | 1.40 | −29.99 |
| 174F | | | | | |
| Extraction feature | 1935.4 | 0 | −6261 | 1.20 | −29.98 |
| 174G | | | | | |
| Extraction feature | 1935.4 | 0 | −6261 | 1.00 | −29.97 |
| 174H | | | | | |
| Extraction feature | 1935.4 | 0 | −6261 | 0.80 | −29.96 |
| 174I | | | | | |
| Lateral light | 101.4 | 0.68 | 0 | 3.00 | 0 |
| reversing reflector | | | | | |
| 140, 110 | | | | | |

The operation of the ANEDD 100 for well-corrected eyes and for ophthalmic correction of eyes will now be described.

FIG. 33J is a schematic diagram illustrating a rear perspective view of an ANEDD 100 further comprising a corrective lens 290 to compensate for ophthalmic conditions of the eye 45 of the viewer 47. Features of the embodiment of FIG. 33J not discussed in further detail may be assumed to correspond to the features with equivalent reference numerals as discussed above, including any potential variations in the features.

In the alternative embodiment of FIG. 33J, the near-eye display apparatus 100 further comprises at least one lens 290 that may be a corrective lens having optical power for correcting eyesight. The correction of eyesight may be for example to correct for presbyopia, astigmatism, myopia or hyperopia of the display user 45.

The operation of the ANEDD 100 for various different visual correction conditions will now be described in further detail.

FIG. 33K is a schematic diagram illustrating in side and top views light output 34 from an ANEDD 100 not comprising the curved reflectors 117 of the type of FIG. 33A; and FIG. 33L is a schematic diagram illustrating in side and top views light output 34 from an ANEDD 100 of the type of FIG. 33A. Features of the arrangement of FIG. 33K and embodiment of FIG. 33L not discussed in further detail may be assumed to correspond to the features with equivalent reference numerals as discussed above, including any potential variations in the features.

By way of comparison with FIG. 33A, the arrangement of FIG. 33K may be provided by light deflection features 118A such as reflectors 117 that are linear in the transverse and lateral directions 197, 195 and the lateral anamorphic component 110 is arranged to provide collimated light from a point in the spatial light modulator 48.

Light rays 34C representing a point at the pixel 222C are parallel across both the transverse and lateral directions 197, 195 and so have zero divergence 38; similarly light rays 34B, 34U and light rays 34L, 34M, 34R are parallel with zero divergence 38. Such an arrangement does not allow the eye 45 of the viewer 47 to focus the output light from a finite viewing distance ZV, the viewing distance ZV being for an infinite conjugate. For an output ray 34 location from the ANEDD 100, the rays 34B, 34C, 34U providing divergence ϕ_{T} with respect to each other; and the rays 34L, 34M, 34R are diverging with divergence ϕ_{L} with respect to each other. Divergences ϕ_{T}, ϕ_{L} represent the angular field of view of the ANEDD 100 in the transverse and lateral directions 197, 195 if the rays 34U, 34B, 34L, 34R are from the outer pixels 222U, 222B, 222L, 222R of the spatial light modulator 48. The divergences ϕ_{T}, ϕ_{L} at said output ray 34 location are not the same as the divergence 38(197), 38(195) of the rays 34 from a point on the spatial light modulator 48.

By way of comparison with FIG. 33K, the embodiment of FIG. 33L illustrates the corresponding divergences 38(197), 38(195) for the embodiments of the present disclosure for example as illustrated in FIG. 33A wherein a virtual image 30 is provided for a finite viewing distance ZV. The arrangement of FIG. 33L is suitable for well-corrected vision of the eye 45.

It may be desirable to provide an ANEDD 100 so that a far field object 130 and a virtual image 30 is provided with appropriate divergences 38(197), 38(195) to correct for ophthalmic prescription needs of the eye 45 of the viewer 47 such that images 36, 136 may be provided with appropriate focus onto the retina 46. On selection of the ANEDD 100 for each eye, a viewer 47 may select a waveguide 1 with the appropriate divergences 38(195) and 38(197) to provide visual correction including myopia, hypermetropia, astigmatism and presbyopia.

FIG. 33M is a schematic diagram illustrating in side and top views light output 34 from an ANEDD 100 of the type of FIG. 33A and further arranged to provide vision correction for a hyperopic eye 45 of a viewer 47. Features of the embodiment of FIG. 33M not discussed in further detail may be assumed to correspond to the features with equivalent reference numerals as discussed above, including any potential variations in the features.

An illustrative hyperopic eye 45 may use a positive corrective lens 290 for viewing distant objects 130; and for nearby objects may use a different spectacle lens correction with yet higher positive optical power.

In the alternative embodiment of FIG. 33M, the ANEDD 100 is provided between the corrective lens 290 and the eye 45 so that the usable eye relief e_{R} for the eye 45 is maximised and viewer 47 freedom improved. By way of comparison with FIG. 33L, the alternative embodiment of FIG. 33M illustrates that the vergence is a convergence 38 is provided from the ANEDD 100 to achieve a virtual image 30 distance ZV that is on the output side of the ANEDD 100 and in the arrangement of FIG. 33M, the virtual image 30 from the ANEDD is positioned behind the eye 45, so the viewing distance ZV is a finite negative distance. Distant objects 130 are provided in focus onto the retina 46 using positive corrective lens 290 and focussed retinal images 36 are provided from the ANEDD 100 to the eye by the convergence 38.

FIG. 33N is a schematic diagram illustrating in side and top views light output from an ANEDD 100 of the type of FIG. 33A and further arranged to provide vision correction for a myopic astigmatic eye 45 of a viewer 47; FIG. 33O is a schematic diagram illustrating in side view operation of a diverging corrective lens 290 for a myopic eye 45; FIG. 33P is a schematic diagram illustrating in side view operation of the arrangement of FIG. 33N wherein the virtual image 30 is arranged for an infinite conjugate distance ZV; and FIG. 33Q is a schematic diagram illustrating in side views operation of the arrangement of FIG. 33N wherein the virtual image is arranged for a finite conjugate distance ZV. Features of the embodiment of FIGS. 33N-Q not discussed in further detail may be assumed to correspond to the features with equivalent reference numerals as discussed above, including any potential variations in the features.

In the alternative embodiments of FIGS. 33M-Q, a myopic eye 45 may be provided with a negative corrective lens 290 to correct for far-field viewing, that is to bring into sharp focus an object 130 arranged at an infinite conjugate such that image 136 is arranged on the retina 46 for comfortable viewing.

The alternative embodiment of FIG. 33N may have an ANEDD 100 with operation that is similar to the embodiment of FIG. 33L, however the divergence 38 may be different, as illustrated in FIGS. 33P-Q. FIG. 33N further illustrates that the astigmatism of the eye 45 may be corrected in which the distances ZV₁₉₅, ZV₁₉₇ are set differently to compensate for astigmatism of the eye 45 of a viewer 47 and optionally different for each eye 45L, 45R. Advantageously further corrective spectacles between the waveguide 1 and the eye 45 may be omitted and the desirable eye relief e_{R} reduced, achieving increased field of view.

By way of comparison with the present embodiments, FIG. 33O illustrates the correction of a myopic eye 45 for viewing of a distant object 130 with parallel rays 134 from an infinite conjugate distance ZR. The unaided eye 45 has too much optical power and the eye cannot focus the image 136 correctly onto the retina 46. The negative corrective lens provides a virtual image distance ZL that is the viewing distance for the eye 45 by providing divergence 298 of the rays 134 from the lens 290 towards the eye 45. The eye 45 of the viewer 47 focuses the light rays 134 from the finite viewing distance ZL onto the retina 46.

In the embodiment of FIG. 33P, the reflectors 117 of the ANEDD 100 are arranged to provide divergence 38 which is the same as the divergence 298 provided by the negative corrective lens 290 for an infinite conjugate distance ZR. The finite viewing distance ZV is the same as the viewing distance ZL for the lens 290 and ANEDD 100.

By way of comparison with FIG. 33L, the magnitude of the divergence 38 of the rays 34 for FIGS. 33P-Q may be different to the magnitude of the divergence for well-corrected vision of FIG. 33L, for example the divergence 38 may be increased.

By way of comparison with FIG. 33P, in the alternative embodiment of FIG. 33Q, the reflectors 117 of the ANEDD 100 are arranged with further increased divergence 38, which is greater than the divergence 298 provided by the negative corrective lens 290 for an infinite conjugate distance ZR, so that a finite viewing distance ZV is provided for the virtual image 30 and the finite image distance ZL is provided for the real-world object 130.

In an illustrative example, a myopic viewer 47 with maximum comfortable focus distance of 0.5 metre may be provided with a negative power corrective lens 290 that provides sharp imaging of distant objects 130 for the viewing distance ZL of 0.5 metres and a viewing distance ZV of 0.25 metres.

It may be desirable to provide a stereoscopic display device.

FIG. 33R is a schematic diagram illustrating a top view of a stereoscopic ANEDD display device 106 incorporating front views of virtual images 30R, 30L arranged to provide a perceived stereoscopic virtual image at a finite viewing distance ZV. Features of the embodiment of FIG. 33R not discussed in further detail may be assumed to correspond to the features with equivalent reference numerals as discussed above, including any potential variations in the features.

The alternative embodiment of FIG. 33R illustrates a stereoscopic display device 106 comprising a left eye ANEDD 100L and a right-eye ANEDD 100R that may be of the same type of or different types as described hereinabove.

Virtual image 107 is provided at the virtual image distance ZV with focussed image points 35L, 35R at the retinas 46L, 46R of the left and right eyes 45L, 45R respectively. The virtual images 39R, 39L comprise image points 32L, 32R that have respective disparities 139L, 139R, for example from the image 39 centre. The disparities are arranged such that the convergence angles χL, χR provide a nominal convergence distance near to the virtual image distance ZV, for example within a convergence distance of A about the virtual image distance ZV.

It may be desirable to provide multiple focal planes for near-eye displays comprising non-anamorphic display devices.

FIG. 33S is a schematic diagram illustrating a rear perspective view of an alternative near-eye display device 100 arranged to provide first and second virtual images 30A, 30B at a finite viewing distance Z_{A}, Z_{B} and comprising a non-anamorphic display device 102 and an ANEDD 100 arranged in series; and FIG. 33T is a schematic diagram illustrating a side view of the operation of the arrangement of FIG. 33S. Features of the embodiments of FIGS. 33S-T not discussed in further detail may be assumed to correspond to the features with equivalent reference numerals as discussed above, including any potential variations in the features.

By way of comparison with FIGS. 12A-B, the alternative embodiments of FIGS. 33S-T comprise the ANEDD 100 comprising anamorphic SLM 48A and anamorphic optical system 250; and a non-anamorphic display comprising a non-anamorphic SLM 48 and non-anamorphic optical system 252.

The anamorphic optical system may be of the type of FIG. 33A or alternatives as described elsewhere hereinabove.

The non-anamorphic optical system 252 comprises a lens arrangement 253 and has positive optical power for the light output by the second spatial light modulator 48B. As will be described further hereinbelow, the non-anamorphic optical system 252 may comprise one or more lenses with rotational symmetry of optical power that may comprise one or more surfaces with spherical or aspherical shape profiles. The non-anamorphic optical system 252 may be provide optical powers are the same with respect to the lateral and transverse directions 195(44), 197(44) for light output towards the pupil 44 of the eye 45 wherein the optical powers are most typically rotationally symmetric.

Further, the spatial light modulator 48B comprises pixels 222B that are imaged in a non-anamorphic manner, that is pixels 222B with a given aspect ratio are imaged to image points in the image 31B on the retina 46 that have the same given aspect ratio. The lens arrangement 253 may comprise glass or plastic lenses that may be singlets or compound lenses. The spatial light modulator 48B typically has a different size to the spatial light modulator 48A, and the pixels 222B are different in size to the pixels 222A. As will be described hereinbelow, the light emission and light control structure of the pixels 222B may be different to the light emission and light control structure of the pixels 222A.

Considering the directions of operation of the second illumination system 102B, lateral directions 195(48B), 195(50B) are the same; the transverse directions 197(48B), 197(50B) are the same and may be the same as the directions 195(44), 197(44).

In alternative embodiments (not shown), the virtual image 30 at finite image distance ZV may be provided for other embodiments described herein comprising more than one near-eye display device arranged in series including, but not limited to, FIG. 26B, FIGS. 28A-B, and FIGS. 31A-B.

Alternative arrangements of illumination systems and transverse anamorphic components 60 will now be described.

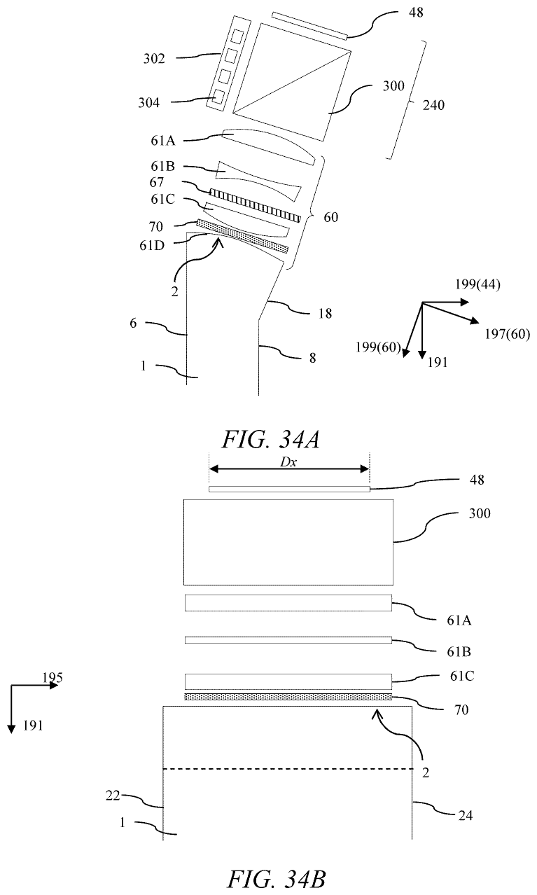

FIG. 34A is a schematic diagram illustrating in side view a detail of an arrangement of a transverse lens 61 that forms a transverse optical component 60; and FIG. 34B is a schematic diagram illustrating in rear view a detail of the arrangement of the transverse lens 61 of FIG. 34A. Features of the embodiment of FIGS. 34A-B not discussed in further detail may be assumed to correspond to the features with equivalent reference numerals as discussed above, including any potential variations in the features.

In the alternative embodiment of FIG. 34A, the transverse lens 61 forming the transverse anamorphic component 60 comprises a compound lens 61A-C. Further the compound lens 61A-C may comprise a lens 61D comprising the curved input end 2 of the extraction waveguide 1. FIG. 34B illustrates that the illumination system 240 and transverse anamorphic component 60 do not provide optical power in the lateral direction 195, that is the compound lenses 61A-D are cylindrical or elongate with a non-spherical surface profile, for example aspheric such as illustrated by the shapes of lenses 61A-B to achieve improved field aberrations and advantageously increased MTF at higher field angles.

Advantageously aberrations in the transverse direction 197(60) may be improved.

Further, the illumination system may comprise a reflective SLM 48, an illumination array 302 comprising light sources 304 and a beam combiner cube arranged to illuminate the SLM 48. The illumination array 302 may comprise different coloured light sources so that the SLM 48 may provide time sequential colour illumination.

FIG. 34A further illustrates that the transverse anamorphic component 60 may comprise a transverse diffractive component 67 that is provided with optical power in the transverse direction 197. The component 67 may have chromatic aberrations that are angularly varying to correct for chromatic aberrations from the refractive components 60A-D in the transverse direction 197. Colour blurring in the transverse direction 197 may advantageously be reduced.

FIG. 35A is a schematic diagram illustrating in side view an illumination system 240 for use in the ANEDD 100 of FIG. 1 comprising separate red, green and blue SLMs 48R, 48G, 48B and a beam-combining element 82. Features of the embodiment of FIG. 35A not discussed in further detail may be assumed to correspond to the features with equivalent reference numerals as discussed above, including any potential variations in the features.

The alternative embodiment of FIG. 35A illustrates that the illumination system 240 may comprise red, green and blue SLMs 48R, 48G, 48B and a colour combining prism arrange to direct light rays 412R, 412G, 412B towards the transverse anamorphic component 60. Such an arrangement may be used to provide high resolution colour imagery from emissive SLMs 48 for example. Emissive displays may be OLED on silicon or micro-LED on silicon SLMs 48 for example. Advantageously high resolution colour virtual images may be provided.

FIG. 35B is a schematic diagram illustrating in side view an illumination system 240 and transverse anamorphic component 60 for use in the ANEDD 100 of FIG. 1A comprising a birdbath folded arrangement. Features of the embodiment of FIG. 35B not discussed in further detail may be assumed to correspond to the features with equivalent reference numerals as discussed above, including any potential variations in the features.

In the alternative embodiment of FIG. 35B, the SLM 48 illuminates a catadioptric illumination system 240 comprising input lens 79, curved mirror 86A and partially reflective mirror 81 such that rays 412 are directed into the input side 2 of the extraction waveguide 1. Advantageously chromatic aberrations in the transverse direction 197 may be reduced. The partially reflective mirror 81 may be a polarising beam splitter or may be a thin metallised layer for example.

Additionally or alternatively curved mirror 86B may be provided to increase efficiency of operation.

FIG. 35C is a schematic diagram illustrating in side view a SLM 48 arrangement for use in an ANEDD comprising a transverse anamorphic component 60 comprising a reflector 62. Features of the embodiment of FIG. 35C not discussed in further detail may be assumed to correspond to the features with equivalent reference numerals as discussed above, including any potential variations in the features.

In comparison to the embodiment of FIG. 1A, illumination system 240 comprises the SLM 48, reflector 62 and curved input end 2. The transverse anamorphic component 60 is an illustrative example of a catadioptric optical element comprising reflective and refractive surfaces of reflector 62, and input end 2 respectively. In other embodiments, not shown, the refractive components may be omitted and the transverse anamorphic component 60 may comprise only reflective surfaces with optical power and the input end 2 may be planar. In comparison to the refractive lens 61 described hereinabove, advantageously chromatic aberration of rays 414 input into the extraction waveguide 1 may be reduced.

FIG. 35D is a schematic diagram illustrating in front perspective view an alternative arrangement of an input focussing lens 61. Features of the embodiment of FIG. 35D not discussed in further detail may be assumed to correspond to the features with equivalent reference numerals as discussed above, including any potential variations in the features.

SLM 48 comprises active area 49A and border 49B and is aligned to the lens of the transverse anamorphic component 60 that is a compound lens comprising lenses 60A-F. Some of the lenses 60A-F may comprise surfaces that have a constant radius and some may comprise variable radius surfaces such that in combination aberration correction is advantageously improved.

It may be desirable to improve the aberrations of a transverse lens 61.

FIG. 35E is a schematic diagram illustrating in side view an alternative arrangement of a transverse anamorphic component 60 comprising a pancake lens 651. Features of the embodiment of FIG. 35E not discussed in further detail may be assumed to correspond to the features with equivalent reference numerals as discussed above, including any potential variations in the features.

The SLM 48 comprises a retarder 221 such as a quarter waveplate arranged to convert linear polarisation state to a circular polarisation state. The illustrative pancake lens 651 of FIG. 35E comprises meniscus lens 650A and plano-convex lens 650B. A half mirror 670 is arranged on the front side of the meniscus lens 650A and a reflective polariser 676 is arranged on the rear side of the plano-convex lens 650B. A retarder 672 such as a quarter waveplate is arranged to convert a linear polarisation state to a circular polarisation state is arranged between the half mirror 670 and reflective polariser 676. The pancake lens 651 has a folded optical path as illustrated, arising from the reflection and transmission of polarised light within the pancake lens 58. Advantageously the optical aberrations are improved in comparison to the compound lens of FIG. 35D for an equivalent exit pupil 40 size and uniformity. The total optical thickness from the input side 2 of the waveguide 1 to the SLM 48 is reduced, reducing the total system thickness.

Alternative arrangements of SLM 48, illumination system 240 and optical system 250 will now be described.

FIG. 35F is a schematic diagram illustrating in side view a SLM arrangement for use in the ANEDD of FIG. 1 comprising a SLM 48 comprising a laser 56, a scanning arrangement 51 and a light diffusing screen 52. Features of the embodiment of FIG. 35F not discussed in further detail may be assumed to correspond to the features with equivalent reference numerals as discussed above, including any potential variations in the features.

In the alternative embodiment of FIG. 35F, the SLM 48 comprises the laser 56 arranged to direct a beam 490 towards scanning arrangement 51 that may be a rotating mirror for example, with oscillation 53 that is synchronised to the image data.

The beam 490 is arranged to illuminate a screen 52 to provide a diffuse light source 55 at the screen. The screen 52 may comprise a diffusing arrangement so that the transmitted light is diffused into light cone 491 arranged to provide input light rays 492 into the transverse anamorphic component 60 and extraction waveguide 1.

The screen 52 may alternatively comprise a photoemission layer such as a phosphor laser at which the laser beam 490 is arranged to produce emission from the photoemission layer. The output colour can advantageously be independent of the laser 56 emission wavelength. Further laser speckle may be reduced.

The laser 56 may comprise a one-dimensional array of laser emitting pixels 222 across a row 221T and the scanning arrangement 51 may provide a one-dimensional array of light sources 55 at the screen 52 for each addressable row of the SLM 48. The scanning speed of the scanning arrangement 51 is reduced, advantageously achieving reduced cost and complexity.

Alternatively the laser 56 may comprise a single laser emitter and the scanning arrangement 51 may provide two-dimensional scanning of the beam 490 to achieve a two-dimensional pixel array of emitters 55 at the screen 52. Advantageously laser 56 cost may be reduced. In the embodiments of FIGS. 35G-K hereinbelow comprising the arrangement of FIG. 35F, the screen 52 may be considered as providing the backplane 228.

It would be desirable to increase the retinal illuminance of an ANEDD 100.

FIG. 35G is a schematic diagram illustrating in front perspective view a SLM 48 comprising a microlens array 226 for use in the ANEDD 100 of FIG. 1A; and FIGS. 35H-K are schematic diagrams illustrating in side views arrangements of pixels and refractive microlens arrays for use in the ANEDD of FIG. 1A. Features of the embodiments of FIGS. 35G-K not discussed in further detail may be assumed to correspond to the features with equivalent reference numerals as discussed above, including any potential variations in the features.

By way of comparison with FIG. 2A, the pixel 222 arrangement of FIG. 35G provides columns 2221L each comprising red, green and blue pixels 222R, 222G, 222B. A microlens array 226 comprising lens surfaces 223a-n that are elongate and extended in the lateral direction 197(48) and arrayed across the lateral direction 195(48). Gap regions 229L are provided in the lateral direction between the columns 221L of pixels 222R, 222G, 222B. Each microlens surface 223 is arranged in alignment with a corresponding column 221L of the pixels 222R, 222G, 222B. In operation, the microlens array 226 is arranged to output a fan of rays with lateral cone angle α_{L} from each of the columns 221L and, referring to FIG. 1C, about the nominal output direction 460. The anamorphic distribution of pixels 222 provides gaps 229 that may be large in comparison to non-anamorphic spatial light modulators 48 that comprise the transverse pitch PT in both the lateral and transverse directions. Anamorphic spatial light modulators 48 may be conveniently provided with gaps 229L that are sufficiently large to provide output light cones 445 that are small for input into the waveguide 1 as will be described with respect to FIG. 35M.

In alternative embodiments, the pixel arrangements of FIG. 2A-D may be provided in columns 221L separated by gaps 229L and aligned with microlens surfaces 223 respectively. Advantageously alternative pixel 222 shapes may be achieved as described hereinabove.

FIG. 35H illustrates an embodiment wherein the microlens array 226 is formed on the backplane 228 for example by bonding or by providing a mould in alignment with the pixels 222 and curing the material of the microlens array 226. By way of comparison with FIG. 35H, the embodiment of FIG. 35I provides a separate lens array in alignment with the backplane 228. Advantageously the separation of the microlens surfaces 223a-n and pixels 222 may be reduced. By way of comparison with FIG. 35H, the embodiment of FIG. 35J provides first and second microlens arrays 226A, 226B with surfaces 223Aa-n aligned with surfaces 223Ba-n. Advantageously increased optical power and reduced aberrations may be achieved. By way of comparison with FIG. 35J, the embodiment of FIG. 35K comprises a microlens array 226B of a material that is different to the material of lens array 226A, 226C for example of a lower refractive index. Advantageously undesirable surface reflections and stray light are reduced.

FIG. 35L is a schematic diagram illustrating in side view arrangements of pixels 222R, 222G, 222B and a diffractive microlens array 226 comprising diffractive optical elements 219R, 219G, 219B comprising microlens function for use in the ANEDD of FIG. 1A. Features of the embodiment of FIG. 35L not discussed in further detail may be assumed to correspond to the features with equivalent reference numerals as discussed above, including any potential variations in the features.

By way of comparison with FIG. 35G, the alternative embodiment of FIG. 35L comprises an array of diffractive microlenses 219R, 219G, 219B that are aligned with respective red, green and blue pixels 222R, 222G, 222B to provide light output in cones 445R, 445G, 445B respectively. The diffractive lenses may have thinner form factor than the refractive microlenses described elsewhere herein.

FIG. 35M is a schematic diagram illustrating in unfolded front perspective view the operation of an ANEDD 100 comprising the SLM 48 comprising the microlens array 226 of FIGS. 35G-H. Features of the embodiment of FIG. 35M not discussed in further detail may be assumed to correspond to the features with equivalent reference numerals as discussed above, including any potential variations in the features.

FIG. 35M illustrates an unfolded optical design comprising region 447A representing light from the SLM 48 propagating towards the lateral anamorphic component 110 in the first direction 191; region 447B that is only a figurative region representing the reflection of light from the lateral anamorphic component 110 and is not a light propagating region; region 447C representing light rays propagating in the second direction 193 from the lateral anamorphic component 110 towards a reflective reflector 117; and region 447D representing light rays propagating in the output direction 199(44) towards the exit pupil 40.

Considering central light rays 446M in cone 445M with lateral cone angle α_{L} from the middle pixel column 221LM is directed towards the lateral anamorphic component 110. Similarly left and right side light rays 446L, 446R are directed in light cones 445L, 445R with lateral cone angle α_{L} towards the lateral anamorphic component 110 and with central rays 446L, 446R that are parallel to the rays 446M, that is the system is telecentric. After reflection from the lateral anamorphic component 110 light is collimated and directed towards the reflective reflector 117 and output towards the exit pupil 40 which is arranged at the intersection of the respective ray bundles formed by rays 446M, 446L, 446R with half cone angle ϕ_{L} in the lateral direction.

An illustrative embodiment of SLM 48 is provided in TABLE 8.

TABLE 8

| Item | Specification | |
|---|---|---|
| SLM 48 width | 44.5 | mm |
| Number of pixel columns 221L | 4450 | |
| Pixel 222 and microlens surface 223 width pitch P_{L} | 10 | μm |
| Pixel width w_{L} | 2 | μm |
| Gap 229L width | 8 | μm |
| Microlens array 226 refractive index | 1.56 | |
| Microlens 223 thickness, t | 11 | μm |
| Microlens 223 radius of curvature | 6 | μm |
| Lateral cone angle α_{L} | 14° | |
| Field half angle ϕ_{L} | 40° | |
| Waveguide 1 length | 36 | mm |
| Waveguide 1 width | 55 | mm |
| Light reversing reflector 140 radius of curvature | 100 | mm |
| Eye relief, e_{R} | 18 | mm |
| Lateral exit pupil width, e_{L} | 12 | mm |

The microlenses 223a-n of the present embodiments achieve increased luminous intensity in the light cones 445, for example by up to a factor of five in the illustrative embodiment of TABLE 8. Advantageously retinal illuminance is increased and/or display power consumption reduced.

Further arrangements comprising laser sources will now be described.

FIG. 36A is a schematic diagram illustrating in side view input to the extraction waveguide 1 comprising a SLM 48 comprising laser 56 sources and a deflector element 50; FIG. 36B is a schematic diagram illustrating in front view a SLM 48 comprising a row of laser 56 light sources 222A-N for use in the arrangement of FIG. 36A; and FIG. 36C is a schematic diagram illustrating an alternative illumination arrangement. Features of the embodiment of FIGS. 36A-C not discussed in further detail may be assumed to correspond to the features with equivalent reference numerals as discussed above, including any potential variations in the features.

The alternative embodiment of FIG. 36A comprises a transverse anamorphic component 60 that is formed by a deflector element 50 that comprises scanning mirror 51.

FIG. 36B illustrates a SLM 48 suitable for use in the arrangement of FIG. 36A comprising a one-dimensional array of pixels 222A-N wherein the pixels 222A-N each comprise a laser 56 source. Control system 500 is arranged to supply line-at-a-time image data to SLM 48 controller 505 that outputs pixels data to laser 56 pixels 222A-N by means of driver 509; and location data to deflector element 50 by means of scanner driver 511. The laser 56 pixels 222A-N are arranged in a single row with pitch P_{L} in the lateral direction 195 that is the same as illustrated in FIG. 2E for example.

Returning to the description of FIG. 36A, in operation, image data for a first addressed row of image data are applied to the laser 56 pixels 222A-N and the deflector element 50 adjusted so that the laser 56 light from the SLM 48 is directed as ray 490A in a first direction across the transverse direction 197. At a different time, image data for a different addressed row of image data are applied to the laser 56 pixels 222A-N and the deflector element 50 adjusted so that the laser 56 light from the SLM 48 is directed as ray 490B in a different direction across the transverse direction 197. The transverse anamorphic component 60 is thus arranged to receive light from the SLM 48 and the illumination system 240 is arranged so that light output from the transverse anamorphic component 60 is directed in directions illustrated by rays 490A, 490B that are distributed in the transverse direction 197 with cone 491.

In other words, the deflector element 50 scans about the lateral direction 197(60) and serves to provide illustrative light rays 490A, 490B sequentially. By means of sequential scanning, the deflector element 50 provides positive optical power in the transverse direction 197(60) for light from the SLM 48, achieving output cone 491 in a sequential manner. In this manner, the deflector element 50 directs light in directions that are distributed in the transverse direction, providing the transverse anamorphic component 60. The scanning of the deflector element 50 may be arranged not to direct light near to parallel to the direction 191 along the extraction waveguide 1. Advantageously double imaging is reduced.

Advantageously the cost and complexity of the illumination system 240 and transverse anamorphic component 60 may be reduced.

The alternative embodiment of FIG. 36C provides beam expander 61A, 61B that increases the width 63 of the output beam from the illumination system 240. In FIG. 36C, the illumination system 240 further comprises a deflector element 50 arranged to deflect light output from the transverse anamorphic component 60 by a selectable amount, the deflector element 50 being selectively operable to direct the light output from the transverse anamorphic component 60 in the directions that are distributed in the transverse direction 197. Advantageously uniformity of the output image from across the exit pupil 40 is provided.

Alternative arrangements of transverse anamorphic component 60 comprising input reflectors 62 will now be described.

FIG. 37A is a schematic diagram illustrating a rear perspective view of an ANEDD 100 comprising an input reflector 62; FIG. 37B is a schematic diagram illustrating a side view of the ANEDD 100 of FIG. 37A; and FIG. 37C is a schematic diagram illustrating a rear view of the ANEDD 100 of FIG. 37A. Features of the embodiment of FIGS. 37A-C not discussed in further detail may be assumed to correspond to the features with equivalent reference numerals as discussed above, including any potential variations in the features.

For clarity of explanation of the input section 12, in the alternative embodiments of FIGS. 37A-G, the PSR 700 and array of deflection features 118A are not illustrated. In construction, various embodiments of PSR 700 and array of deflection features 118A as described elsewhere herein are provided with the waveguide 1 to achieve light extraction.

In comparison to FIG. 1, in the alternative embodiment of FIGS. 37A-C, the optical system 250 comprises an input section 12 comprising an input reflector 62 that is the transverse anamorphic component 60 and is arranged to reflect the light from the illumination system 240 and direct it along the waveguide 1. The input section 12 further comprises an input face 122 disposed on a front or rear side 8, 6 of the waveguide 1 and facing the input reflector 62, and the input section 12 is arranged to receive the light from the illumination system 240 through the input face 122 wherein the input face 122 is disposed outwardly of one of the front or rear guide surfaces 8, 6 and the input section 12 is integral with the waveguide 1. The input section 12 further comprises a separation face 28 extending outwardly from the one of the front or rear guide surface 8, 6 to the input face 122. Extraction features in extraction region 284 may be of the types as illustrated elsewhere herein.

The embodiment of FIGS. 37A-G may be fabricated using a moulding process and reflective material 66 formed on curved surface 65 to provide the input reflector, for example by sputtering, evaporation or other known coating methods. Alternatively the reflective material 66 may comprise a reflective film such as ESR™ from 3M Corporation. Advantageously the cost and complexity of fabrication may be reduced.

It may be desirable to provide further control of optical aberrations in the transverse direction 197.

FIG. 37D is a schematic diagram illustrating a side view of an alternative ANEDD 100 comprising alternative input reflector 62 and lens 61. Features of the embodiment of FIG. 37D not discussed in further detail may be assumed to correspond to the features with equivalent reference numerals as discussed above, including any potential variations in the features.

In the alternative embodiment of FIG. 37D, the waveguide 1 has an end 2 that is an input face through which the waveguide 1 is arranged to receive light from the illumination system 240, and the input section 12 is a separate element from the waveguide 1 that further comprises an output face 23 and is arranged to direct light reflected by the input reflector 62 through the output face 23 and into the waveguide 1 through the input face 2 of the waveguide 1.

The transverse anamorphic component 60 further comprises a lens 61 wherein the lens 61 of the transverse anamorphic component 60 is a compound lens 61. Lens 61 may comprise a refractive element 61A. Further, lens 61 may comprise a lens 61B comprising the curved input surface 2 of the waveguide 1. Further, lens 61 may comprise a curved surface 61C and a material 61D that may be air or a material with a different refractive index to the refractive index of the waveguide 1 material. The lenses 61A-D may be arranged to reduce the aberrations of the input reflector 62 of FIGS. 1A-D. The transverse anamorphic component 60 is thus a catadioptric optical element comprising refractive and reflective optical functions. Advantageously the fidelity of the image may be improved in the transverse direction.

FIG. 37D further illustrates an alternative embodiment wherein the input reflector 62 is arranged on the surface of a member 68A. The surface of the input reflector 62 may advantageously be further protected. FIG. 37D further illustrates an alternative embodiment wherein the lateral anamorphic component 110 is a reflector arranged on the surface of a member 68B. The surface of the extraction reflector 140 may advantageously be further protected. The coatings 66, 67 may be formed on the members 68A, 68B respectively. Higher temperature processing conditions may be achieved than for coating of polymer waveguides 1. Advantageously cost may be reduced and efficiency of operation increased. Gap 69D may be provided between the waveguide 1 end 4 and member 68B, wherein the gap 69D may comprise air or a bonding material such as an adhesive.

In the alternative embodiment of FIG. 37D, the input section 12 is not integral with the waveguide 1. The waveguide 1 has an end that is an input face 2 through which the waveguide 1 is arranged to receive light from the illumination system 240, and the input section 12 is a separate element from the waveguide 1 that further comprises an output face 23 and is arranged to direct light reflected by the input reflector 62 through the output face 23 and into the waveguide 1 through the input face 2 of the waveguide 1. Further, the transverse anamorphic component 60 is disposed outside the waveguide 1, and the waveguide 1 is arranged to receive light 400 from the transverse anamorphic component 60 through the input face 2. In other words, FIG. 37D further illustrates an alternative embodiment wherein the input section 12 and the guide section 10 of the waveguide 1 are formed by separate members 69A, 69B respectively and aligned across gap 69C which may comprise air or a bonding material such as an adhesive. The members 69A, 69B may be formed separately during manufacture, reducing complexity of processing of the waveguide 1 surfaces and advantageously increasing yield.

It may be desirable to increase the size of SLM 48 in the transverse direction.

FIGS. 37E-G are schematic diagrams illustrating in side views alternative embodiments of ANEDD 100 comprising an input reflector 62. Features of the embodiments of FIGS. 37E-G not discussed in further detail may be assumed to correspond to the features with equivalent reference numerals as discussed above, including any potential variations in the features.

In the alternative embodiment of FIGS. 37E-F input face 122 extends parallel to the front guide surface 8 in the case that the input face 122 is on the front side of the waveguide 1 or to the rear guide surface 6 in the case that the input face 122 is on the rear side of the waveguide 1. FIG. 37E comprises input face 122 that is coplanar with the front guide surface 8 in the case that the input face 122 is on the front side of the waveguide 1 or with the rear guide surface 6 in the case that the input face 122 is on the rear side of the waveguide 1. Advantageously the SLM 48 may be provided on a drive board of a larger size.

In the alternative embodiment of FIG. 37F, input face 122 is offset and parallel with the front guide surface 8 in the case that the input face 122 is on the front side of the waveguide 1 or with the rear guide surface 6 in the case that the input face 122 is on the rear side of the waveguide 1. Advantageously the SLM 48 may be provided within or near to the arms 604 of the headwear 600.

In the alternative embodiment of FIG. 37G, the input face 122 extends at an acute angle θ to the front guide surface 8 in the case that the input face 122 is on the front side of the waveguide 1 or to the rear guide surface 6 in the case that the input face 122 is on the rear side of the waveguide 1. Advantageously a more convenient mechanical arrangement may be provided.

In the alternative embodiments of FIGS. 37E-G, the extraction features may be of the types as illustrated elsewhere herein.

It may be desirable to provide a tracking sensor to determine the location of the pupil of a viewer.

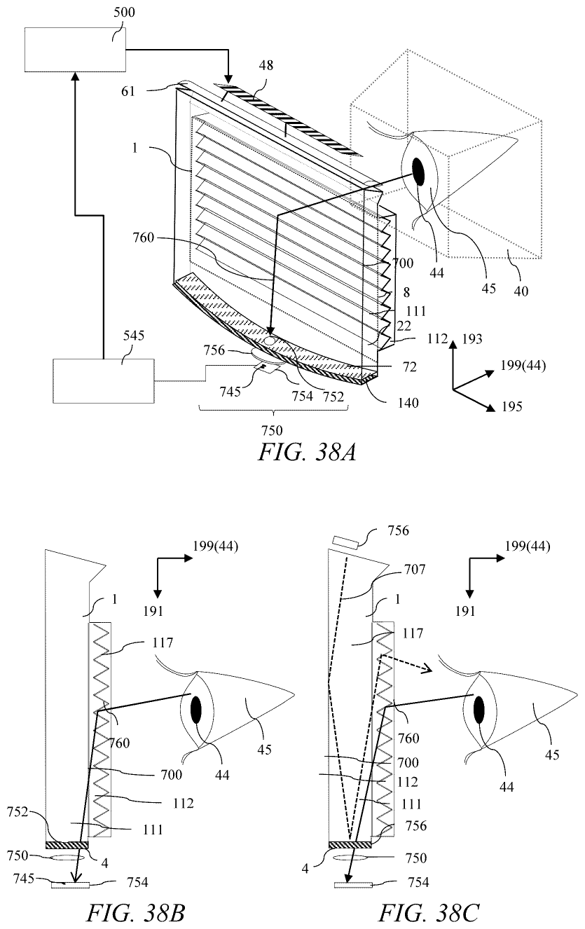

FIG. 38A is a schematic diagram illustrating in rear perspective view an ANEDD 100 comprising an eye tracking arrangement 750; FIG. 38B is a schematic diagram illustrating in side view an ANEDD 100 comprising an eye tracking arrangement 750 with a transmissive hole 752 arranged at the reflective end; and FIG. 38C is a schematic diagram illustrating in side view an ANEDD 100 comprising an eye tracking arrangement 750 with a partially transmissive reflector arranged with the light reversing reflector 140. Features of the embodiments of FIGS. 38A-C not discussed in further detail may be assumed to correspond to the features with equivalent reference numerals as discussed above, including any potential variations in the features.

In the alternative embodiment of FIGS. 38-C, the extraction waveguide 1 is illustrated with deflection reflectors 117 such as those described hereinbefore may be provided as alternatives.

In the alternative embodiments of FIGS. 38A-B, a hole is provided in the light reversing reflector 140. In operation, some light from the eye 45 may be reflected into the extraction waveguide 1 and directed towards the light reversing reflector 140. Some light rays 760 incident on the hole 752 are directed onto an optional lens 756 and an optical sensor 754 arranged to collect the received image data for the location 745 at the sensor of the image of the eye 45. The image of the eye 45 may be directed to multiple locations 745 from the respective reflectors 117 and from guiding of light in the extraction waveguide 1. A machine learning algorithm may be implemented in the position location estimation unit 545 to determine most likely eye 45 location on the basis of the image from the sensor 754 with locations 745. The eye location data is returned to the control system 500. The control system may be adjusted to optimise the image quality for the measured eye 45 location, advantageously increasing image quality.

In the alternative embodiment of FIG. 38C, the light reversing reflector 140 may be partially transmitting, for example to infra-red illumination of the eye 45 by rays 707 provided by light source 756 arranged at the input end 2 of the extraction waveguide 1. Advantageously improved uniformity of output of image data to the eye 45 may be achieved.

The illumination system 240 and optical system 250 of the embodiments hereinabove may be provided for anamorphic directional illumination devices 1000 for illumination of external scenes 479.

FIG. 39A is a schematic diagram illustrating in rear perspective view an anamorphic directional illumination device 1000 arranged to illuminate a scene 479. Features of the embodiment of FIG. 39A not discussed in further detail may be assumed to correspond to the features with equivalent reference numerals as discussed above, including any potential variations in the features.

The alternative embodiment of FIG. 39A illustrates an anamorphic directional illumination device 1000 that comprises an illumination system 240 comprising a light source array 948, the illumination system being arranged to output light. Light source array 948 may for example comprise an array of light emitting diodes, or may be provided by a SLM 48 as described elsewhere herein. In the alternative embodiment of FIG. 39A, the anamorphic directional illumination device 1000 may be a vehicle external light device.

By way of comparison with the ANEDD 100, the SLM 48 of the anamorphic directional illumination device 1000 may comprise an array of pixels 222 that each comprise at least one light source 949 that are arranged to provide an array of illumination cones 951 that illuminate a scene 479 such as a road environment.

By way of comparison with FIG. 3B, the alternative embodiment of FIG. 39A may comprise a single reflector 117 that may comprise a dichroic stack 276 arranged to reflect substantially all of the light incident thereon. High output efficiency may be achieved in a small output aperture, advantageously achieving improved aesthetic appearance. Alternatively multiple reflector 117a-n may be provided to modify the aesthetic appearance.

Optical system 250 is arranged to direct light from the illumination system 240. The light in light cone 499 may be directed towards an externally illuminated scene 479. Illuminated scenes 479 may include but are not limited to roads, rooms, external spaces, processing equipment, metrology environments, theatrical stages, human bodies such as for face illumination for face detection and measurement purposes.

The optical system 250 has an optical axis 199 and has anamorphic properties in a lateral direction 195 and a transverse direction 197 that are perpendicular to each other and perpendicular to the optical axis 199, wherein the light source array 948 comprises light sources 949a-n distributed in the lateral direction 195, and which may further be distributed in the transverse direction 197 as described elsewhere herein.

The anamorphic directional illumination device 1000 of FIG. 39A may comprise various embodiments arranged to improve efficiency and image quality as described elsewhere herein.

By way of comparison with the ANEDDs 100 described hereinabove, the output light from the anamorphic directional illumination device 1000 is provided as illumination cones 951a-n for illumination of a scene 479 compared to the angular pixel information for illumination of pupil 44 and retina 46. High resolution imaging of illuminated scenes 479 may be achieved with high efficiency and low cost in a compact package.

The light sources 949 may output light that is visible light or infra-red light. Advantageously directional illumination of scenes 479 may be provided for visible illumination or illumination of scenes for other detectors such as LIDAR detectors. The light sources 949 may have different spectral outputs. The different spectral outputs include: a white light spectrum, plural different white light spectra, red light, orange light, and/or infra-red light. A visible illumination may be provided and a further illumination for detection purposes may also be provided, which may have different illumination structures to achieve improved signal to noise of detection.

In an alternative embodiment, the scene 479 may comprise a projection screen and the anamorphic directional illumination device 1000 may provide projection of images onto the projection screen. Advantageously a lightweight and portable image projector with high efficiency may be provided in a thin package.

The reflective deflection feature 970 of FIG. 39A may alternatively be provided by an array of light deflection features 970a-n. Advantageously the aesthetic appearance of the directional illumination appearance may be modified. Alternative embodiments of light source array 948 may be provided by embodiments of SLM 48 as described hereinabove, for example in FIGS. 2A-E, FIG. 35F, and FIGS. 36A-C. The transverse anamorphic component 60 may alternatively comprise one or more lenses such as illustrated with reference to FIG. 17D, FIG. 35D, FIG. 34A-B, FIGS. 35A-B and FIG. 37. Aberration control and power of anamorphic components 60, 110 may be further improved by the Pancharatnam-Berry lenses of FIGS. 29A-C, FIG. 30A and FIG. 30B for use in the lateral anamorphic component 110 and/or transverse anamorphic component 60. The features mentioned above may be provided in isolation or in combination.

Further alternative embodiments of waveguide 1 arrangements, transverse anamorphic component 60 arrangements, lateral anamorphic component 110 arrangements, PSRs 700 front waveguide 114, deflection arrangements 112, deflection elements 116, reflectors 117 and deflection features 118 may be provided as described elsewhere hereinabove.

FIG. 39B is a schematic diagram illustrating a side view of a road scene 479 comprising a vehicle 600 comprising a vehicle external light apparatus 106 comprising the anamorphic directional illumination device 1000 of FIG. 39A. Features of the embodiment of FIG. 39B not discussed in further detail may be assumed to correspond to the features with equivalent reference numerals as discussed above, including any potential variations in the features.

The alternative embodiment of FIG. 39B illustrates a vehicle external light apparatus 106 comprising an anamorphic directional illumination device 1000 such as illustrated in FIG. 39A that is a vehicle external light device mounted on a housing 108 for fitting to a vehicle 600. The vehicle external light apparatus 106 is arranged to illuminate an external scene 479 such as a road environment. The vehicle external light apparatus 106 provides output light cone 499 so that the horizon 499 and road surface 494 may be illuminated. In the example of FIG. 39B the cross section of light cone 499 is distributed across the transverse direction 197. In alternative embodiments the cross section of light cone 499 may be distributed across the lateral direction 195.

The light source array 948 may be controlled by controller 500 in response to the location of objects such as other drivers or road hazards in the illuminated scene 479. The light cone 499 may be arranged to illuminate a two-dimensional array of light cones 951 corresponding to respective light sources 949. The light sources 949a-n may be individually or collectively controllable so that some parts of the scene 479 are illuminated and other parts are not illuminated or illuminated with different illuminance. Advantageously glare to other drivers may be reduced while providing increased levels of illuminance of the road scene 479.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. An anamorphic directional illumination device comprising:
an illumination system comprising a spatial light modulator (SLM), the illumination system being arranged to output light; and
an optical system arranged to direct light from the illumination system, wherein the optical system has an optical axis and has anamorphic properties in a lateral direction and a transverse direction that are perpendicular to each other and perpendicular to the optical axis, wherein the SLM comprises pixels distributed in the lateral direction, and the optical system comprises:
a transverse anamorphic component having positive optical power in the transverse direction, wherein the transverse anamorphic component is arranged to receive light from the SLM and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light guided along the extraction waveguide in the first direction to form light that is directed along the extraction waveguide in a second direction opposite to the first direction,
wherein:
the extraction waveguide comprises a rear guide surface and a polarisation-sensitive reflector (PSR) opposing the rear guide surface;
the anamorphic directional illumination device further comprises a deflection arrangement disposed outside the PSR,
the anamorphic directional illumination device is arranged to provide light guided along the extraction waveguide in the first direction with an input linear polarisation state before reaching the PSR;
the optical system further comprises a polarisation conversion retarder disposed between the PSR and the light reversing reflector, wherein the polarisation conversion retarder being arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has an orthogonal linear polarisation state that is orthogonal to the input linear polarisation state;
the PSR is arranged to reflect light guided in the first direction having the input linear polarisation state so that the rear guide surface and the PSR are arranged to guide light in the first direction, and to pass light guided in the second direction having the orthogonal linear polarisation state so that the passed light is incident on the deflection arrangement; and
the deflection arrangement is arranged to deflect at least part of the light passed by the PSR that is incident thereon forwards of the anamorphic directional illumination device.

2. An anamorphic directional illumination device according to claim 1, wherein the deflection arrangement comprises a deflection element comprising an array of deflection features that are arranged to deflect light incident thereon forwards of the anamorphic directional illumination device.

3. An anamorphic directional illumination device according to claim 2, wherein the deflection features are reflectors.

4. An anamorphic directional illumination device according to claim 3, wherein the reflectors are partially reflective reflectors.

5. An anamorphic directional illumination device according to claim 4, wherein the partially reflective reflectors each comprise a partially reflective layer.

6. An anamorphic directional illumination device according to claim 5, wherein the partially reflective layer comprises at least one dielectric layer, preferably a stack of dielectric layers.

7. An anamorphic directional illumination device according to claim 5, wherein the partially reflective layer is metallic.

8. An anamorphic directional illumination device according to claim 1, further comprising an intermediate polarisation conversion retarder arranged between the PSR and the deflection element, the intermediate polarisation conversion retarder being arranged to convert a polarisation state of light passing therethrough between the orthogonal linear polarisation state and the input input linear polarisation state.

9. An anamorphic directional illumination device according to claim 2, wherein the deflection arrangement comprises a front waveguide having a front guide surface on the opposite side of the front waveguide from the PSR, the deflection features being disposed internally within the front waveguide.

10. An anamorphic directional illumination device according to claim 9, wherein the front waveguide comprises a front element and a rear element having a partially reflective layer disposed therebetween, the partially reflective layer comprising first and second sections of opposite inclination alternating in a direction along the front waveguide, the first sections comprising the reflective reflectors and the second sections being arranged to pass the light passed by the PSR that is incident thereon.

11. An anamorphic directional illumination device according to claim 9, wherein the deflection features are separated in a direction along the front waveguide.

12. An anamorphic directional illumination device according to claim 11, wherein the deflection features are distributed along the extraction waveguide to provide exit pupil expansion in the transverse direction.

13. An anamorphic directional illumination device according to claim 2, wherein the deflection arrangement comprises a front waveguide having a front surface on the opposite side of the front waveguide from the extraction waveguide, the front surface comprising guide facets that are arranged to guide light incident thereon in the second direction along the front waveguide and inclined facets that form the deflection elements.

14. An anamorphic directional illumination device according to claim 13, wherein the front surface of the front waveguide further comprises draft facets that are of an opposite inclination to the inclined facets that form the deflection features, the draft facets being arranged to pass the light passed by the PSR that is incident thereon.

15. An anamorphic directional illumination device according to claim 13, wherein the front surface of the front waveguide has a partially reflective layer disposed thereon.

16. An anamorphic directional illumination device according to claim 2, wherein the deflection arrangement comprises:
a partial reflector arranged to pass part of the light that is incident thereon and to reflect the remainder of the light that is incident thereon back into the extraction waveguide; and
a deflection element that is arranged to deflect the part of the light that is passed by the partial reflector forwards of the anamorphic directional illumination device.

17. An anamorphic directional illumination device according to claim 16, wherein the deflection element comprises an array of deflection features that are arranged to deflect the part of the light that is passed by the partial reflector forwards of the anamorphic directional illumination device.

18. An anamorphic directional illumination device according to claim 17, wherein the deflection element has a front surface on the opposite side thereof from the extraction waveguide, the front surface comprising inclined facets that form the deflection features.

19. An anamorphic directional illumination device according to claim 18, wherein the front surface of the deflection element further comprises draft facets that alternate with the inclined facets and are of an opposite inclination to the inclined facets that form the deflection features, the draft facets being arranged to pass the light passed by the PSR that is incident thereon.

20. An anamorphic directional illumination device according to claim 17, wherein the front surface has a partially reflective layer disposed thereon.

21. An anamorphic directional illumination device according to claim 1, wherein the deflection features are elongate in the lateral direction.

22. An anamorphic directional illumination device according to claim 1, wherein the input linear polarisation state is an s-polarisation state in the extraction waveguide, and the orthogonal linear polarisation state is a p-polarisation state in the extraction waveguide.

23. An anamorphic directional illumination device according to claim 1, wherein the PSR comprises a reflective linear polariser.

24. An anamorphic directional illumination device according to claim 1, wherein the polarisation conversion retarder has a retardance of a quarter wavelength at a wavelength of visible light.

25. An anamorphic directional illumination device according to claim 1, wherein the PSR comprises at least one dielectric layer.

26. An anamorphic directional illumination device according to claim 25, wherein the at least one dielectric layer comprises a stack of dielectric layers.

27. An anamorphic directional illumination device according to claim 1, wherein the PSR comprises a nematic liquid crystal layer.

28. An anamorphic directional illumination device according to claim 28, wherein the nematic liquid crystal layer comprises a liquid crystal material arranged between first and second opposing alignment layers.

29. An anamorphic directional illumination device according to claim 27, wherein the component of the optical axis of the liquid crystal layer in the plane of the liquid crystal layer is parallel or orthogonal to the first direction along the extraction waveguide.

30. An anamorphic directional illumination device according to claim 1, wherein the PSR comprises a cholesteric liquid crystal layer.

31. An anamorphic directional illumination device according to claim 30, further comprising a polarisation conversion retarder arranged between the rear guide surface and the cholesteric liquid crystal retarder, wherein
the polarisation conversion retarder is arranged to convert a polarisation state of light passing therethrough between a linear polarisation state and a circular polarisation state, and the polarisation conversion retarder and the cholesteric liquid crystal layer are arranged in combination to reflect the input linear polarisation state of the light guided in the first direction and to transmit the linear polarisation state of the light guided in the second direction.

32. An anamorphic directional illumination device according to claim 30, further comprising a polarisation conversion retarder arranged outside the cholesteric liquid crystal retarder, wherein
the polarisation conversion retarder is arranged to convert a polarisation state of light passing therethrough between a linear polarisation state and a circular polarisation state.

33. An anamorphic directional illumination device according to claim 1, wherein the optical system further comprises an input linear polariser that is disposed between the SLM and the PSR and is arranged to pass light having the input linear polarisation state.

34. An anamorphic directional illumination device according to claim 33, wherein the input linear polariser is disposed between the SLM and the extraction waveguide.

35. An anamorphic directional illumination device according to claim 33, wherein the input linear polariser is disposed within the extraction waveguide.

36. An anamorphic directional illumination device according to claim 33, wherein
the input linear polariser is disposed after the transverse anamorphic component, and
the optical system further comprises a polarisation conversion retarder disposed between the transverse anamorphic component and the input linear polariser, the polarisation conversion retarder being arranged to convert a polarisation state of light passing therethrough between a linear polarisation state and a circular polarisation state.

37. An anamorphic directional illumination device according to claim 33, wherein the illumination system is arranged to output light that is unpolarised.

38. An anamorphic directional illumination device according to claim 1, wherein the illumination system is arranged to output light having the input linear polarisation state.

39. An anamorphic directional illumination device according to claim 1, wherein the extraction waveguide has an input end extending in the lateral and transverse directions, the extraction waveguide being arranged to receive light from the illumination system through the input end.

40. An anamorphic directional illumination device according to claim 39, wherein the input linear polariser is disposed between the SLM and the input end of the extraction waveguide.

41. An anamorphic directional illumination device according to claim 39, wherein the direction of the optical axis through the transverse anamorphic component is inclined with respect to the first and second directions along the extraction waveguide.

42. An anamorphic directional illumination device according to claim 39, wherein the input end is inclined with respect to the first and second directions along the extraction waveguide.

43. An anamorphic directional illumination device according to claim 42, wherein the polarisation conversion retarder has a retardance of a quarter wavelength at a wavelength of visible light.

44. An anamorphic directional illumination device according to claim 1, wherein the light reversing reflector is a reflective end of the extraction waveguide.

45. An anamorphic directional illumination device according to claim 1, wherein the lateral anamorphic component comprises the light reversing reflector.

46. An anamorphic directional illumination device according to claim 1, wherein the transverse anamorphic component comprises a lens, lens.

47. An anamorphic directional illumination device according to claim 1, wherein the optical system comprises an input section comprising an input reflector that is the transverse anamorphic component and is arranged to reflect the light from the illumination system and direct it along the extraction waveguide.

48. An anamorphic directional illumination device according to claim 47, wherein the transverse anamorphic component further comprises a lens.

49. An anamorphic directional illumination device according to claim 47, wherein the input section further comprises an input face disposed on a front or rear side of the extraction waveguide and facing the input reflector, and the input section is arranged to receive the light from the illumination system through the input face.

50. An anamorphic directional illumination device according to claim 49, wherein the input face extends at an acute angle to the front guide surface in the case that the input face is on the front side of the extraction waveguide or to the rear guide surface in the case that the input face is on the rear side of the extraction waveguide.

51. An anamorphic directional illumination device according to claim 49, wherein the input face extends parallel to the front guide surface in the case that the input face is on the front side of the extraction waveguide or to the rear guide surface in the case that the input face is on the rear side of the waveguide.

52. An anamorphic directional illumination device according to claim 51, wherein the input face is coplanar with the front guide surface in the case that the input face is on the front side of the extraction waveguide or with the rear guide surface in the case that the input face is on the rear side of the waveguide.

53. An anamorphic directional illumination device according to claim 47, wherein the input face is disposed outwardly of one of the front or rear guide surfaces.

54. An anamorphic directional illumination device according to claim 53, wherein the input section further comprises a separation face extending outwardly from the one of the front or rear guide surfaces to the input face.

55. An anamorphic directional illumination device according to claim 47, wherein the input section is integral with the extraction waveguide.

56. An anamorphic directional illumination device according to claim 47, wherein
the extraction waveguide has an end that is an input face through which the extraction waveguide is arranged to receive light from the illumination system, and
the input section is a separate element from the extraction waveguide that further comprises an output face and is arranged to direct light reflected by the input reflector through the output face and into the extraction waveguide through the input face of the extraction waveguide.

57. An anamorphic directional illumination device according to claim 1, wherein the pixels of the SLM are also distributed in the transverse direction so that the light output from the transverse anamorphic component is directed in the directions that are distributed in the transverse direction.

58. An anamorphic directional illumination device according to claim 1, wherein the illumination system further comprises a deflector element arranged to deflect light output from the transverse anamorphic component by a selectable amount, the deflector element being selectively operable to direct the light output from the transverse anamorphic component in the directions that are distributed in the transverse direction.

59. An anamorphic directional illumination device according to claim 1, wherein the SLM comprises pixels having pitches in the lateral and transverse directions with a ratio that is the same as the inverse of the ratio of optical powers of the lateral and transverse anamorphic optical elements.

60. An anamorphic directional illumination device according to claim 1, further comprising a control system arranged to operate the illumination system to provide light input in accordance with image data representing an image.

61. An anamorphic directional illumination device according to claim 1, wherein the deflection arrangement is configured such that the output light from each point of the spatial light modulator has vergence in the transverse direction and, when the output light is viewed by an eye of a viewer, the vergence allows the eye of the viewer to focus the output light from a finite viewing distance in the transverse direction.

62. An anamorphic directional illumination device according to claim 61, wherein the deflection arrangement comprises a deflection element comprising an array of deflection features that are arranged to deflect light incident thereon forwards of the anamorphic directional illumination device, and wherein the deflection features have tilts that vary such that the light from each point of the spatial light modulator has the vergence in the transverse direction.

63. An anamorphic directional illumination device according to claim 62, wherein, in the transverse direction, each deflection feature is linear.

64. An anamorphic directional illumination device according to claim 62, wherein, in the transverse direction, each deflection feature is curved.

65. An anamorphic directional illumination device according to claim 64, wherein, in the transverse direction, each deflection feature is curved with the same curvature.

66. An anamorphic directional illumination device according to claim 64, wherein, in the transverse direction, each deflection feature is curved with a curvature that changes along the extraction waveguide in the second direction.

67. An anamorphic directional illumination device according to claim 1, wherein the vergence in the transverse direction is divergence.

68. An anamorphic directional illumination device according to claim 1, wherein the lateral anamorphic component and the deflection arrangement are configured such that the output light from each point of the spatial light modulator has vergence in the lateral direction so that, when the output light is viewed by an eye of a viewer, the vergence of the output light allows the eye of the viewer to focus the output light from a finite viewing distance in the lateral direction.

69. An anamorphic directional illumination device according to claim 68, wherein the vergence in the lateral direction is divergence.

70. An anamorphic directional illumination device according to claim 69, wherein the lateral anamorphic component is configured to cause divergence in the lateral direction.

71. An anamorphic directional illumination device according to claim 69, wherein the deflection arrangement is configured to cause divergence in the lateral direction.

72. An anamorphic directional illumination device according to claim 70, wherein the deflection arrangement comprises a deflection element comprising an array of deflection features that are arranged to deflect light incident thereon forwards of the anamorphic directional illumination device, and wherein the deflection features are curved with negative optical power to cause divergence in the lateral direction.

73. An anamorphic directional illumination device according to claim 70, wherein the deflection arrangement is configured to cause no change of the divergence of the output light in the lateral direction.

74. An anamorphic directional illumination device according to claim 73, wherein the deflection arrangement comprises a deflection element comprising an array of deflection features that are arranged to deflect light incident thereon forwards of the anamorphic directional illumination device, and wherein the deflection features are linear in the lateral direction to cause no change of the divergence of the output light in the lateral direction.

75. An anamorphic directional illumination device according to claim 70, wherein the deflection arrangement is configured to reduce the divergence caused by the lateral anamorphic component in the lateral direction.

76. An anamorphic directional illumination device according to claim 75, wherein the deflection arrangement comprises a deflection element comprising an array of deflection features that are arranged to deflect light incident thereon forwards of the anamorphic directional illumination device, and wherein the deflection features are curved with positive optical power in the lateral direction reduce the divergence caused by the lateral anamorphic component in the lateral direction.

77. An anamorphic directional illumination device according to claim 72, wherein each deflection feature is curved in the lateral direction with a curvature that changes along the extraction waveguide in the second direction.

78. An anamorphic directional illumination device according to claim 1, the anamorphic directional illumination device being an anamorphic near-eye display device, wherein the deflection element is arranged to direct the deflected light towards an eye of a viewer in front of the anamorphic directional illumination device.

79. A head-worn display apparatus comprising:
an anamorphic directional illumination device according to claim 78; and
a head-mounting arrangement arranged to mount the anamorphic directional illumination device on the head of a wearer with the anamorphic near-eye display device extending across at least one eye of the wearer.

80. A head-worn display apparatus according to claim 79, further comprising lenses having optical power, the anamorphic near-eye display device overlying one or each lens.

81. A head-worn display apparatus according to claim 79, wherein the head-worn display apparatus comprises a pair of spectacles.

82. An anamorphic directional illumination device according to claim 1, the anamorphic directional illumination device being a vehicle external light device.

83. A vehicle external light device according to claim 82, wherein the light sources output light that is visible light or infra-red light.

84. A vehicle external light device according to claim 82, wherein the array of light sources includes light sources have different spectral outputs.

85. A vehicle external light device according to claim 84, wherein the different spectral outputs include: a white light spectrum, plural different white light spectra, red light, orange light, and/or infra-red light.

86. A vehicle external light apparatus comprising:
a housing for fitting to a vehicle; and
a vehicle external light device according to claim 82 mounted on the housing.
